(19) United States
(12) Patent Application Publication
(10) Pub. No.: US 2011/0195390 A1
(43) Pub. Date: Aug. 11, 2011

(54) Methods and Systems of Communicating Academic Meaning and Evaluating Cognitive Abilities in Instructional and Test Settings

(76) Inventors: Rebecca Kopriva, Berkeley, CA (US); James John Bauman, Harpers Ferry, WV (US); Timothy Boals, Madison, WI (US)

(21) Appl. No.: 12/986,274

(22) Filed: Jan. 7, 2011

Related U.S. Application Data
(60) Provisional application No. 61/293,356, filed on Jan. 8, 2010.

(51) Int. Cl. G09B 7/00

(52) U.S. Cl. 434/362

(57) ABSTRACT

A computer-implemented method for administering and analyzing electronic testing includes providing a non-English speaking student a computer-implemented standardized testing interface configured to administer a standardized test including one or more test question sets stored in an electronic database. Each test question set administration includes providing a test question demonstration animation for a demonstration test question to be solved through non-linguistic methods, providing at least a first solvable test question animation, the subject matter of the solvable test question correlated to the subject matter of the demonstration test questions, wherein the solvable test question is solved by the student using non-linguistic methods. The testing method further includes providing to an educator a computer-implemented standardized testing analysis engine configured to monitor and analyze one or more activities of the user during the administration of the test question set.

### CROSS REFERENCE TO RELATED APPLICATION

This application claims priority from U.S. Provisional Patent Application Ser. No. 61/293,356, filed on Jan. 8, 2010, the entirety of which is expressly incorporated by reference herein.

### STATEMENT REGARDING FEDERALLY SPONSORED RESEARCH

This invention was made with government support under 39-6006492 awarded by the U.S. Department of Education. government has certain rights in the invention.

### FIELD OF THE INVENTION

Described are methods and systems for evaluating and enhancing the cognitive sophistication of subjects. Methods and systems described herein generally relate to the computer-implemented evaluation and enhancement of subjects' knowledge, skills, and conceptual understanding with sensitivity to measuring these skills despite internal (that is, internal to the subject) barriers and external (that is, external to the subject) barriers to understanding and evaluation. Barriers and other disadvantages are particularly prevalent with traditional textual and language-rich pedagogical methods of communication. Subjects' knowledge, skills, and understanding are enhanced and evaluated by integrating various features, such as interactive task demand spaces and dynamic

response spaces. These involve the use of such features as contextual animations, simulations, assembly, manipulation of stimuli, interactive expository regions using non-typical communication methods that have cognitive implications, and facilitative response functions. Methods and systems consistent with the present invention provide particular advantages with subjects presenting with significant language or other disability challenges. The methods and systems may be used to

improve and to test the knowledge, skills, and understanding of subjects with language or other communication challenges (such as non-native English speakers), English speaking subjects with disabilities pertaining to textual communication (such as learning disabilities in reading), and subjects who are native English speakers but have other disabilities that impair communication using typical methods (for example deaf and hard of hearing subjects or those with emotional, attention, or other learning disabilities).

### BACKGROUND

Development of effective methods of education and evaluation that enhance and/or test subjects' cognitive skills in a field or subject is a significant challenge for educators, employers, gatekeepers, and others.

Conventional methods of evaluation have significant drawbacks. For example, multiple-choice questions used in standardized tests to evaluate achievement or aptitude in k-12 schools and higher education, to determine disability status, and to qualify for jobs can simplify scoring, but subjects without mainstream communication skills or experiences are often at a disadvantage in demonstrating their knowledge even though they may understand the concepts being tested. Additionally, students may guess correctly when they do not understand a question or make an incorrect selection when they otherwise understand the concepts being tested. To adequately discriminate between available choices, fine-tuned language skills and mainstream schooling, or societal conventions are often necessary, but possession of such skills does not necessarily follow an understanding of what is being tested.

In developing test questions measuring knowledge and skills requiring a degree of cognitive complexity, such as a “word problem,” for example, the conventional approach presents a problem using sophisticated language structures and written or oral text to provide context, and then presents a problem to be answered with language subtleties associated with abstract concepts and using additional text or oral language skills. Communication of nuanced and abstract concepts is essential for conveying appropriate precision in meaning in these kinds of questions, but such concepts are generally sought to be communicated using language and language structures which are learned only over time and with proficiency in and experience with more basic structures. Such heavy reliance on language to explain a conceptually complex question often confuses a subject who otherwise understands the concepts being tested, acting as a barrier rather than facilitating the meaning of a question. Even if the words used are understood, for example, test questions may require cultural, mainstream societal, or background knowledge outside the experience of the subject, and unfamiliar contexts, examples, or ways of explaining can confound rather than assist comprehension.

FIG. 1 visually depicts the concept of limited interactivity and facilitation between subjects and the concepts being taught or evaluated using conventional means. Conceptually, test mechanisms may be considered to include (i) an access pathway (120) that permits a particular test mechanism to access a subject's knowledge, skills, and abilities (“KSAs”) (130); and (ii) a response pathway (110) through which a subject is able to communicate in order to respond to questions posed. When, for example, subjects are provided a particular question using static text on a page or computer screen, and the subject responds by composing text or selecting a response from among available options, the conventional test mechanism (100) cannot effectively provide access to the subject's KSAs. This is in part due to the limited ability of the conventional text mechanism to impart the concepts being tested to the subject. This is also due to the conventional test mechanism's lack of alternative response approaches which result in an inability to receive the appropriate information necessary to gauging the KSAs of subjects. The conventional approaches thus act as additional barriers that distort the subject's access to the question and information, and hinder the test designer's access to the KSAs of the subject.

Additionally, with traditional paper-and-pencil-based tests, language-based attentional deficits or reading and writing demands can exceed the capabilities of the subject who may otherwise understand the concepts being tested.

The potential barriers between mechanisms for capturing knowledge and skill acquisition in evaluations and the subjects' inherent knowledge and skills include, among other things, language proficiencies; cognitive abilities or limitations (such as learning disabilities); cultural or societal knowledge and experiences; and the barriers introduced by the testing tools themselves.

For such reasons, there is conventionally a disconnect between the knowledge and understanding intended to be evaluated, and the knowledge and understanding that is required by the educational tool. Evaluations relying on discriminations in language or language-based explanations of cognitive capacity, rather than on what the discriminations or explanations are cognitively pointing to thus tend to be one or more steps removed from what is actually being evaluated.

Just as the text above focuses on evaluations, the same mechanisms of conveying meaning are required during instruction in most contexts. Typically and primarily, instructors use language, including distinctions in language structures and subtle word choices, to precisely communicate new concepts or skills, especially when these concepts and skills are abstract and cognitively challenging. Further, language-rich explanations extend to demonstrations and examples intended to clarify meaning of abstract constructs. In these instances, subjects with language-based challenges who otherwise have the ability to comprehend the new subject matter cannot access the content. In cases where they can access only parts of the content, distorted understandings and skill development often result. Avenues for conveying meaning using other representations are not well developed in live instructional situations, and, just as in current evaluation machinery, to-date, they are nascent in computer-driven teaching applications.

The methods and systems described herein address these and other challenges to provide effective methods and systems of enhancing and evaluating subjects' cognitive sophistication.

### SUMMARY

The present application provides, in exemplary versions, methods and systems of enhancing and evaluating cognitive sophistication.

It presents, for example, a computer-implemented method of evaluating a subject that includes: posing a problem to be solved using simulated visual stimuli with cues that retain the precision of language but reduce and/or support remaining text; and permitting the subject to interact with and respond to the problem by providing an interactive task demand space, dynamic response space, and facilitative response function geared to collecting information about the subject's targeted cognitive abilities and skills. Stimuli associated with communicating the question to the subject, for example, may use animation to relate the contextual backdrop of the question to the subject using moving visual supports that depict unfolding of information over time with limited textual language, or a roll-over where an input-device pointer is placed over displayed screen elements to obtain additional information to clarify the target question without cuing the answer. By using other representational methods in the questions, residual language conveying precision of targeted content is usually reduced to one statement. To support this statement, interactive contexts convey context and meaning referred to within the clause or sentence making it essential that they manipulate the progression of screens or elements within a screen. The imposed interactivity intentionally requires the student to engage in a tactile and active versus passive manner, introducing necessary compensatory supports for these students with language challenges. Further, rollovers that are uniquely designed to convey meaning for this population are one feature in exemplary versions of this invention. For instance, rollovers of words or action phrases use static or dynamic visuals to depict what the text is saying. Action rollovers are particularly important as most students with substantial language challenges have problems with tenses and other variations of verbs. Other rollovers of one or more words in the question refer to specific visuals in the presentation or response spaces referred to in the text. The response spaces may appear after the purpose of the question is delivered, and the functions of these rollovers is to both link the task demand or presentation of the test question to the space where the student will respond while also relating particular text to the relevant way the response elements are pictured. Response rollovers significantly reduce the explanation needed to move the student from the targeted item question to the avenues of response.

To respond, test questions are deliberately designed with response avenues that allow students to demonstrate their knowledge and skills directly. This response enhancement is unique to methods and systems consistent with the present invention. Suitable responses are accomplished by, for example, manipulating e elements displayed on a display device, assembling, reconstructing, or otherwise producing evidence of relations, comparisons, implications or generalizations germane to the problem posed. In this way evidence of cognition is produced without needing to use language or language structures to discriminate between subtle word or phrasal choices or to explain mental conceptual schemas.

The methods and systems consistent with the present invention use additional features to facilitate interaction. For example, the subject is exposed to how functionally to respond to the different questions through the activation of an animated expository region that generically demonstrates a manner of responding to the problem posed without providing any cues as to the response.

In various exemplary versions, for example, the animated expository regions may visually depict a manner in which a subject may respond to a problem being posed or may otherwise interact with particular elements. The layout of the animated expository region may be designed, in an exemplary version, such that its elements correspond with the elements of the task demand space and/or the response space. Such an animated expository region is additionally applicable to any setting in which a manner of interaction with particular components may be elucidated through a self-contained animation.

In other exemplary versions, a plurality of task demand spaces, response spaces, and response functions in an item convey evidence of different cognitive abilities, or evidence that the student has acquired intended meaning, by further accessing the subject's knowledge, understanding, and skills at a deeper level. A subsequent task demand space may, for example, pose a conceptually complementary problem that helps better gauge the subject's knowledge of a concept. Varying items in this manner may pose related problems that serve as checks on a subject's understanding. In further exemplary versions, the raw data of the student's interaction with item components (such as the task demand space, the response space, and the response function) is gathered and analyzed to effectively quantify the subject's understanding and skills. The accumulation of information acquired from the manner in which a subject interacts with and responds to various related and unrelated task demand spaces serves as strong evidence of a subject's knowledge, skills, abilities, and understanding.

Scoring algorithms which underpin the evaluation questions are additional features of exemplary versions consistent with the present invention. Unlike other test questions where only the end response of a static or interactive sequence is evaluated, many process markers are captured in these questions. The purpose of capturing these markers is to evaluate the subject's cognitive processes, including a) the stability or defensibility of the cognitive qualities suggested in their final response; b) the depth and sophistication of their knowledge or skill as evidenced over and among screens or in how they proceed to respond within a screen; or c) to provide instructional feedback which evidence where errors in their judgments lead to incorrect answers. For instance, in FIG. 6, correct answers to two separate graphs suggest the subject's formative understanding of food chains when specific conditions change. However, together, these two screen responses provide a gestalt which further explains that the student more deeply comprehends the role, impact, and implications inherent in varying environmental food sources. In FIG. 25, how the subject moves the elements to build the various causal chains within screens provides evidence of stability and hesitation. Additionally, the item is designed with increasingly more complex causal chains over screens, and algorithms capture evidence of the points at which the subject may have skill and causal understanding, and where and how the skill or conceptual complexity may break down or be less well developed.

The objects and advantages of the invention will appear more fully from the following detailed description of the preferred embodiment of the invention made in conjunction with the accompanying drawings.

### BRIEF DESCRIPTION OF THE DRAWINGS

Drawings provided here convey, in part, how meaning is communicated to and from subjects during an evaluation of the subjects' inherent latent knowledge and skills (or during teaching where the latent acquisition of the concepts and skills by the subjects is the goal).

Features, aspects, and advantages of exemplary versions of the present invention may be demonstrated by the following non-limiting figures, in which:

FIG. 1 is a representation showing the conceptual relationship between prior art test mechanisms and the knowledge, skills, and abilities being evaluated;

FIG. 2 is a representation of the conceptual relationship between a dynamic and interactive evaluation system consistent with the present invention and the knowledge, skills, and abilities being taught or evaluated;

FIG. 3A is a diagram showing the components of a conventional computer system that may be used in one exemplary version of the present invention;

FIG. 3B is a diagram showing examples of devices that may be used in different versions to implement items consistent with the present invention;

FIG. 4A is a flowchart showing a potential sequence of events in an exemplary sample item related to evaluation of a subject;

FIG. 4B is a flowchart showing a potential sequence of events in an exemplary sample item related to education without evaluation of a subject;

FIGS. 5A-5E relate to sample item 1 demonstrating some of the features of a potential version;

FIGS. 6A-6M relate to sample item 2 demonstrating some of the features of a potential version;

FIGS. 7A-7G relate to sample item 3 demonstrating some of the features of a potential version;

FIG. 8A-8K relate to sample item 4 demonstrating some of the features of a potential version;

FIGS. 9A-9C relate to sample item 5 demonstrating some of the features of a potential version;

FIGS. 10A-10B relate to sample item 6 demonstrating some of the features of a potential version;

FIGS. 11A-11F relate to sample item 7 demonstrating some of the features of a potential version;

FIGS. 12A-12C relate to sample item 8 demonstrating some of the features of a potential version;

FIGS. 13A-13G relate to sample item 9 demonstrating some of the features of a potential version;

FIGS. 14A-14C relate to sample item 10 demonstrating some of the features of a potential version;

FIGS. 15A-15E relate to sample item 11 demonstrating some of the features of a potential version;

FIGS. 16A-16C relate to sample item 12 demonstrating some of the features of a potential version;

FIGS. 17A-17E relate to sample item 13 demonstrating some of the features of a potential version;

FIGS. 18A-18B relate to sample item 14 demonstrating some of the features of a potential version;

FIGS. 19A-19O relate to sample item 15 demonstrating some of the features of a potential version;

FIGS. 20A-20I relate to sample item 16 demonstrating some of the features of a potential version;

FIGS. 21A-21D relate to sample item 17 demonstrating some of the features of a potential version;

FIGS. 22A-22L relate to sample item 18 demonstrating some of the features of a potential version;

FIGS. 23A-23I relate to sample item 19 demonstrating some of the features of a potential version;

FIGS. 24A-24J relate to sample item 20 demonstrating some of the features of a potential version; and

FIGS. 25A-25C relate to sample item 21 demonstrating some of the features of a potential version.

FIGS. 26A-26C relate to sample item 22 demonstrating some of the features of a potential version.

FIGS. 27A-27D relate to sample item 23 demonstrating some of the features of a potential version.

FIGS. 28A-28F relate to sample item 24 demonstrating some of the features of a potential version.

FIGS. 29A-29B relates to sample item 25 demonstrating some of the features of a potential version.

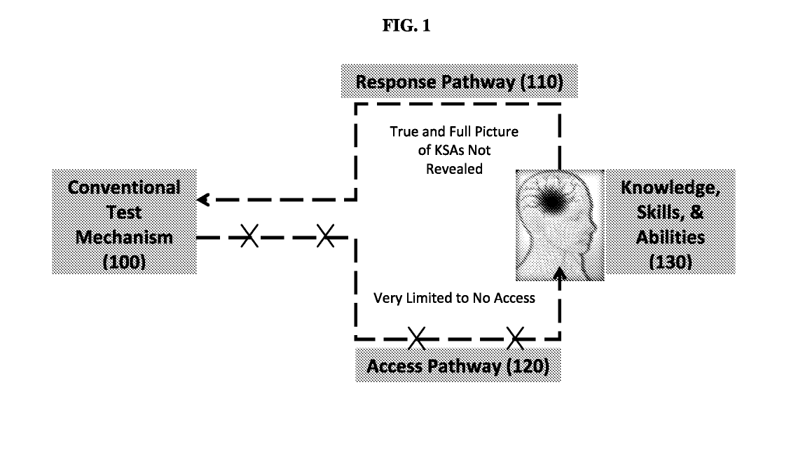

### DETAILED EXPLANATION

The following is not intended to limit the scope or application of the present invention, but rather to provide details and examples of non-exhaustive exemplary versions.

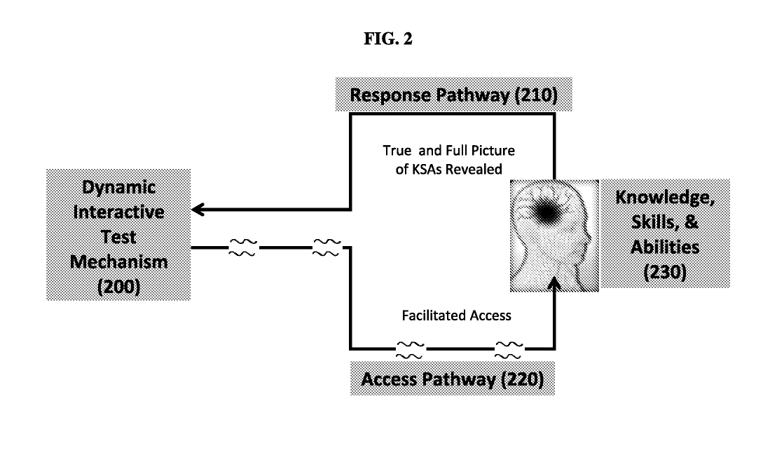

Language and other intermediaries in the enhancement and determination of a subject's cognitive sophistication often confound and confuse the subject's actual understanding. Exemplary versions of the present invention are directed generally to the more direct communication of new knowledge or skills, or more direct evaluation of the subject's current level of abilities and understanding without the hindrances of conventional tools. Such exemplary versions are directed to the effective development and presentation of instructional and evaluation tools that can, among other things, (1) impart to a subject which concept(s) and skill(s) are being taught or tested, and (2) permit the subject more directly and effectively to demonstrate his or her understanding of the concept(s). These are achieved for subjects with varying language proficiencies, cognitive difficulties, cultural or societal background and knowledge, and other unique traits. FIG. 2 visually depicts the concept that a true and full picture of a subject's KSAs (230) is revealed through a dynamic and interactive test mechanism (200) that, among other things, (i) facilitates access to a subject's KSAs (220); and (ii) permits the subject effectively to communicate and demonstrate his or her KSAs more directly (210).

By contrast to conventional tools, the methods and systems in an exemplary version are highly interactive and facilitative. The user may learn about the environment or context by interacting with images, animations, remaining text and other information on the display area. They use, among other things, dynamic task demand spaces and response spaces, dynamic response functions, and animated expository regions to visually communicate information and demonstrate how the subject interacts with and responds to problems posed. They permit the manipulation of the display area, such as the task demand space and the response space, thus allowing the user to modify images, figures, graphs, drawings, and other displayed components. When one segment of a display area is manipulated by a subject, other related areas may automatically be altered or adjusted so as to maintain consistency or conceptual veracity. This sort of manipulation thus permits the subject to instantly perceive the consequences of changes to a presented scenario, further aiding the subject's comfort with and understanding of the relevant concepts.

Moreover, such manipulation of various components in the display area at various points in time and stages in particular items serves as raw data to be analyzed in order to quantify the subject's knowledge, understanding, and skills. That is, data collection algorithms which capture movements of elements within and across screens, back-and-forth movement between screens, and other formative data support the evaluation of cognitive schematic processes as well as end product judgments. Additionally, because test questions are often designed to simultaneously elicit various depths of knowledge depending on how subjects respond, electronic scoring schemes capture responses over screens and even over items to provide evidence of greater or lesser depth and sophistication of various cognitive functions. For example, the manner in which components of a graphic are modified relative to each other (such as to increase the value for a data point on a graph relative to another data point) can be interpreted to represent understanding of different concepts.

Additional features and exemplary versions can be demonstrated through sample items. The sample items below are directed to evaluation, but may be tailored for instruction as appropriate. The presented sample items utilize a mouse as the input device, but can use any input device that permits its user to make a selection. The sample items also utilize a standard computer screen to display their various components, but any device or system can be used to aid the subject in visualizing the relevant concepts. For example, in one exemplary version, the sample components can be visualized using “virtual reality” devices that show three-dimensional images and utilize devices that receive input based on the subject's physical movements in relation to the images. The selection of the input devices used can also be tailored to the cognitive and other limitations of the subjects being taught or evaluated.

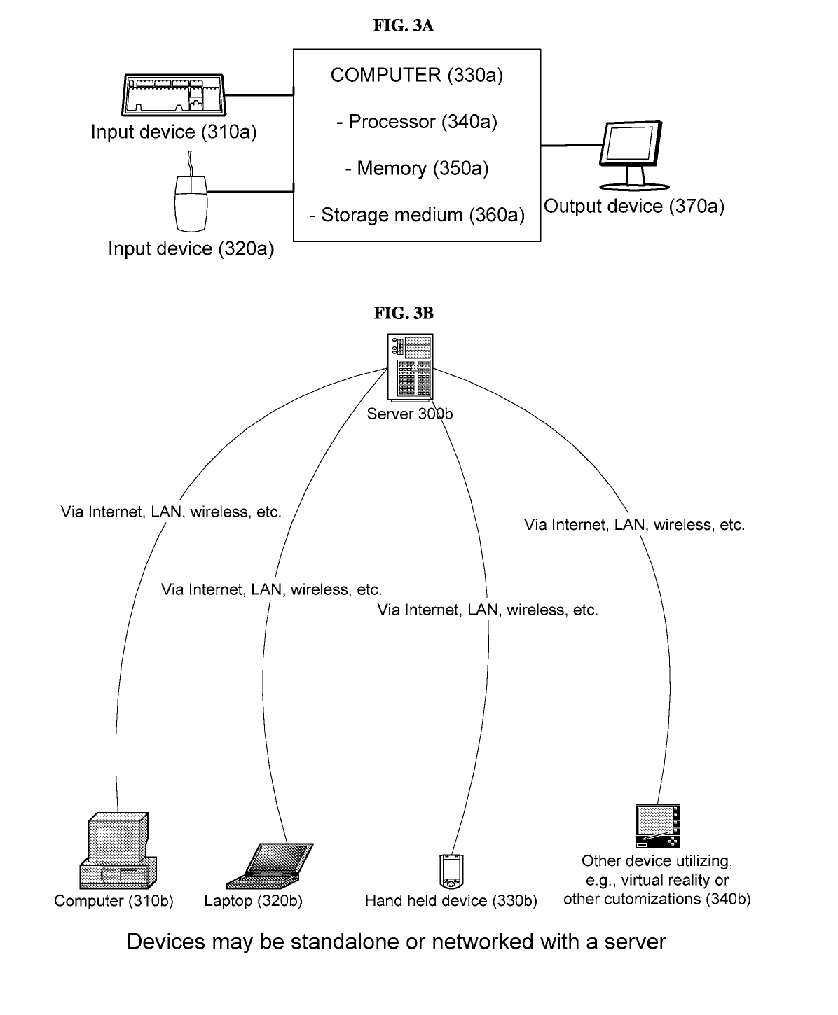

To control costs, one exemplary version can be implemented using computer systems known in the prior art. Standard computer input devices (such as a keyboard, mouse, joystick, touch-screen display, microphone, voice recognition technology, etc.), can be used, or more specialized devices that enhance the ability of subjects to interact with test items can be developed or used. FIG. 3A shows computer hardware components that may be utilized to implement one exemplary version of the present invention. Specifically, depicted in FIG. 3A is a computer (330a) connected to two input devices (310a and 320a) and one output device (370a). The computer (330a) generally uses a processor (340a), memory (350a), and a storage medium (360a) in its operation.

FIG. 3B shows additional exemplary devices that may be used to implement sample items. Such devices include, but are not limited to, a desktop computer (310b), a laptop or other portable computer (320b), a hand held device (330b), or other specialty device (340b) utilizing, for example, virtual reality or other customizations suited to the particular items being implemented. In different exemplary versions, they may function as standalone devices that contain one or more items, or may instead receive items from another location (such as from server 300b) through a network such as the Internet.

A computer system that can be used to implement the methods and systems of an exemplary embodiment comprise, among other things, a processor, memory, storage medium, display means, and input means. The sample items may be stored on a storage medium or received through a network, such as a Local Area Network (LAN), wireless communication device, and/or the Internet. Various security measures may be implemented in order to ensure the integrity of the process. The sample items may additionally be developed for use on hand-held or portable devices. Such devices may include a display, an input means, and an audio output. These devices may optionally be touch screen to permit the user to interact with the sample items without an input device like a computer mouse.

Sample items may incorporate, among other things, none, one, or a plurality of each of the elements from the following non-exhaustive list in any order deemed appropriate: an introductory screen, image, or animation; a contextual and targeted animation or simulation that demonstrates the relevant concepts and/or context and the targeted question or meaning of a passage; dynamic task demand spaces; dynamic response functions; dynamic response spaces; an animated expository region (referred to as the “animated icon” for convenience) that is activated by the subject and that demonstrates the response function or a manner of interacting with the relevant spaces; one or more follow-up sections/questions; and data collection and scoring algorithms underlying each of the test questions.

An exemplary version of an animation of an animated icon can be characterized by at least three phases. An introductory phase often includes an initial motion intended to accomplish such goals as: (i) acquiring the attention of the subject; (ii) suggesting to the subject that the region encompassed by the animated expository region corresponds to the remainder of the space in the display area; and (iii) suggesting to the subject that an icon can move around through the represented display area. A demonstrative phase of an exemplary animation of an animated icon instructs or otherwise informs the subject how to interact with elements of a display area. A conclusory phase includes a “winding down” of the animation of the animated icon, including supplementary animations and motions following the demonstrative phase, and a return to a pre-activation initial state. It should be noted that the duration of time between phases may range from none to long pauses, as deemed appropriate.

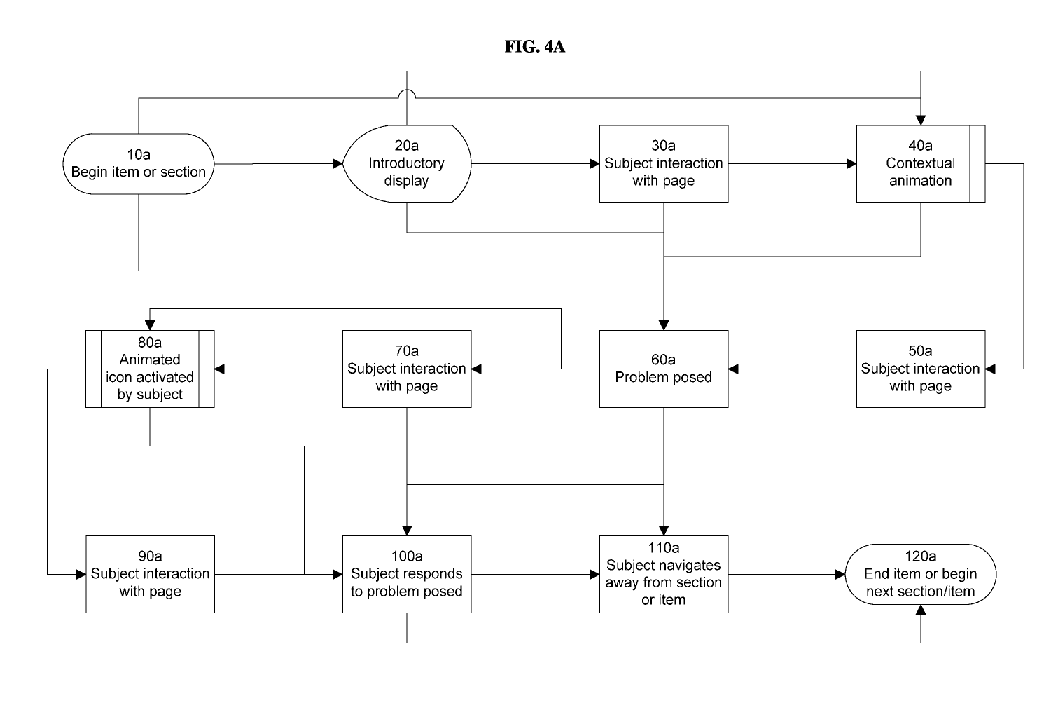

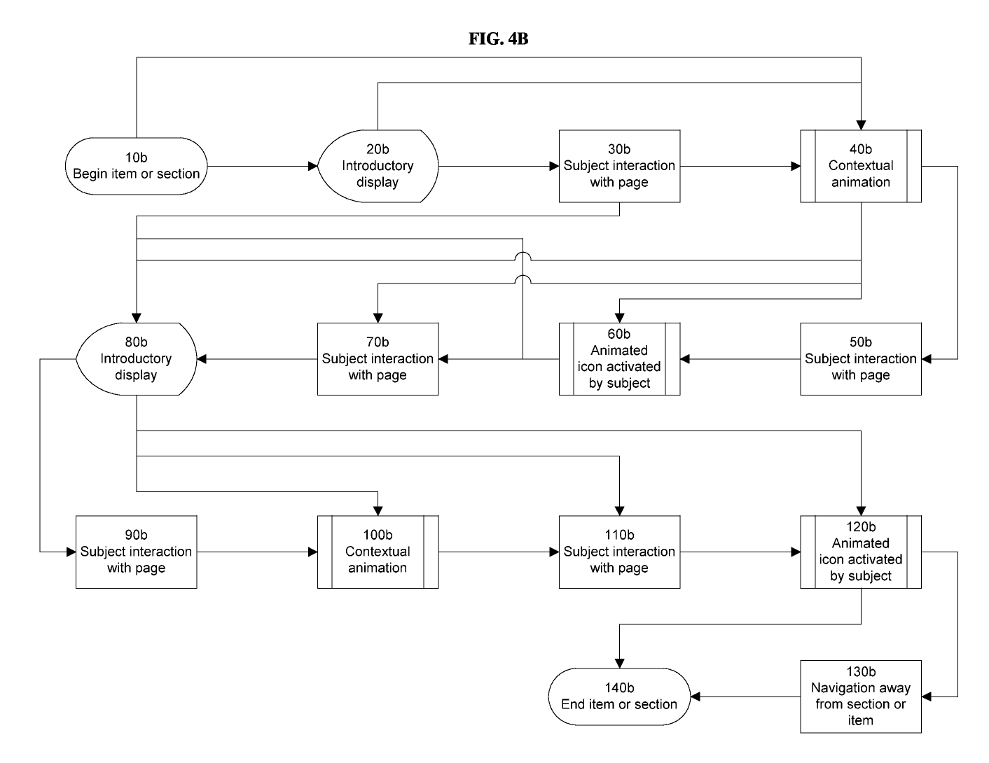

One example of a potential flowchart of events in an exemplary sample item related to evaluation is shown in FIG. 4A. The flowchart in FIG. 4B is related to an exemplary sample item targeted to education without evaluation of a subject.

The sample flowchart of FIG. 4A shows the possible sequence of events in one exemplary version of one section in a sample item. A section may be considered to include one problem or question posed, along with its associated screens and animations. Although it includes one section posing one problem or question, a sample item may present any appropriate number of sections or problems in sequence. The use of multiple conceptually-related sections helps provide, among other things, validation of the subject's understanding and/or skill development.

The item or section begins (10a) through navigation from another item or section, or as the first item or section. The section may then optionally progress to a first introductory screen (20a), to a contextual animation (40a), or to a first problem posed (60a). Following the first introductory screen (20a), the subject may optionally interact with the page (30a) in order to acquaint himself/herself with the context of the item, a contextual animation may begin (40a), or a first problem may be posed (60a). If the subject has interacted with the page (30a), the sample item may then progress to a contextual animation (40a) or to the first problem posed (60a). Following a contextual animation (40a), the subject may interact with the page (50a) before progressing to the first problem posed (60a) or may directly progress to the first problem posed (60a). Once the first problem is posed (60a), the subject may have an opportunity to interact with the page (70a), activate the animated expository region (the “animated icon”) (80a) to learn more about the response function, respond to the problem posed (100a) according to a response function, or navigate away from the section/item (110a). If the subject has interacted with the page (70a), he/she may activate the animated icon (80a) or respond to the problem posed (100a). If the subject has activated the animated icon, he/she may again interact with the page (90a) or may respond to the problem posed (100a). Once the subject has responded to the problem posed, he or she may navigate to another section of the same item or to another item (110a), or simply end (120a).

As suggested, once the subject has completed a section, which may, for example, be indicated through the use of a navigation/information bar or through the expiration of a timer, an item may progress to any subsequent sections with related problems. Such subsequent sections may, for example, change the parameters of, or expand on, the problem; provide additional context; change perspective; approach from a different conceptual angle; present the consequences of a previous section; present parallel patterns; build upon the overall principles; or otherwise provide additional information. A subject may be presented with any appropriate number of items, each comprising any appropriate number of sections. Additional sections and items may be presented in parallel manner, but they need not be constrained to the flowchart of FIG. 4A, as the sequence of events may be altered in any manner to suit needs.

The flowchart in FIG. 4B provides a potential sequence of events in an exemplary version of a sample item not targeted at evaluation. The primary difference of the flowchart of FIG. 4B from that of FIG. 4A is the omission of the steps of posing a problem, and the subject responding to the problem posed. Formative and ongoing checks on a student's understanding at certain points of instruction, though, are an important aspect of teaching and learning, and are part of the instructional flow.

An item or section begins (10b) through navigation from another item or section, or as the first item or section. The section may then optionally progress to a first introductory screen (20b) or to a contextual animation (40b). Following the first introductory screen (20b), the subject may optionally interact with the page (30b) in order to learn more about the context of the item or a contextual animation may begin (40b) such as through navigation to the contextual animation by the subject or through the passage of a given amount of time. If the subject has interacted with the page (30b), the sample item may then progress to a contextual animation (40b) or to a second introductory screen (80b). Following a contextual animation (40b), the subject may interact with the page (50b) before activating an animated icon (60b) or may directly activate the animated icon (60b). Following the contextual animation (40b), the sample item may also progress to subject interaction with the page (70b) before progressing to an introductory screen (80b), or may progress to an introductory screen (80b) directly. If the animated icon was activated (60b), then the subject may interact with the page (70b) before progressing to an introductory screen (80b) or may progress directly to an introductory screen (80b).

It is noted that, in this setting, the animated icon instructs the subject how to interact with components on the screen or otherwise manipulate text, images, graphical elements, or animations in other to achieve a result, learn a concept, practice a skill, or otherwise progress through a sample item. That is, the animated icon in this setting need not represent a response function to be used by the subject to respond to a problem being posed.

Following the introductory screen (80b), the sample item may progress to subject interaction with the page (90b or 110b), contextual animation (100b), or activation of an animated icon (120b). The sample item or section may end here (140b), optionally as a consequence of the subject navigating away from the section or item (130b).

It is noted that not all of the possible events are required in any sample item. After any event, for example, the section or sample item may end because of navigation away from the section or item by the subject, because of expiration of a timer, or otherwise because of completion of the lesson.

Once the first problem is posed (60a), the subject may have an opportunity to interact with the page (70a), activate the animated expository region (the “animated icon”) (80a) to learn more about the response function, respond to the problem posed (100a) according to a response function, or navigate away from the section/item (110a). If the subject has interacted with the page (70a), he/she may activate the animated icon (80a) or respond to the problem posed (100a). If the subject has activated the animated icon, he/she may again interact with the page (90a) or may respond to the problem posed (100a). Once the subject has responded to the problem posed, he or she may navigate to another section of the same item or to another item (110a), or simply end (120a).

As suggested, once the subject has completed a section, which may, for example, be indicated through the use of a navigation/information bar or through the expiration of a timer, an item may progress to any subsequent sections with related problems. Such subsequent sections may, for example, change the parameters of, or expand on, the problem; provide additional context; change perspective; approach from a different conceptual angle; present the consequences of a previous section; present parallel patterns; build upon the overall principles; or otherwise provide additional information. A subject may be presented with any appropriate number of items, each comprising any appropriate number of sections. Additional sections and items may be presented in parallel manner, but they need not be constrained to the flowchart of FIG. 4A, as the sequence of events may be altered in any manner to suit needs.

As with sample items related to evaluation, sample items not focused on evaluation are also very flexible and customizable, providing a highly interactive and facilitative tool for information exchange.

Elements displayed on the screen, as well as events in an overall flow of a sample item, can be used in any manner that is appropriate for particular items and/or concepts. For example, they can be rearranged on the screen, introduced to the subject at various times or in various orders, introduced together and subsequently used in a free-form manner by the subject, or otherwise combined, emphasized, and/or deemphasized as deemed appropriate.

Properly-designed dynamic sample items permit the more effective instruction and accurate evaluation for subjects with language limitations, providing a more direct demonstration of a subject's cognitive sophistication in a particular field or subject. Proper design, for example, limits language load and demonstrates concepts through facilitative methods. Methods and systems designed in accordance with the present invention are not hindered by the barriers and shortcomings that plague conventional static or dynamic instructional applications and testing tools.

Items for use with non-native language speakers, for example, use a reduced language load and multi-semiotic representations without sacrificing content and cognitive complexity. Items may reflect more local standards and lower depth of cultural knowledge. These items are incorporated in computer-based tests that integrate distribution, scoring, and reporting functions within a computer-based test delivery platform. Automatic scoring algorithms are used for each item to enhance efficiency without sacrificing quality, and, in fact, expand and enhance how process elements can be part of the judgments about subjects' abilities.

The high level of interactivity of each sample test item below helps demonstrate rather than merely state the context, background, and targeted demand of the questions and concepts, and, in response, demonstrate the subjects' capabilities in ways that are not dictated by language. The use of ample images, where appropriate, “shows” the subject what is being asked in a manner that can be understood, regardless of cultural, language, and other barriers to understanding. The reduced use of language, and the optional use of short, simple phrases and sentences, further helps boil the test item to the concepts and knowledge being evaluated while providing precision using other semiotic representations. The use of the speaker icon, which allows the subject to hear a translation of the text and phrases used to provide further context and explanation, makes the whole experience more accessible to subjects.

The languages used in text and voice can be tailored as appropriate based on the intended audience.

For demonstrative purposes only, the sample items involve math and science concepts. However, the methods and systems consistent with the present invention are in no way limited to any particular types of subjects, concepts, knowledge, or skills. They are equally applicable to any fields, subjects, and types of information.

The sample items presented below can be tailored for teaching purposes, for testing a subject's knowledge and understanding in a field, or other educational or evaluative contexts. The focus is to communicate meaning, including asking for and receiving an exchange of information.

For demonstrative purposes, the sample test items shown below may display more elements than are required. None of the sample items, individually or in combination, is intended to narrow the scope of the exemplary version, nor does it limit the claimed subject matter.

The sample items shown below make use of numerous screenshots that are intended to capture the various displayed images, animations, and other components of sample items. Individual screenshots of a series of screenshots intended to capture an animation are not necessarily captured at regular intervals between each other. The screenshots are not intended to dictate the speed or duration of animations, the shapes or sizes of elements, the time of introduction of various item components, or otherwise limit the exemplary versions or the claimed subject matter. The screenshots may show an entire display area or may crop and zoom into the portions of the display area being discussed. Where cropped portions of a page are shown, the cropped portions are preceded by the page from which they are cropped. Except for screenshots of animated icons, screen crops are outlined by a dashed line. The cropped screenshots are not enlarged or reduced to the same degree, and thus a larger screenshot does not necessarily mean that elements shown are relatively larger than elements in smaller screenshots.

The input device selector (such as the mouse pointer) is not captured in the screen shots. The pointer can take any appropriate form or image, such as an arrow, a hand, or a tailored image based on the type of question, the response function, the particular stage of a test item, the subject's progress, etc.

Instructional applications and test items can be developed using any appropriate software packages, programming languages, or animation tools. The sample items shown below are viewable using Adobe® Flash® Player. The sample questions below are basic examples of items. Items or instructional passages may be more cognitively challenging, involving multiple interactions with stimuli, sometimes free-formed, that are particularly designed to communicate meaning and, in the case of testing, produce evidence of the subjects' cognitive abilities related to targeted topics.

The sample items below are not presented in any particular order, and do not show all the variations and features of the present invention. The screen shots exhibited here include test questions designed to evaluate the cognition associated with the knowledge and skill acquisition in elementary and middle-school students. The features, principles, concepts, methods, and systems consistent with the present invention, however, are not limited in applicability to such subjects.

Sample Item 1

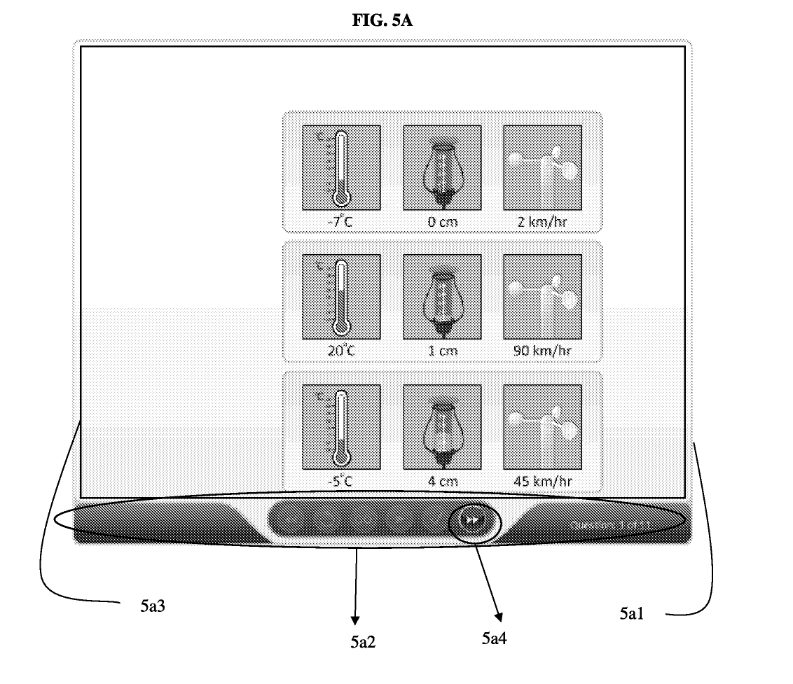

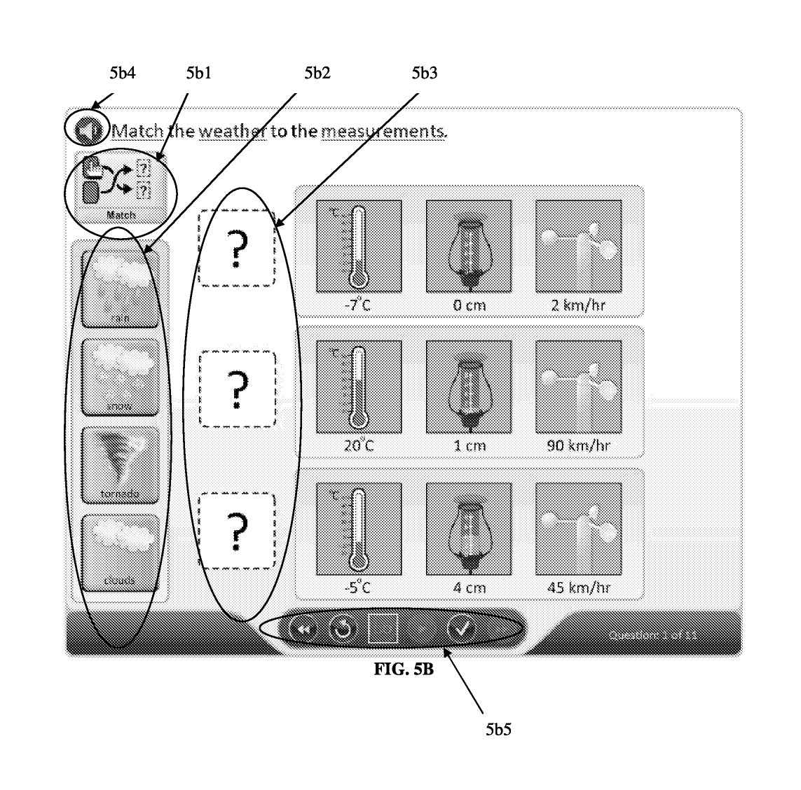

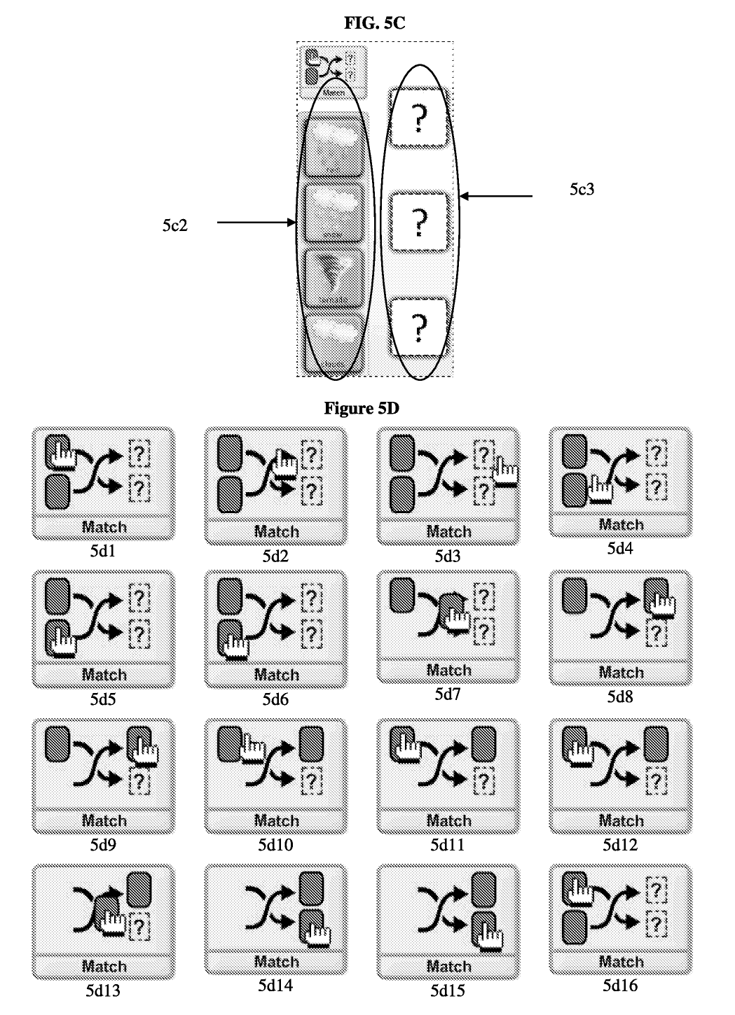

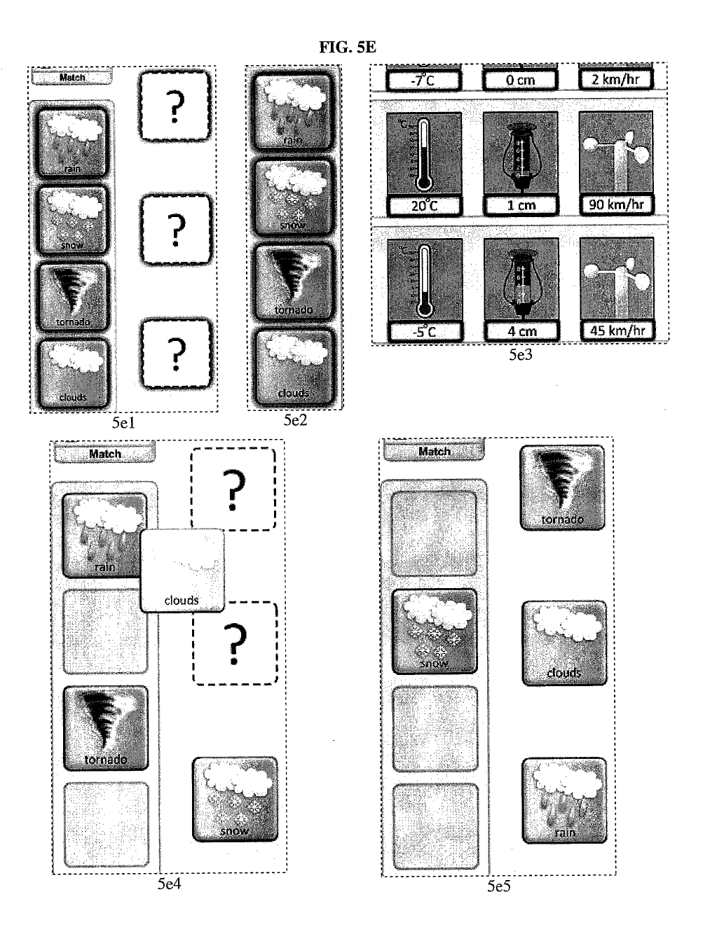

Sample item 1 begins to introduce some of the features consistent with the present invention. When the subject begins sample item 1, item 1 begins with an introductory screen (5a1), shown in FIG. 5A, to permit the subject an opportunity to get acquainted with the relevant material or overall subject matter.

FIG. 5A includes a display area with a navigation/information bar at the bottom of the screen (5a2), stating the question number and the subject's progress through the current set of questions, and permitting the subject to navigate within and between questions. The navigation/information bar is not limited to the information shown, and may include other information such as a timer, subject, title, or any other information. The remainder of the screen (5a3) is the task demand space, or the area in which the subject interacts with the concepts and information being taught and/or tested by the item. When the subject is ready to continue, he or she may select the double-right arrows (5a4) of the navigation bar to progress to the screen shown in FIG. 5B.

FIG. 5B shows the first problem being posed in sample item 1, referred to as “question 1” for convenience. The screen shown in FIG. 5B is interactive and facilitative. In FIG. 5B, the animated expository region, or “animated icon” for convenience, appears in the top left corner as region 5b1. Region 5b1 includes a graphic that represents the task demand space and the response function for this particular item. The graphic is generally designed with elements laid out to correspond with elements of the task demand space. The response function relates generally to the manner in which the subject interacts with screen stimuli in order to respond to a question posed. Here, the graphic in region 5b1 shows a hand over a box that is to be manipulated (corresponding to one of the boxes 5b2), with two arrows suggesting that the boxes 5b2 are to be matched with the boxes 5b3 each containing a question mark.

When the subject scrolls over region 5b1, the animated icon is “turned on” and stays on as long as the pointer remains over region 5b1, as shown in FIG. 5C. While region 5b1 is turned on, the animated icon increases in brightness, changes color or is otherwise modified to emphasize or highlight that it has been turned on, and the relevant components of the response function are highlighted. Specifically, while the pointer is scrolled over region 5b1, boxes 5b2 and boxes 5b3 are highlighted in a manner that draws the attention of the subject to 5b2 and 5b3 (such as with a colored or flashing border around the boxes, as shown by 5c2 and 5c3 of FIG. 5C).

If the subject activates a selector on the input device being used (for example, if the subject clicks or double-clicks the left mouse button on a mouse) while scrolling over region 5b1, the animated icon is “activated.” Activated region 5b1 demonstrates the response function through an animation. Screenshots of one potential demonstrative animation are shown in FIG. 5D.

State 5d1 shows the initial state of the animated icon shown in region 5b1. Once the animated icon has been activated, the animation begins with smooth motions that visually demonstrate the response function for the subject. To get to state 5d3, the animated icon animates the hand icon to move smoothly (shown in state 5d2) toward the upper-right question box to demonstrate that the subject can manipulate the hand icon through the response space. The hand icon then moves (state 5d4) smoothly back toward the left-lower (the bottom gray box) to get to state 5d5. The hand icon then demonstrates “grabbing” the bottom gray box (accomplished by a selector of the input device, such as by a mouse click) by changing its shape to a “clenched” or “clicked” position, as shown in state 5d6. The hand icon, which has now grabbed the bottom gray box, carries it (state 5d7) smoothly to the top question box, dragging it over the question box as shown in state 5d8. The hand then “releases” the gray box, returning to its “unclenched” position, as shown in state 5d9. The hand icon then glides smoothly (state 5d10) to the remaining gray box, shown in state 5d11, clenches it as shown in state 5d12, and drags it (state 5d13) to the bottom question box as shown in state 5d14. The hand icon then unclenches or “releases” the second gray box, as shown in state 5d15. The animated expository region may then return to its initial state, as shown in state 5d16 and may be activated again if the subject wishes to review the animation from the beginning. This return to the initial state need not occur through an animation but may occur abruptly once the animation is completed.

It should be noted that although the different stages of the animation are referred to as states, the so-called “states” may be transient and shown only briefly, and transitions between states can occur with smooth animations. Additionally, if deemed appropriate, transitions between so-called states may occur without animations and smooth motions but rather in still frames if it would save time in developing test items.

At the top of FIG. 5B is a speaker icon (element 5b4), which can be replaced with any other appropriate icon. When the subject presses the speaker icon, the computer provides an audio of the written text and/or other appropriate instructions. Here, for example, pressing the speaker icon could result in a voice speaking the words “match the weather to the measurements.” The voice need not speak in English, and may instead use any other language as appropriate, such as Spanish, French, or signing for the hard of hearing. Selecting the speaker icon (such as by clicking the left mouse button while the pointer is scrolled over the speaker icon) may also result in a pull-down menu or other means of selecting a desired language from two or more available languages. It should be noted that the spoken instructions can be short and limited in length, or be more elaborate. It should also be noted that the subject can be given the option to select varying degrees of spoken instructions depending on whether the subject feels comfortable with what is being asked of him or her. For example, speaker icons of varying size or complexity can be used to represent to the subject that longer and more elaborate instructions can be requested depending on which icon is selected.

It should be noted that in addition to a speaker icon, the screen may include a “request proctor” selection (not shown) using an appropriate image. By selecting such an icon, the subject could be requesting additional assistance, such as interaction with a help section, or qualified proctor through live chat, instant messaging, in person, or other appropriate means.

To the right of the speaker icon is text instructions with some of the words underlined or otherwise highlighted (here, “match,” “weather,” and “measurements” are underlined and bolded). It should be noted that the brief instructions need not be limited to English or to only one language at a time. For example, drop-down menus or other means of changing the displayed language could be provided. It is also noted that such clauses are optional, as the other graphics, images, animations, and other components may adequately facilitate the subject's understanding of the relevant information.

Scrolling over highlighted terms in the brief instructions at the top of the screen results in particular portions of the task demand space becoming highlighted or otherwise emphasized as appropriate. For example, by scrolling the mouse (or other input device) pointer over “match,” the components that are to be matched with each other (items 5b2 and 5b2) are highlighted or emphasized, as shown in 5e1 of FIG. 5E. By scrolling over “weather,” the weather icons 5b2 would be highlighted, as shown in 5e2 of FIG. 5E. And by scrolling over “measurements,” the numeric measurements would be highlighted, as shown in 5e3 of FIG. 5E.

Optionally, clicking on the highlighted words may additionally result in an audio voice speaking the particular words in a given language. Here, for example, clicking on the highlighted “weather” term could result in a spoken reading of that term through speakers or a headset, or a spoken translation of that word into another language, or an explanation of its meaning.

In this manner, the subject better understands what weather-related concepts are being tested, and how to manipulate the task demand space using an appropriate response function to demonstrate his/her knowledge and understanding. Specifically, the response function here requires that the subject click on three of the four weather icons (“rain,” “snow,” “tornado,” and “clouds”) in order to grab them, and drag them over to the appropriate question boxes (as shown in process 5e4 of FIG. 5E) in order to match the type of weather with the measurements that match those types of weather.

Once the subject has finished manipulating the response space using an appropriate response function, the subject can move onto another question or to another part of the same question (5e5 of FIG. 5E shows a potential completed response).

The icons at the bottom of the display area (5b5 of FIG. 5B) allow the subject to move through the questions, to reset or restart the present questions or animations, or to indicate that the subject has completed the present question through appropriate icons. It should be noted that the checkmark icon can be used to indicate that the subject is ready to move on. If the subject has not completed all the required sections, a message can inform the subject of this either through the use of text, spoken words, or other means.

It should be noted that this sort of item design need not be limited to questions related to weather, and items may be varied and revised as deemed appropriate.

Sample items thus connect conceptual, abstract, and academic ideas to real-world and common experiences.

### Sample Item 2

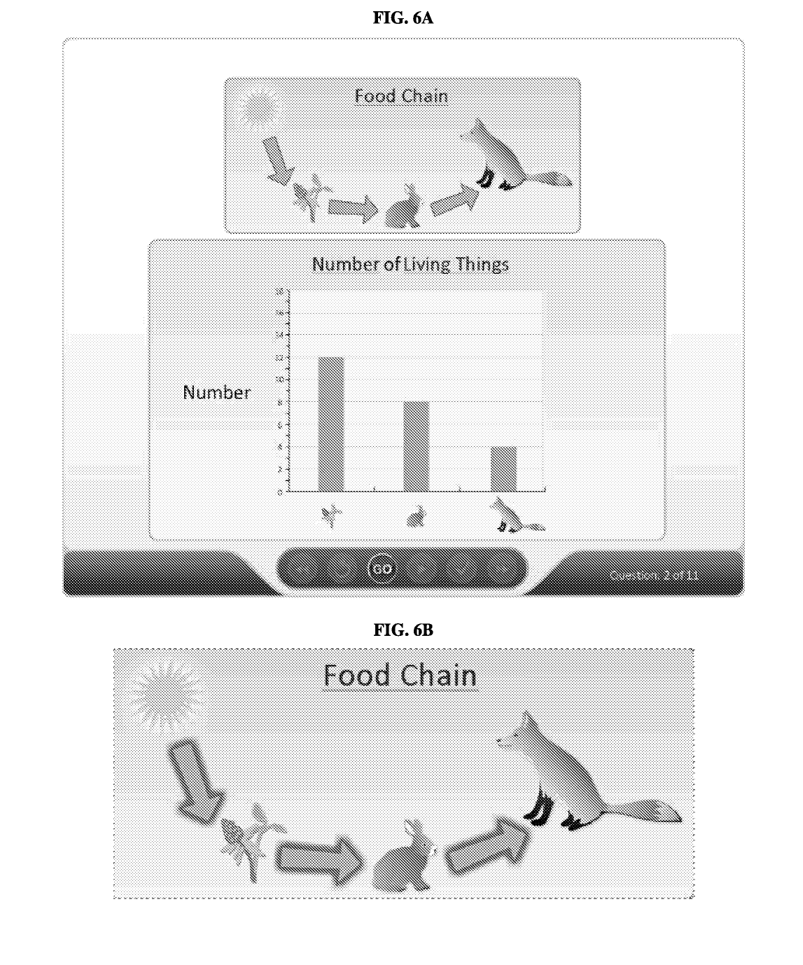

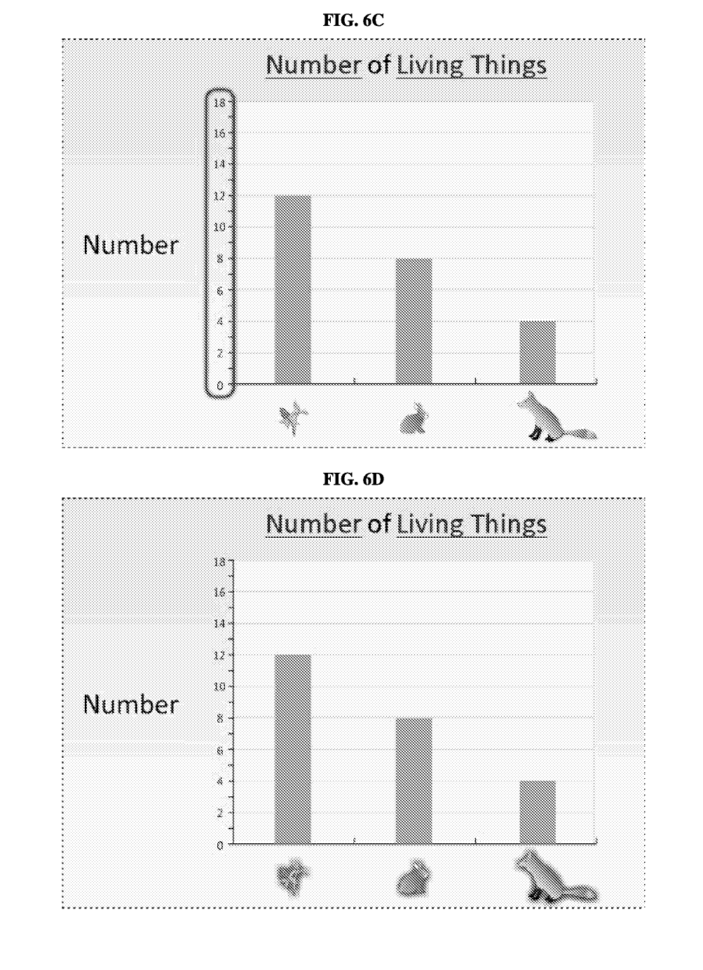

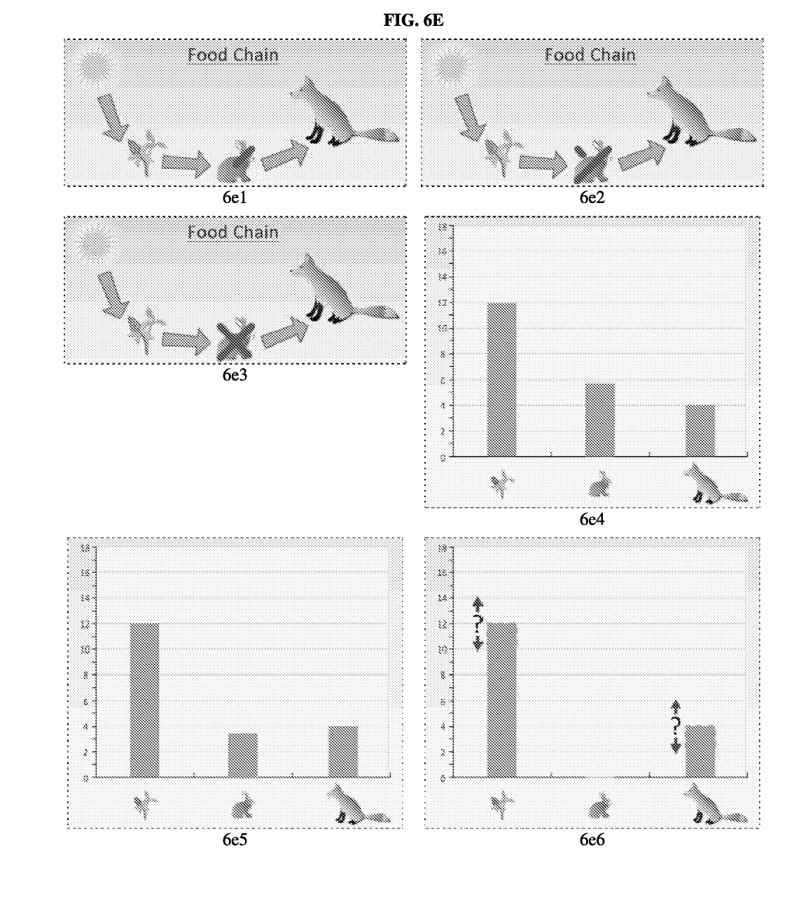

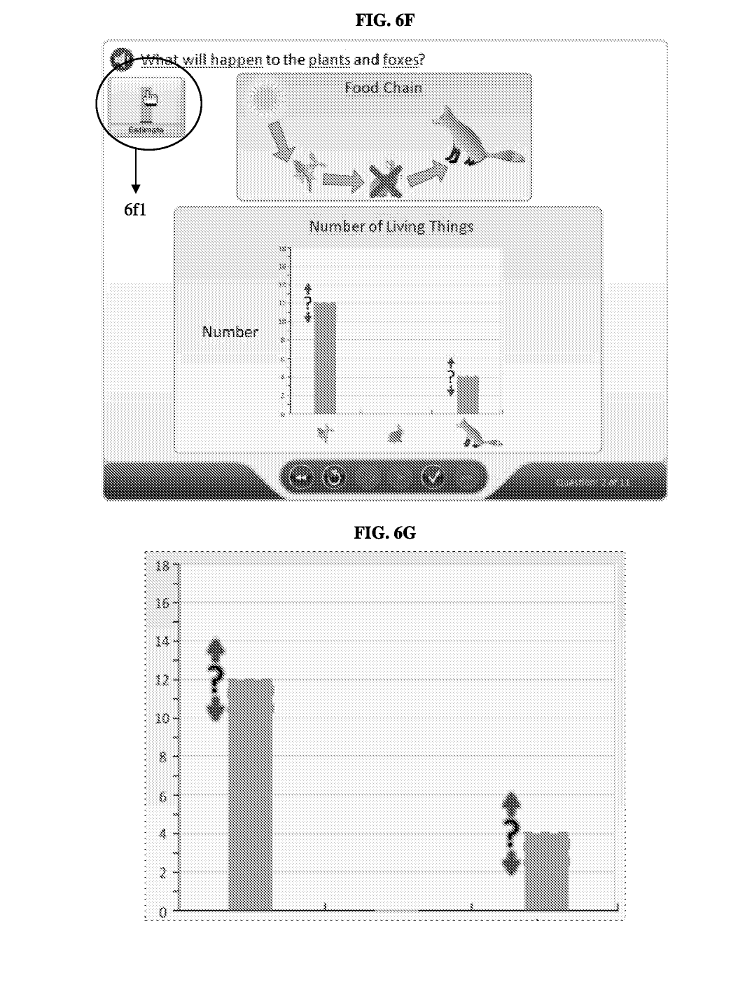

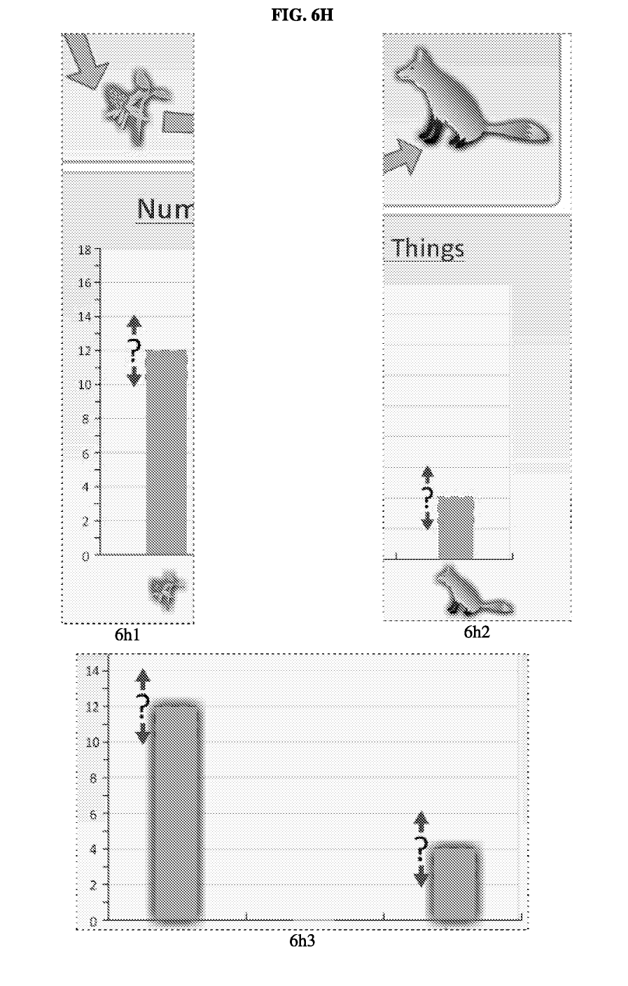

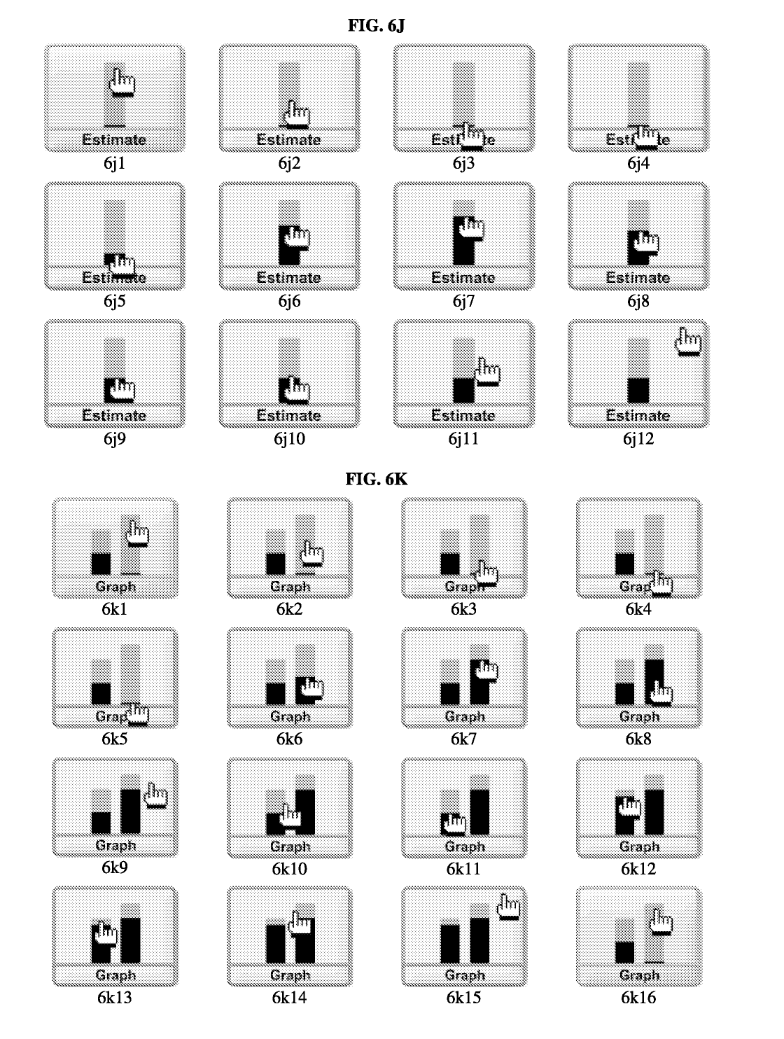

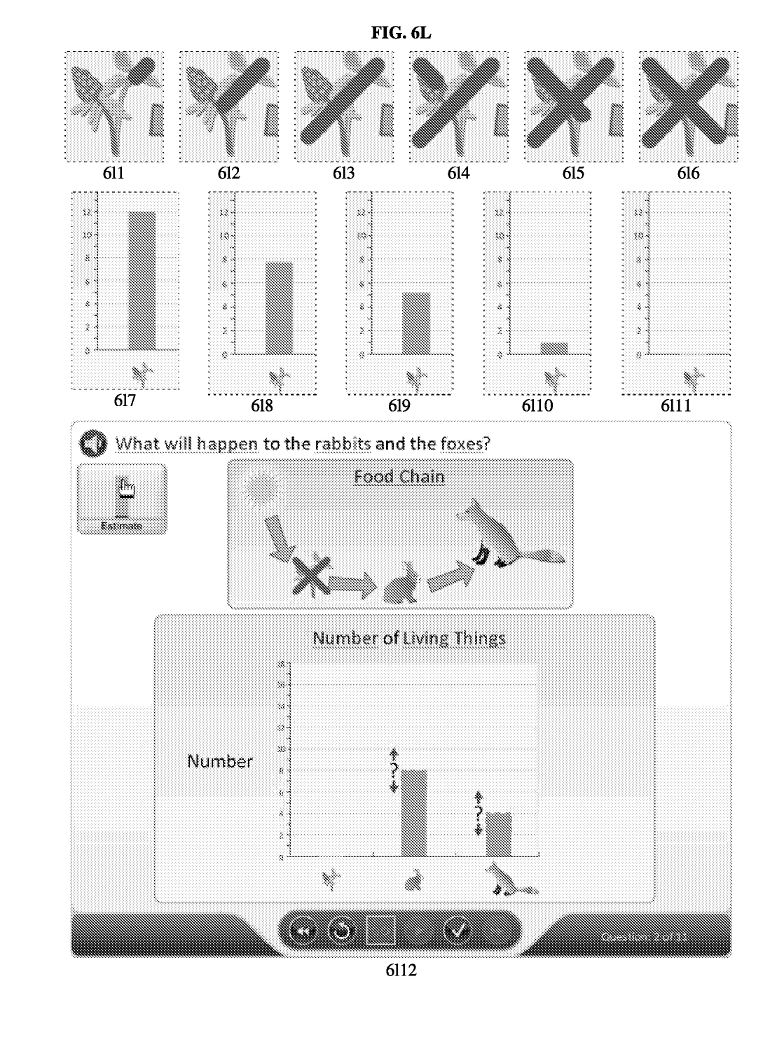

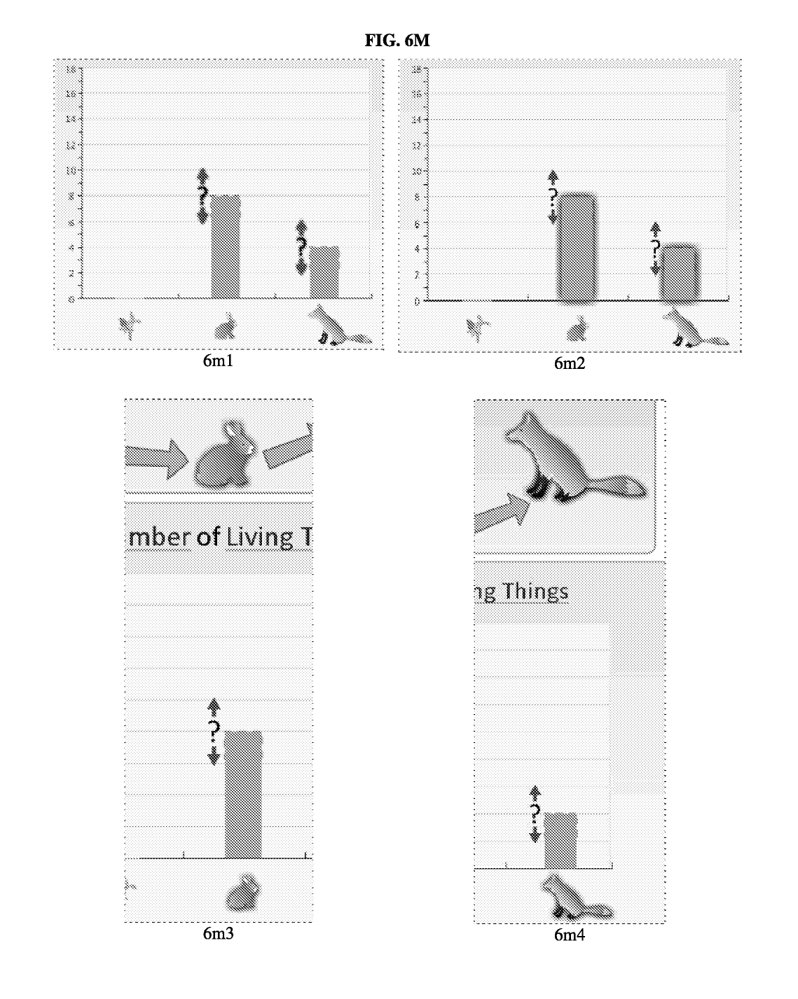

The next sample item begins with an introductory screen in FIG. 6A to acquaint the subject with the material to be considered.

The task demand space is highly interactive and facilitative, allowing the subject to explore the words, images, and ideas presented. For example, by scrolling over the “Food Chain” text, the arrows in the food chain are highlighted, as shown in FIG. 6B, to draw the subject's attention to the chain shown.

Similarly, scrolling over “Number” and “Living Things” results in the relevant items being highlighted, as shown in FIGS. 6C and 6D, respectively.

It is noted that the subject's ability to visually and conceptually connect words and elements with their graphical representations allows the test item to more directly communicate about particular topics and/or evaluate the subject's conceptual understanding, knowledge, and skills without the hindrances of conventional educational and evaluative tools.

By allowing the subject intimately to interact with the task demand space, the subject feels more confident and is better able to demonstrate his or her cognitive sophistication. Further, because these students may be limited by their language, the various representations discussed here and on other items are often not just preferred but become necessary to providing compensatory meaning not provided in another way.

When the subject is ready to continue, he or she presses the “play” icon (the single right-arrow in the navigation/information bar), and sample item 2 begins a first animation and a second animation that visually depict the concepts and context of a first section of item 2. Screenshots of the two animations are shown in FIG. 6E. The screenshots in FIG. 6E are cropped and zoomed portions of FIG. 6A in order to better show the relevant animations.

Screenshots 6e1, 6e2, and 6e3 of FIG. 6E show a first animation in which the rabbit is being crossed out or eliminated from the food chain. Screenshots 6e4, 6e5, and 6e6 show a second animation in which, as a consequence of removing the rabbit from the food chain, the number of rabbits in the bar graph goes from a value of eight to a value of zero. It should be noted that animations occur smoothly, such that the red “X” is drawn and the rabbit bar shrinks to zero smoothly, but to save development time, these can be accomplished with the display of an adequate number of still frames.

At the completion of the second animation of the first section of sample item 2, a first question requiring a response is presented to the subject, as shown in FIG. 6F. Specifically, the optional phrase “What will happen to the plants and foxes?” appears. The response space remains interactive, allowing the subject to explore the displayed words and images. For example, scrolling over “What will happen” results in the highlighting of the question mark with up and down arrows above and below it, respectively, as shown in FIG. 6G. The arrows are highlighted in part to focus the attention of the subject to the values that may be affected as a result of the previous animation.

Similarly, scrolling over “plants” and “foxes” highlights the images of the plants and foxes, as respectively shown in the two screenshots of FIG. 6H.

Along with the first question appears the animated icon 6f1 below the given phrase. Scrolling over the animated icon labeled “Estimate” results in highlighting of the task demand space elements that are to be manipulated by the subject in order to respond to the question posed, as shown in 6h3. Specifically, the relevant task demand space elements here include the bar graphs that are to be used in estimating what will happen to the plants and foxes.

When animated icon 6f1 is activated, it demonstrates the response function through a visual animation, as shown in FIG. 6J.

Here, the response function requires that the subject manipulate the bar graph's bars up or down to adjust the numbers of the given living things to their expected values as a result of the elimination of the rabbit from the food chain. Specifically, the subject is to raise or lower the value of each remaining bar (one for plants and the other for foxes) depending on whether the number of plants and foxes would go up or down. In 6j1, the subject views the initial state of the animated icon. In the initial state, the bar graph depicted in the animated icon is near zero, and the hand icon moves down to the current value of the bar graph (represented by the darker portion of the bar) as shown in states 6j2 and 6j3. The hand icon then clenches or grabs the current value (the darker portion), as shown in state 6j4, and drags it up and down to demonstrate that the values can be manipulated, as shown in 6j5 through 6j9. Specifically, these states show that the subject can move the input device pointer to a bar of the bar graph, select the bar, and drag it up to a higher value or down to a lower value. State 6j10 shows the hand “releasing” the bar, and states 6j11 and 6j 12 show the hand icon moving away from the bar. The animated icon then resets to its initial state after a brief pause (already shown in state 6j1).

An alternative animated icon related to manipulation of a graph is provided in states 6k1 through 6k16 of FIG. 6K.

It is noted that these states are shown automatically, without need for further input from the subject, from beginning to end while the subject reviews the animation. However, an animated icon requiring input from or interaction with the subject may be provided. It is also noted that the speed, level of detail, and number of steps demonstrated in any particular icon can be tailored for, among other things, the age and level of the audience subjects, the relevant concepts and ideas, the particular problems being posed, and system demands. The time that passes between each screenshot shown in the figures is not constant.

It is further noted that the manipulation of the task demand space need not be limited to the manipulation of bar graphs, but may involve the manipulation and modification of, among other things, any graph, chart, figure, image, drawing, or animation.

Once the subject has manipulated the bar values for plants and foxes as deemed appropriate, the subject may press the checkmark icon to continue. Sample item 2 then moves to a second section, and begins a first animation and a second animation of a second section, as shown in FIG. 6L.

As can be seen in the screenshots of FIG. 6L, sample item 2 continues by crossing out the plant, eliminating it from the food chain in a first animation (611 through 616). Sample item 2 then reduces the value of the bar representing the plants down to zero in a second animation (617 through 6111), and presents another question, as shown in screenshot 6112 of FIG. 6L.

The task demand space is interactive as before, and scrolling over “What will happen,” “Estimate,” “rabbits,” and “foxes” results in the highlighting of the relevant components, as shown respectively in the four screenshots of FIG. 6M.

While no words are exchanged during the process of estimating via graph manipulations for either graph, conceptual cognitive skill levels associated with how food sources interact during changing conditions are being documented, and this is being done at at least two levels of cognitive sophistication. Traditionally, beginning to capture this sort of information would necessitate a prohibitively lengthy textual explanation, but here this end is in large part achieved using this type of interactive method and capturing specific process elements associated with how students manipulate the graphs and other components. Scoring algorithms for this item are examples of how both process and end-response data collections can be used to make within screen and between screen judgments, where these judgments result in multiple measures of cognitive complexity.

Although the animated icon is the same in the second section as it was in the first section, this need not be the case. The subject can optionally activate the animated icon again to review the response function for the new question posed. Once the subject responds to the question by manipulating the bar graph to adjust the numbers of rabbits and foxes, the subject indicates that he or she is ready to continue using the navigation/information bar. It is noted that a correct response need not require that exact particular values for the living things be selected using the bars of the graph. Instead, where appropriate, adjustment of the bars so that the numbers of the living things change correctly relative to each other may be acceptable, as may be suggested by the “Estimate” label of the animated icon. That is, where the concept being tested is the understanding that one species changes relative to another, or at a higher or lower rate compared to another, the relative adjustment of the individual bars by the subject may result in a correct response, rather than a particular value for each of the living things. In other words, tailoring which kinds of responses are accepted as correct permits the educator to adjust which concepts are tested, the level of difficulty of questions, and other features of the sample item. For this sample item, the response screens for the two sections (the rabbit and the fox) are separate. However, the screen manipulations have been designed together to provide evidence of a subject's conceptual maturity in understanding food chains and how they are impacted by varying environments. Here, neither screen by itself would provide sufficient evidence of the subject's understanding, and so complementary task demand spaces are designed together to produce adequate evidence. The gestalt of task demand spaces and other components in a sample item plays an important role in effectively accessing a subject's knowledge, skills, and abilities. The orchestration, presentation, and acquisition of targeted and complementary information in such a sample item provide evaluation and educational tools far superior to the conventional approaches.

It is also noted that a new set of screens may include the functionality of previous sets of screens, where appropriate. For example, scrolling over “Food Chain” may highlight the arrows of the depicted food chain in the second set of screens just as they did in the first set of screens.

It is additionally noted that the number and types of sections, task demand spaces, questions posed, animations, animated icons, response functions, and response spaces can be adjusted to suit the particular items, subjects, developers, level of difficulty, and so forth.

### Sample Item 3

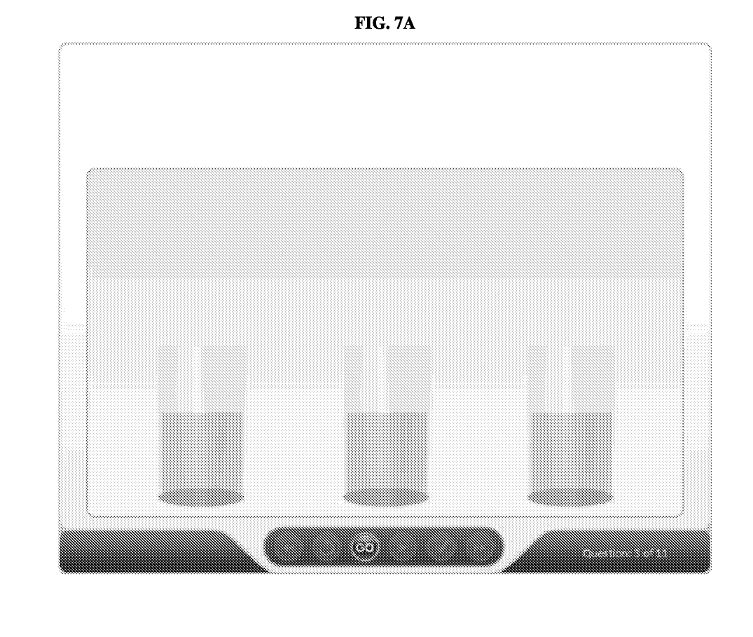

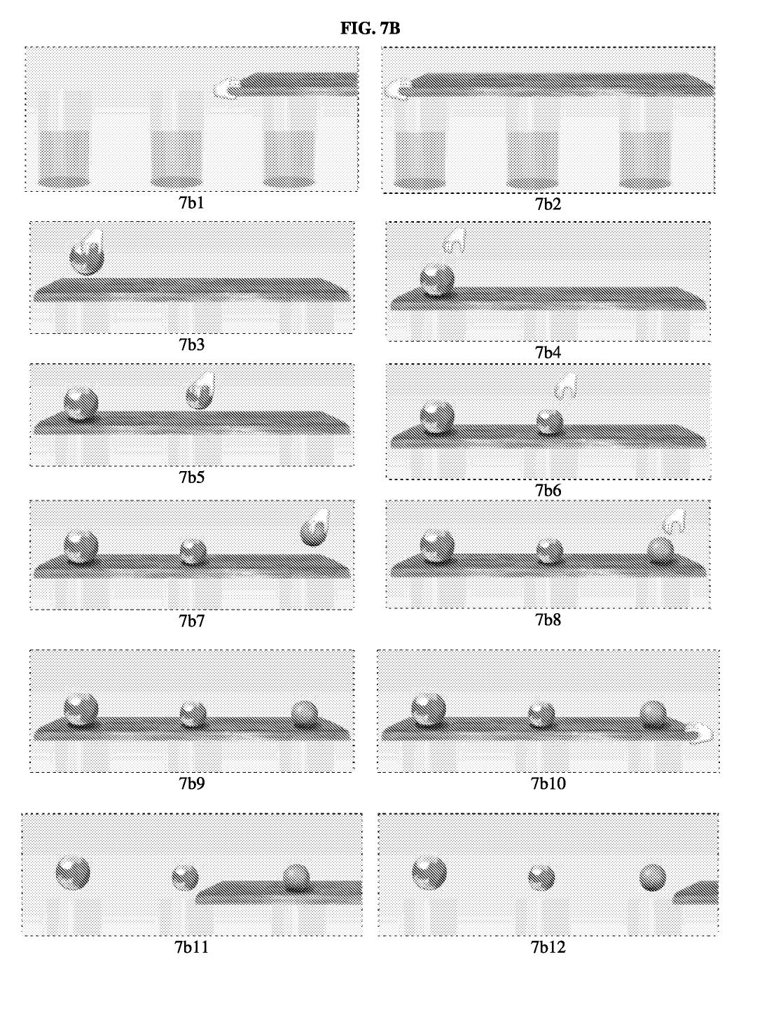

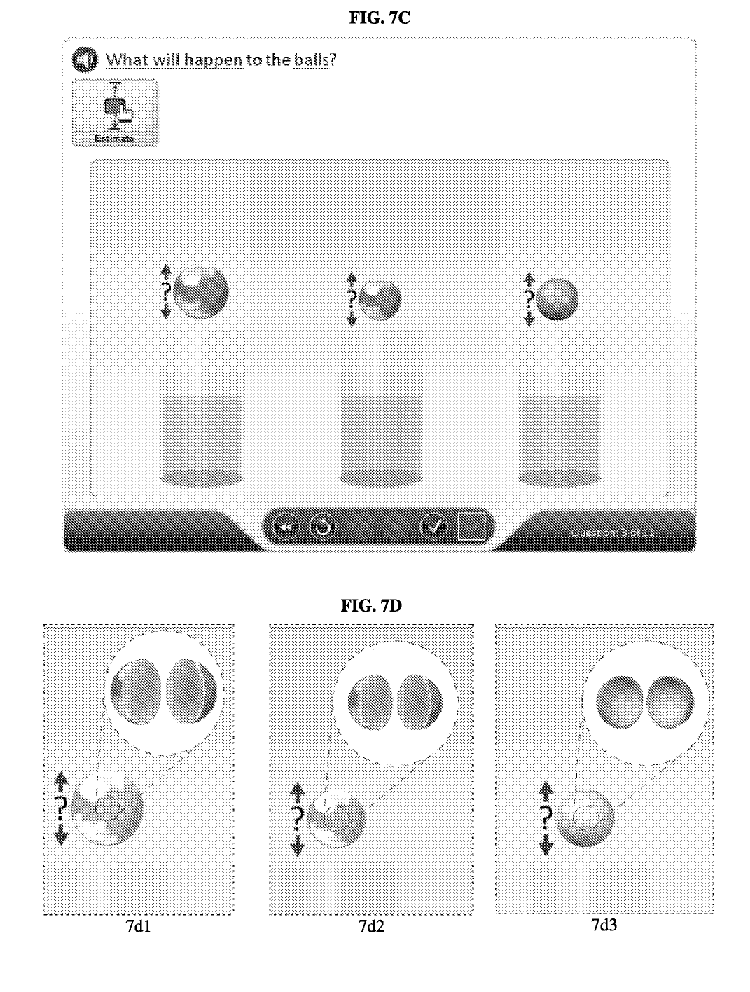

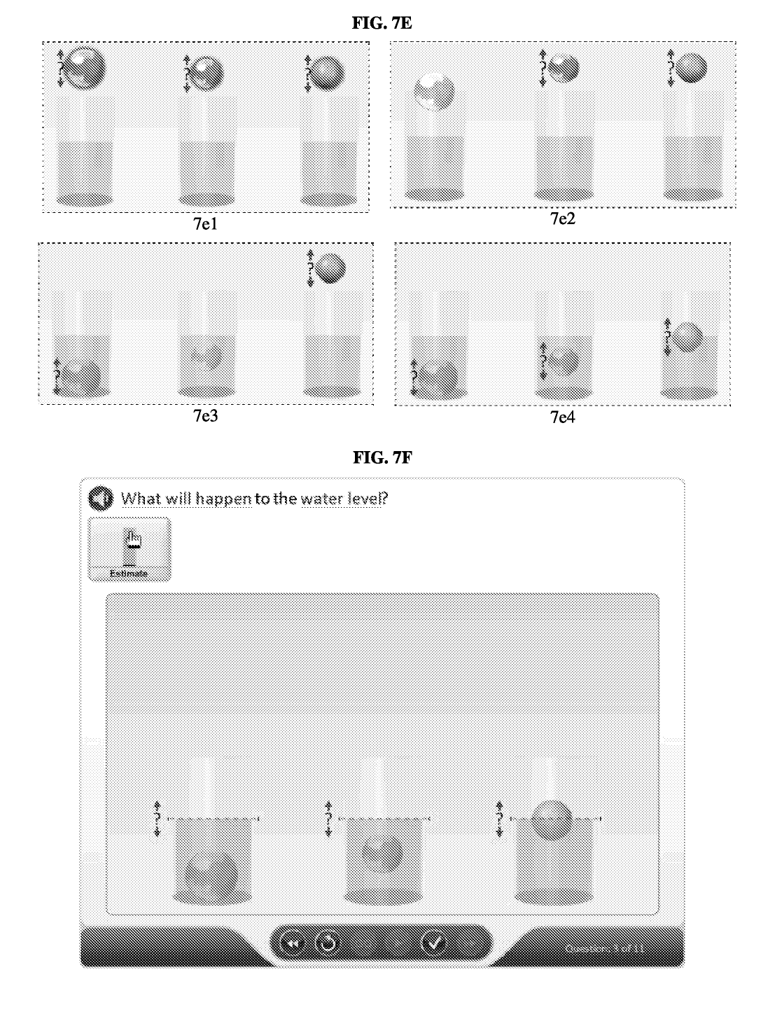

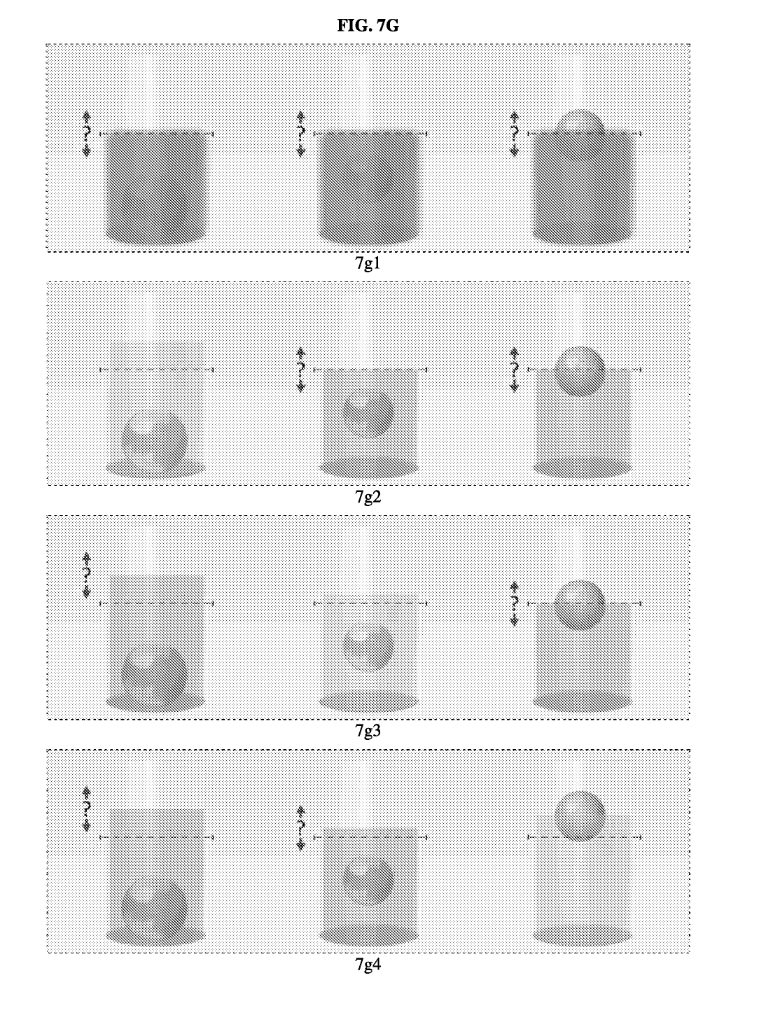

Sample item 3 begins with an introductory screen, as shown in the screenshot of FIG. 7A. The introductory screen acquaints the subject with the situation of three cylindrical containers of liquid. An animation elaborating on the context that will be required to test the targeted scientific principles is depicted in FIG. 7B. In this animation, screenshots 7b1 and 7b2 show a hand dragging a wooden board over the three cylinders. The hand then places a different spherical object on top of the wooden board over each of the cylinders, as shown in screenshots 7b3 through 7b9. Screenshots 7b10 through 7b12 show the hand returning to remove the wooden board that separated the three balls from the three cylinders by sliding the board off the screen. The first problem posed is shown in the interactive screen of FIG. 7C.

The dynamic nature of the sample item permits the subject to learn more details by interacting with the action and response spaces. Rolling over the first, second, and third balls with the input-device pointer, for example, shows their interiors and composition, as shown respectively in screenshots 7d1 through 7d3 of FIG. 7D. Without this type of rollover the explanation of the substance of the balls would otherwise require complex language. The interactive nature of the problem allows the subject to scroll over, for example, the animated icon with the label “Estimate” in order to highlight the target of the response function, as shown in screenshot 7e1 of FIG. 7E. Screenshots 7e2 through 7e4 show the three balls being dragged vertically by the subject according to the response function in order to estimate the positions of the balls in the liquid cylinders based on the character of the balls and on other available information.

Once the subject has positioned the three balls as desired, he or she may navigate to a subsequent section of sample item 3. The screenshot of FIG. 7F shows a sample follow-up question inquiring about the consequences of the subject's positioning of the balls. Specifically, the first section inquired about the position of the balls, and this subsequent section deals with the water level that results from the subject's positioning of the balls in the previous section. This manner of conceptual scaffolding by splitting up related concepts into separate sections, among other things, reduces the likelihood of confusion on the part of the subject, and permits different sections to serve as verification of the subject's understanding. The dynamic nature of the methods in this sample item provide for these and other marked advantages over conventional methods.

Screenshot 7g1 of FIG. 7G shows highlighting or emphasis of what is being estimated (the water level) when the animated icon labeled “Estimate” is scrolled over by the subject. Screenshots 7g2 through 7g4 show the subject adjusting the left, middle, and right water levels, respectively. In screenshot 7g4, the wooden ball, which the subject indicated would float, also adjusts positions while the water level is being adjusted so that the floating wooden ball would continue to float at the new water level.

It should be noted that the ball and water level positions that are entered by the subject at one point of the sample test item are remembered by the system even as different questions, introductions, and animations are displayed and navigated through by the subject using the navigation region. This helps maintain continuity and consistency so that the consequences of the actions and perceptions of the subject can be better demonstrated and evaluated.

These methods of evaluating subjects' understanding of scientific principles provide additional marked advantages. The two sections with subsequent follow-up questions permit the splitting-up of related concepts, such as displacement and buoyancy, to test principles from different angles, to confirm a subject's understanding of previously and subsequently presented material, and to cumulatively teach or evaluate overall scientific principles.

### Sample Item 4

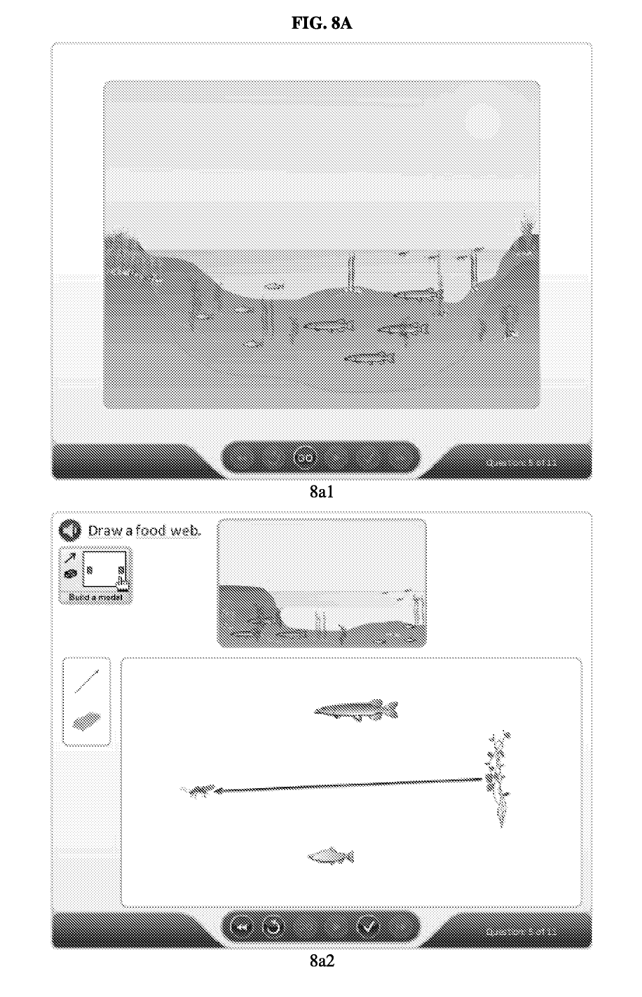

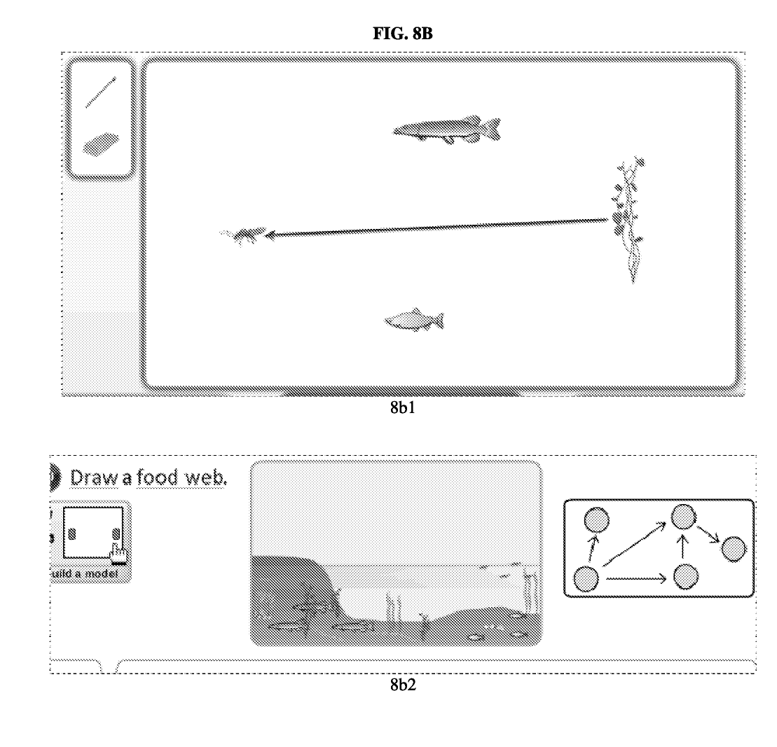

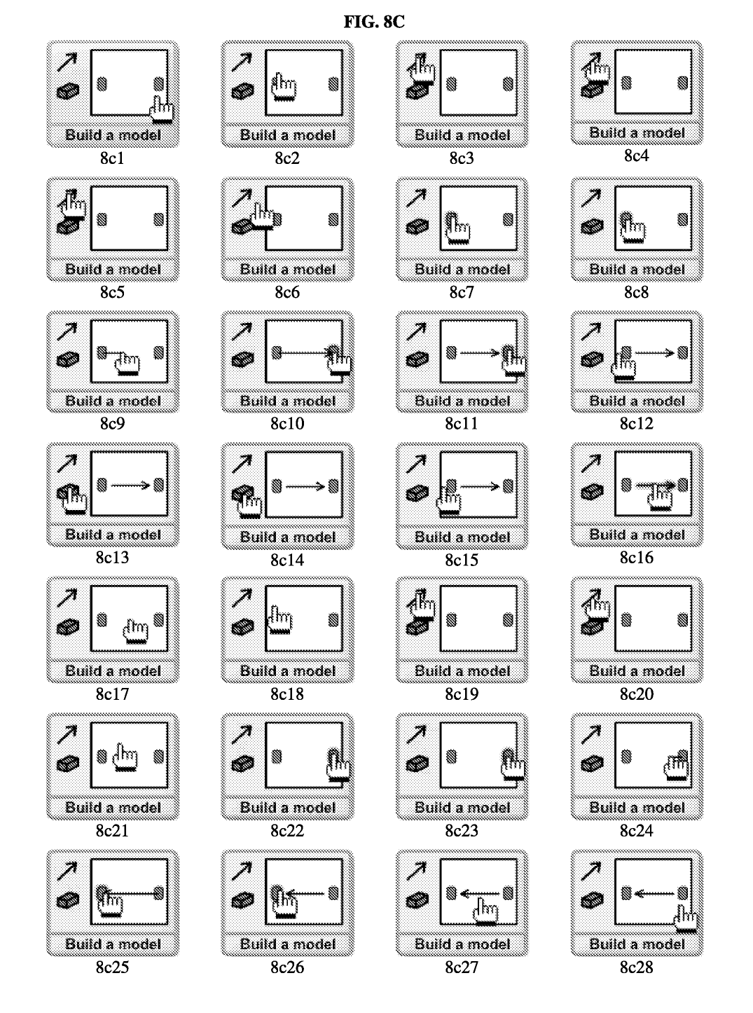

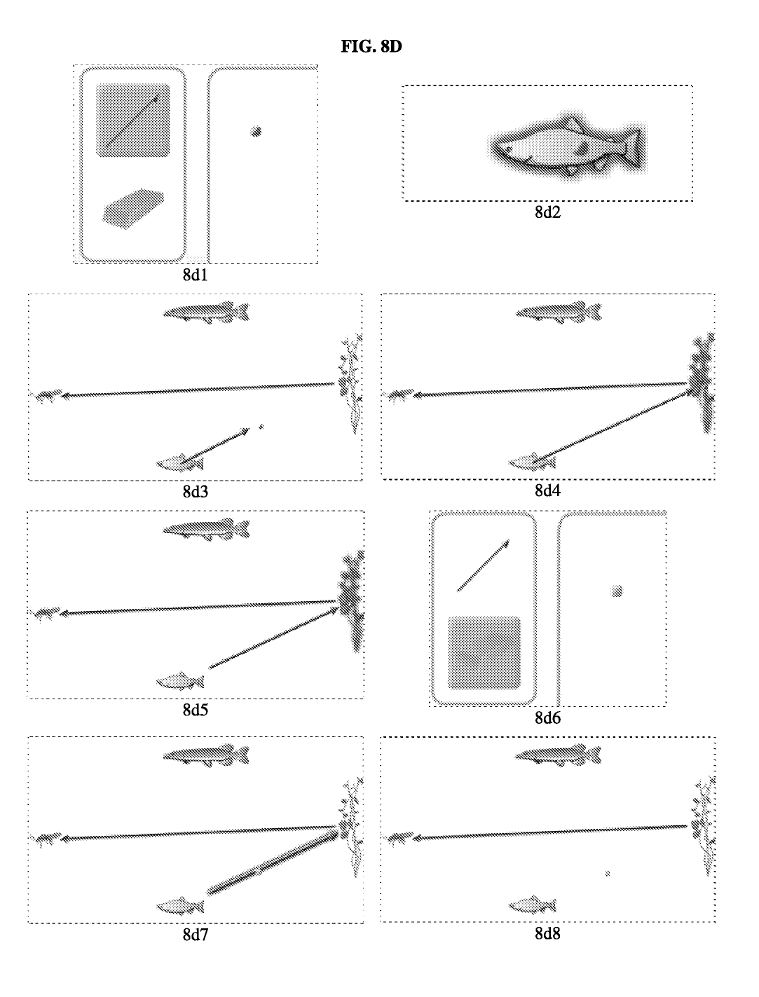

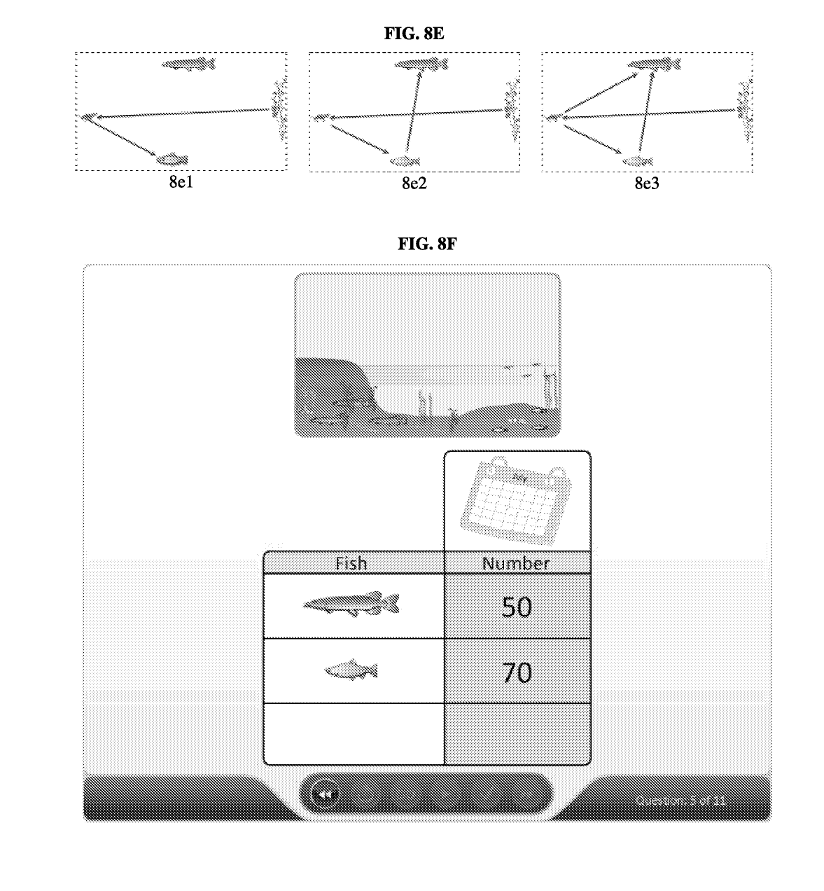

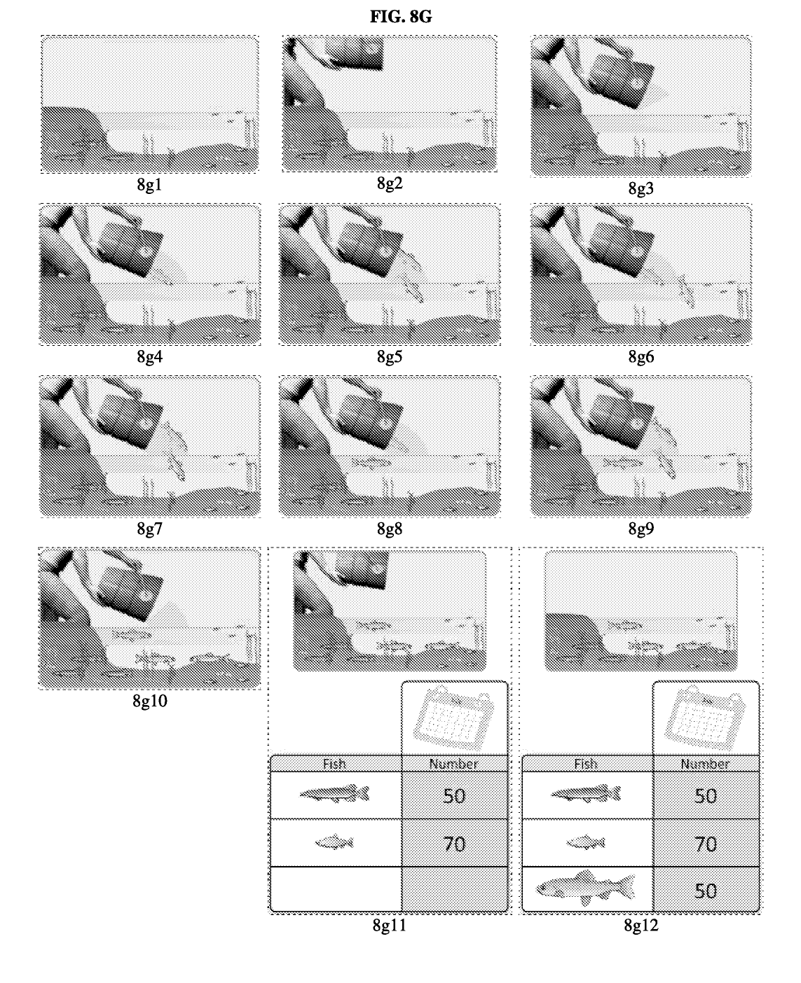

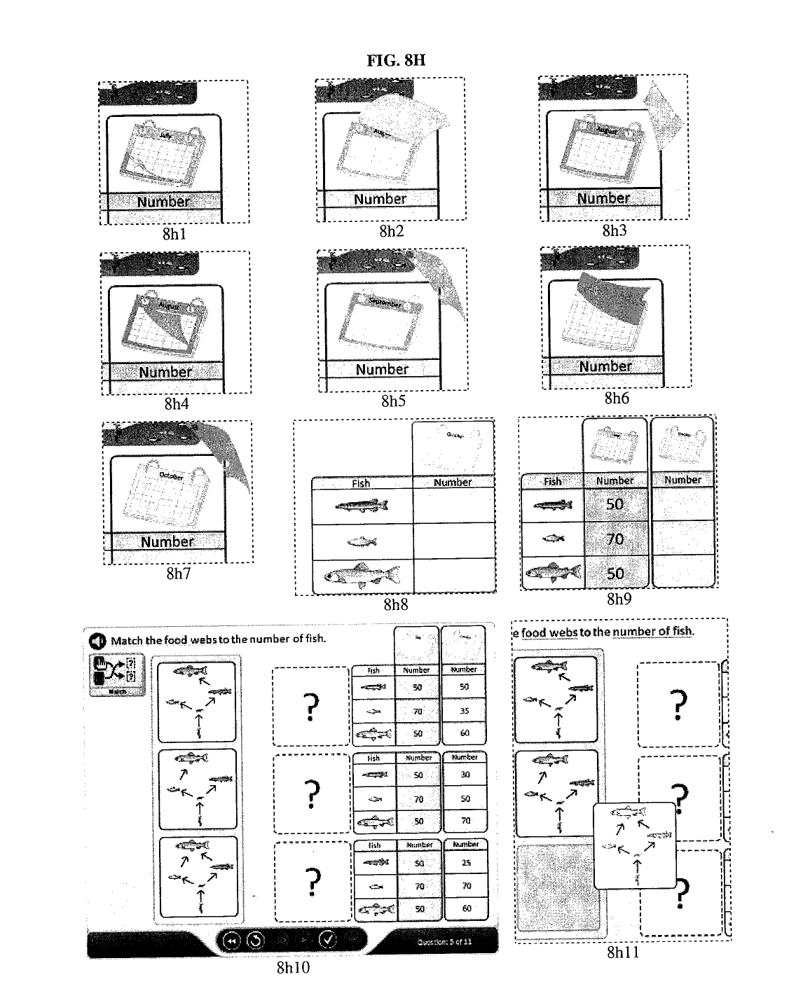

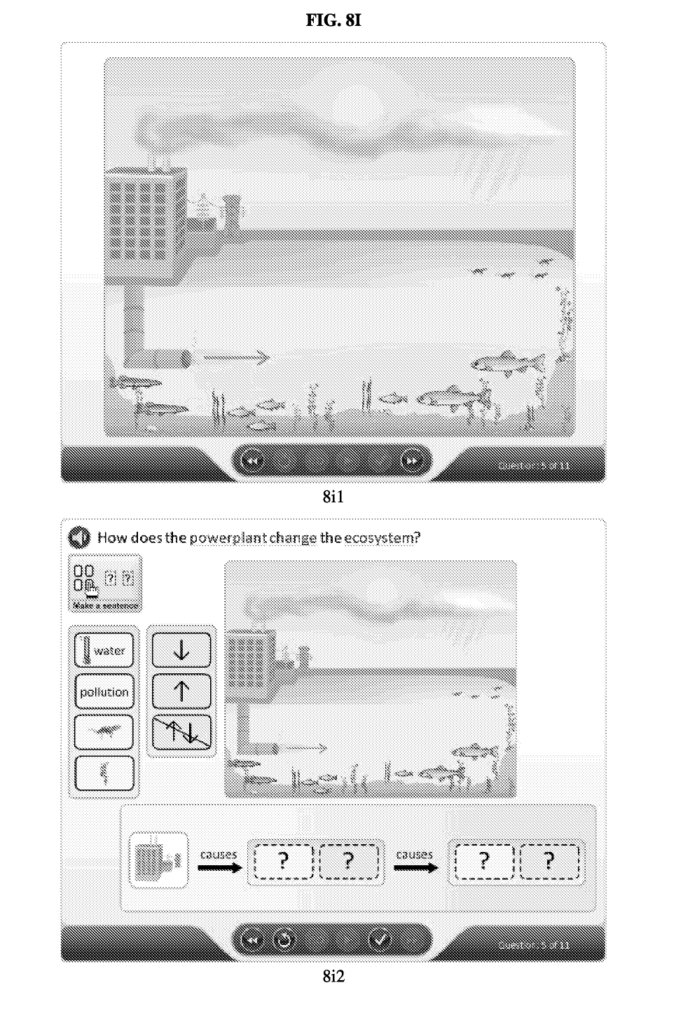

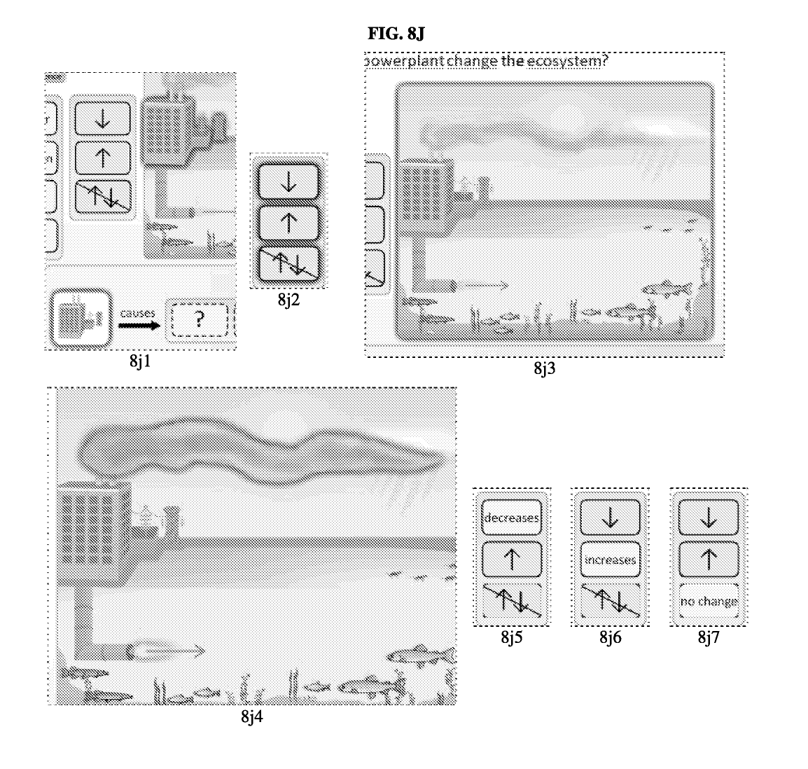

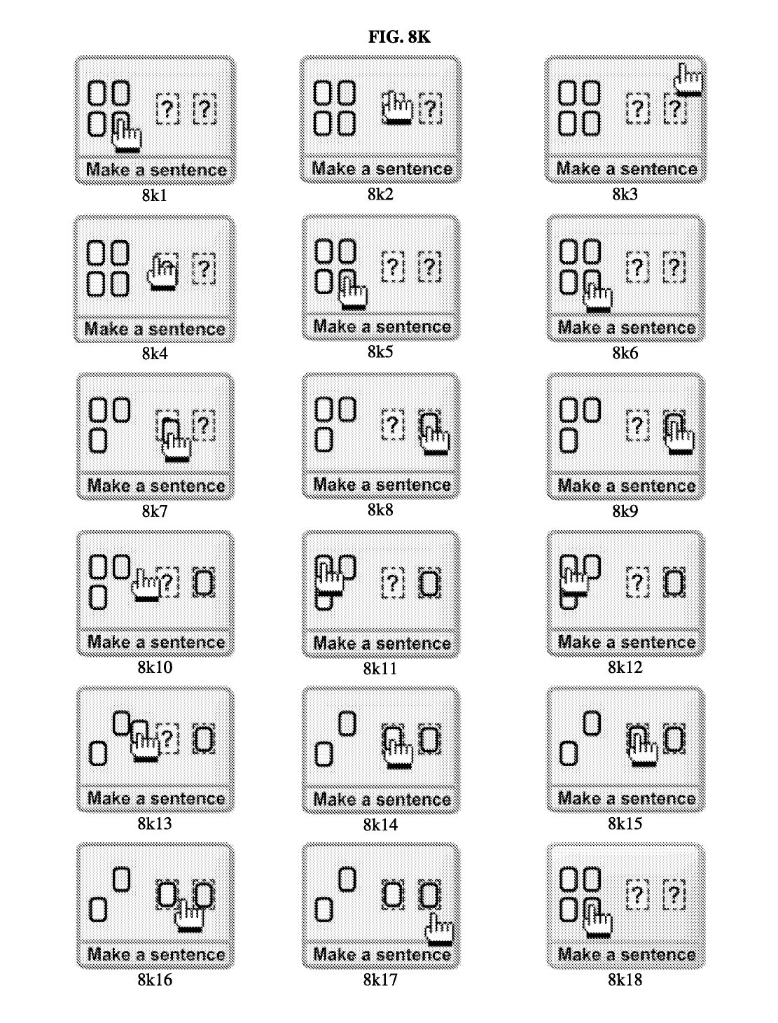

Sample item 4 begins with an introductory screen and a first question presented in an interactive task demand space, as shown respectively in screenshots 8a1 and 8a2 of FIG. 8A. Screenshot 8b1 of FIG. 8B shows the highlighting of the relevant regions of the response space when the subject scrolls over “Draw.”

In addition to highlighting existing portions of the response space, scrolling over interactive components of the response space may additionally introduce new images, animations, text, or other components to facilitate the subject's understanding. For example, when the subject scrolls over “food web” in the phrase “Draw a food web,” a new schematic may appear to depict a food web visually, as shown in screenshot 8b2 of FIG. 8B. The newly-appearing schematic may remain for the duration of the sample item, or disappear once the user is no longer scrolling over “food web” so as to limit screen clutter.

The animated icon for this section of sample item 4 demonstrates how the subject responds to the questions posed by building a model, as shown in FIG. 8C. The arrow and the three-dimensional box on the left side of the animated icon are representative of the arrow and the pink eraser, respectively, on the left side of the task demand space. It should be noted that, for easier understanding by subjects, animated icons may be drawn in a manner that visually correlates with the remainder of the task demand space.

The initial state of the animated icon is shown in state 8c1 of FIG. 8C. The hand icon moves to the arrow at the top-left of the animated icon, as shown in states 8c2 and 8c3. The hand icon clenches and unclenches to select the arrow, as shown in states 8c4 and 8c5. The hand icon then moves over to the left gray rectangle in the represented response space, as shown in states 8c6 and 8c7. The hand icon then clenches to select the left rectangle, as shown in state 8c8. The left rectangle is highlighted to draw the subject's attention to it when the hand icon is positioned over it, as shown in states 8c7 and 8c8. The hand icon then moves to the right gray rectangle, drawing an arrow from the first to the second gray rectangles, as shown in states 8c9 and 8c10. Once the destination for the arrow is reached, the hand unclenches, and the arrow is completed, as shown in state 8c11. The right rectangle is highlighted to draw the subject's attention to it when the hand icon is positioned over it, as shown in states 8c10 and 8c11. The hand icon then moves leftward to the three-dimensional box that represents the pink eraser in the task demand space of sample item 4, as shown in states 8c12 and 8c13. The hand icon demonstrates selection of the three-dimensional box by clenching, as shown in state 8c14. The hand icon then moves rightward to the arrow that has been drawn, as shown in states 8c15 and 8c16. The arrow is highlighted when the hand icon scrolls over the arrow to draw the subject's attention to the arrow and to indicate a potential target of the selected eraser icon, as shown in state 8c16. The hand then clenches to show selection of the arrow, making the arrow disappear and demonstrating the eraser function, as shown in state 8c17. The hand icon then unclenches and progress back to the arrow at the top left of the icon, and repeats the above arrow-drawing process in the opposite direction, as shown in states 8c18 through 8c26. The last two states, 8c27 and 8c28 show the hand icon moving to the side of the represented task demand space to permit the subject to view the result of the actions demonstrated unhindered by the hand icon.

It is noted that this animation occurs automatically as a demonstration of the response function of the sample item. It does not require further input from the subject for the animation to progress. Multi-stage animated icons requiring participation by the subject may be suited for certain animated icons, however, if deemed appropriate due to its level of complexity or nature of the response function. Participation in multi-stage animated icons by the subject may be as simple as navigation through the stages of the multi-stage animated icon, or may involve practicing of the applicable response function.

In using the teachings of the animated icon, the subject can begin building a model by selecting the arrow, as shown in screenshot 8d1 of FIG. 8D. The input-device pointer becomes a gray rectangle to show that the function of the input device (for example, the computer mouse) has become that of the arrow. Screenshots 8d2 shows the pointer scrolling over the bottom fish (note that the bottom fish is highlighted when the pointer scrolls over it), and screenshot 8d3 shows selection of the bottom fish and dragging of an arrow toward the plant.

When the gray icon reaches the plant, the plant is highlighted as shown in screenshot 8d4, and when the subject un-clicks the device pointer, the arrow is completed, as shown in screenshot 8d5.

If the subject wishes to erase an arrow he or she has drawn, the subject may click on the pink eraser on the left of the response space. Once the pink eraser is selected, the input device pointer becomes a pink square to demonstrate that the function of the eraser is active, as shown in screenshot 8d6 of FIG. 8D. The subject may then scroll over the arrow he or she wishes to erase, highlighting the line as shown in screenshot 8d7. When the subject selects the arrow by clicking the mouse button, for example, the arrow disappears (that is, it is “erased”), as shown in screenshot 8d8.

The subject may then, for example, draw an arrow from the fly to the bottom fish, from the bottom fish to the top fish, and from the fly to the top fish by the above methods, as shown respectively in the three screenshots of FIG. 8E. It is noted that the arrow need not be drawn to the exact center of the images for the sample item to understand what is intended by the subject. For example, the arrow may snap to position even if the subject drags the arrow to the front of the top fish rather than to its center (not shown).

In a subsequent section, sample item 4 may progress to the second introductory screen, as shown in the screenshot of FIG. 8F. The sample item can then progress through an animation that visually demonstrates what has occurred in a manner that can be readily understood despite potential internal and external barriers to conceptual understanding. For example, screenshots 8g1 through 8g10 of FIG. 8G visually demonstrate that a particular species of fish is introduced to the depicted pond with the given fishes. The table in screenshot 8g11 then acquires a certain number of the new fish in its third row, as shown in screenshot 8g12. It is noted that the screenshots shown are portions of the larger display area that have been cropped and zoomed for ease of viewing. The cropped portions show the regions of the overall display area that contain an animation, a new image, or are otherwise evolving.

Screenshots 8h1 through 8h9 of FIG. 8H visually demonstrate that a particular amount of time (about three months) is passing through the tearing away of pages from a calendar. Screenshots 8h8 and 8h9 show that, as a result of the passage in time, a new column is added to the table to represent a new point in time consistent with the new month. As such, the calendar in the first column of 8h9 shows the month of July and the calendar in the second month shows the month of October. Screenshot 8h10 shows a subsequent question based on the situation that has been described and placed into context. The response space is interactive, allowing the subject to receive clarification by interacting with the components in the response space. Screenshot 8h11 shows one of the food webs being dragged to one of the question boxes as part of the execution of the response function previously demonstrated by the “Match” animated icon. Even though a simple interactive method of matching may be used here, the conceptual understanding required to distinguish between how the four different webs represent the four tables is quite sophisticated. Further, if subjects answer incorrectly, scoring algorithms evaluate the lower level of skill complexity of the subjects by how they incorrectly perceive the relationships between each of the tables and the models they select to represent them. This product provides further data to the subjects which are impossible to capture when an item would simply be marked incorrect.

Screenshot 8i1 in FIG. 8I shows a third introductory screen, showing the introduction of a polluting power plant in the ecosystem. Another problem is subsequently presented in screenshot 8i2 based on the new parameters of the test environment. This task demand space is interactive again, and highlighting “powerplant,” “change,” “ecosystem,” “pollution,” the up arrow, the down arrow, and the crossed-out arrows are shown respectively as examples in screenshots 8j1 through 8j7 of FIG. 8J.

The “Make a sentence” animated icon is analogously demonstrated by eighteen states (8k1 through 8k18) in FIG. 8K. Screenshots 8k1 through 8k3 show a hand icon moving to the top-right corner in an introductory phase of the animated icon. From the top-right corner, the hand icon moves over to a content box (8k4 and 8k5), selects the content box (8k6), drags the content box to the right question box (8k7 and 8k8), releases the content box (8k9), and analogously drags a second content box to the left question box (8k10 through 8k15). It should be noted that screenshots 8k4 through 8k5 may be characterized as part of a demonstrative phase of this animated icon. In screenshots 8k16 and 8k17, the hand icon moves away from the represented response space and to the side of the represented task demand space in part to permit to the subject better to view the final state of the demonstration. Screenshot 8k18 shows a return of the animated icon to its initial state prior to activation. It should be noted that screenshots 8k16 through 8k18 may be characterized as part of a conclusory phase of this animated icon.

It is noted that a different type of animated icon is provided for this section of sample item 4 because the question(s) posed require a different response function. This response function is unique to this method, as proposed here, and is quite efficient at demonstrating complex cognitive understanding with few or no words.

It is further noted that the context, problems, and other information conveyed by sample item 4, as shown above, would have been extremely text intensive and prohibitively difficult using conventional methods. Furthermore, students would have needed to produce a heavily loaded textual explanation to begin achieving the same aims as those successfully achieved with this response approach. As this sample item shows, methods and systems consistent with the present invention make complex concepts and problems accessible to considerably greater numbers and types of subjects.

### Sample Item 5

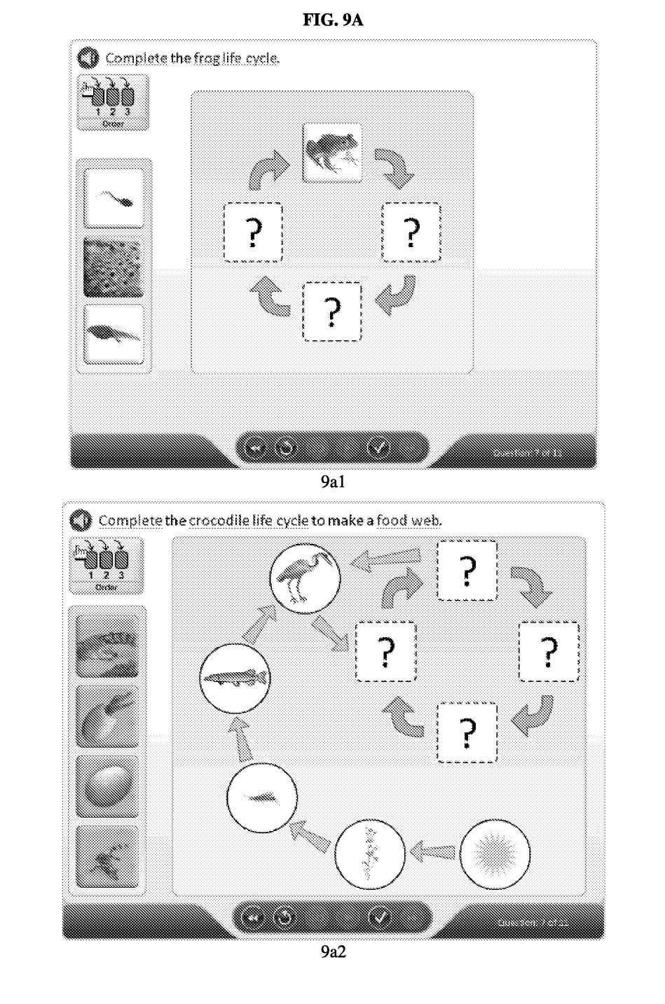

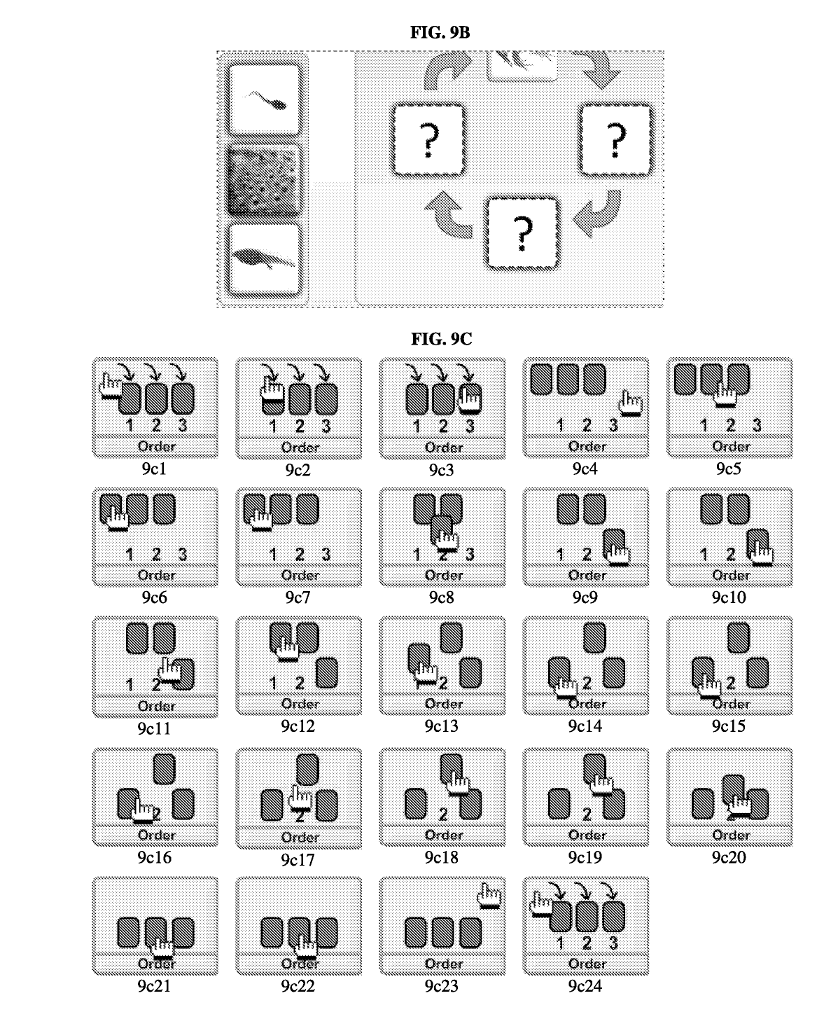

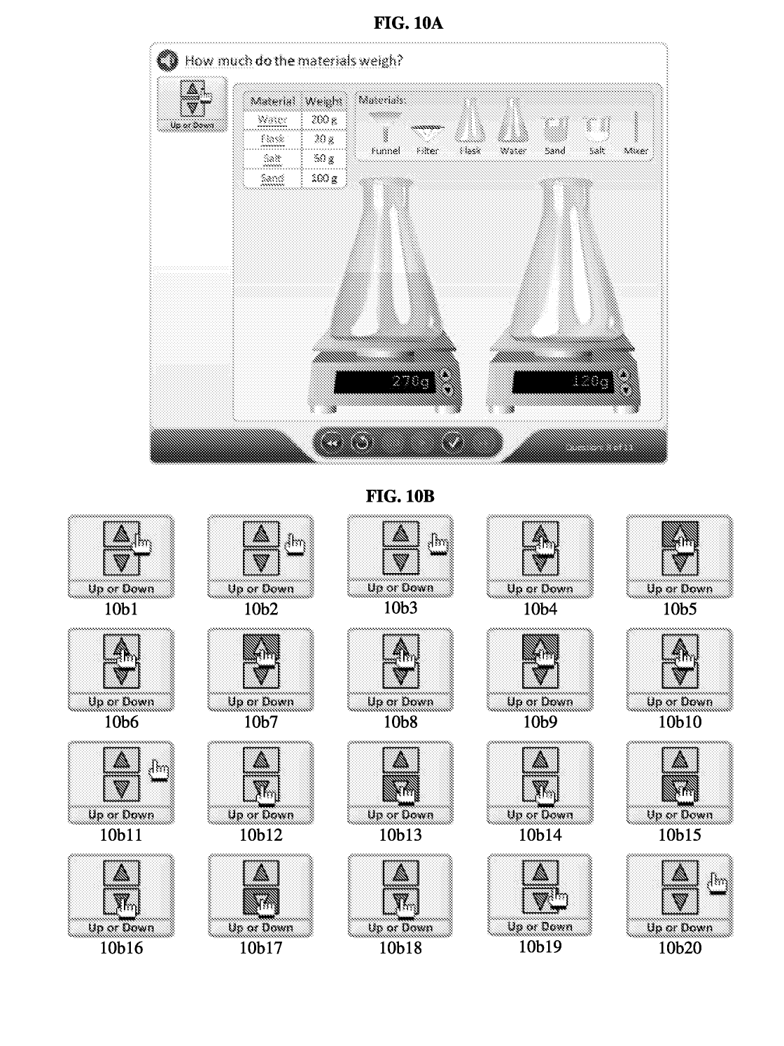

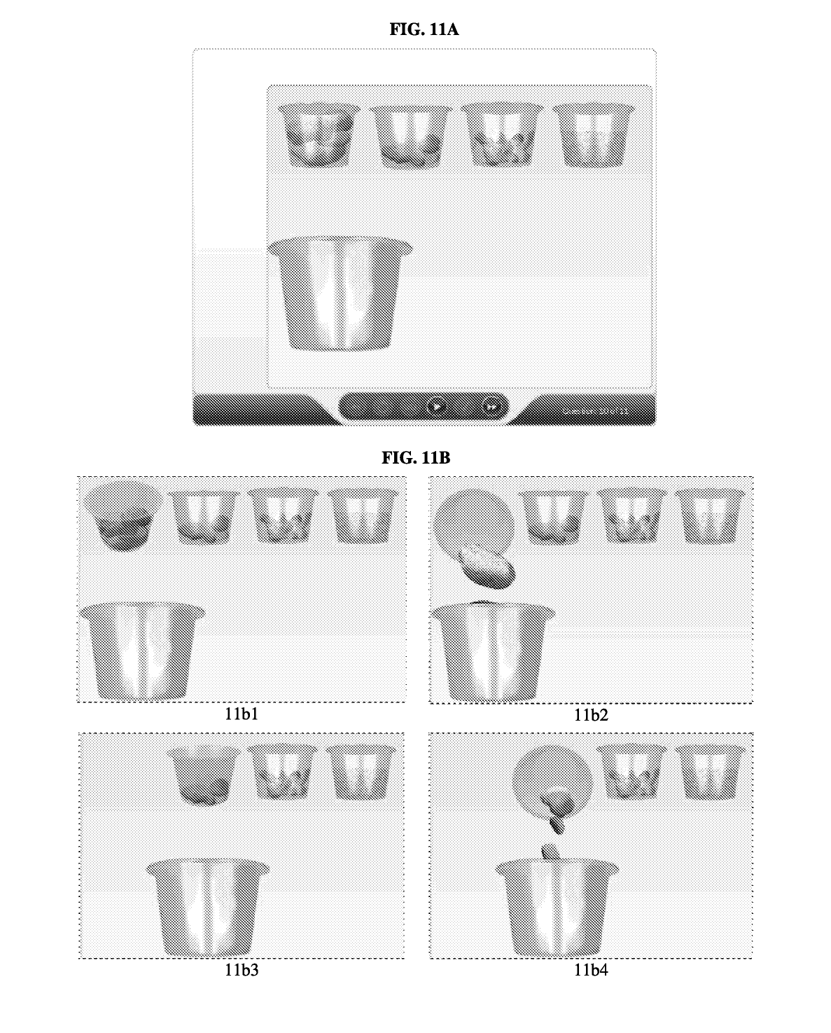

FIG. 9A shows two problems posed as part of a biology-related sample item in screenshots 9a1 and 9a2, respectively. The screenshot in FIG. 9B shows the highlighting of the elements that are to be ordered when the subject scrolls over the animated icon labeled “Order” in the first problem. It should be noted that the sample item is not shown in its entirety.

FIG. 9C shows an animated icon that demonstrates an ordering response function. State 9c1 shows the initial state of the animated icon, with the hand icon in the vicinity of the top left corner. States 9c2 and 9c3 show that the hand icon moves over to the right of the icon. State 9c4 shows that once the hand has reached the right of the animated icon, the three boxes set themselves to their unordered position at the top left of the animated icon, ready to be ordered. The hand icon then moves toward the leftmost gray box, as shown in states 9c5 and 9c6. Once the leftmost gray box is reached, the hand clenches, representing that the subject may click on or select the scrolled-over box, as shown in state 9c7. The hand then drags the selected gray box over the number 3, as shown in states 9c8 and 9c9, and un-clicks or deselects the gray box, as shown in state 9c10. The hand then moves over to the remaining gray boxes, and drags them over to the remaining available positions (“1” and “2”), as shown in states 9c11 through 9c22. The hand then moves away from the ordered gray boxes, as shown in state 9c23, and resets to its initial state in 9c24.

### Sample Item 6

In this sample item (not shown in its entirety), the animated icon demonstrates for the subject the response function of adjusting given values to show understanding of the relevant scientific principles.

FIG. 10A shows a screenshot of a problem posed by this sample item. The animated icon, explained further below, demonstrates the response function of adjusting values on the scales.

FIG. 10B explains the animated icon labeled “Up or Down.” State 10b1 shows the initial state of the animated icon. The hand moves over to the side of the animated icon, to demonstrate that the hand icon is free to move about the task demand space, as shown in states 10b2 and 10b3. State 10b4 shows that the hand then moves to the up arrow, and state 10b5 shows that the hand icon “clenches” over it, or selects it, turning the surroundings of the arrow dark gray to show that it has been selected. State 10b6 shows de-selection of the up arrow and its return to a lighter shade of gray. The hand icon repeats the selection of the up arrow, as shown in states 10b7 through 10b10. The hand icon then moves to the lower arrow and selects it three times, as shown in states 10b11 through 10b18. States 10b19 and 10b20 show the hand icon moving away from the arrows before the self-contained animated icon returns to its initial state.

### Sample Item 7

With many complex problems involving, for example, complicated principles and ideas, it is often important to convey to the subject a particular situation that is achieved through a set of intermediary steps. By visually demonstrating the steps that brought about the situation that serves as the context for a test item, the subject mentally visualizes and conceptualizes what is being tested on his or her own terms, overcoming such barriers as language limitations and cultural background. This allows the more direct connection between the subject's cognitive sophistication and the concepts and/or knowledge being taught and/or tested.

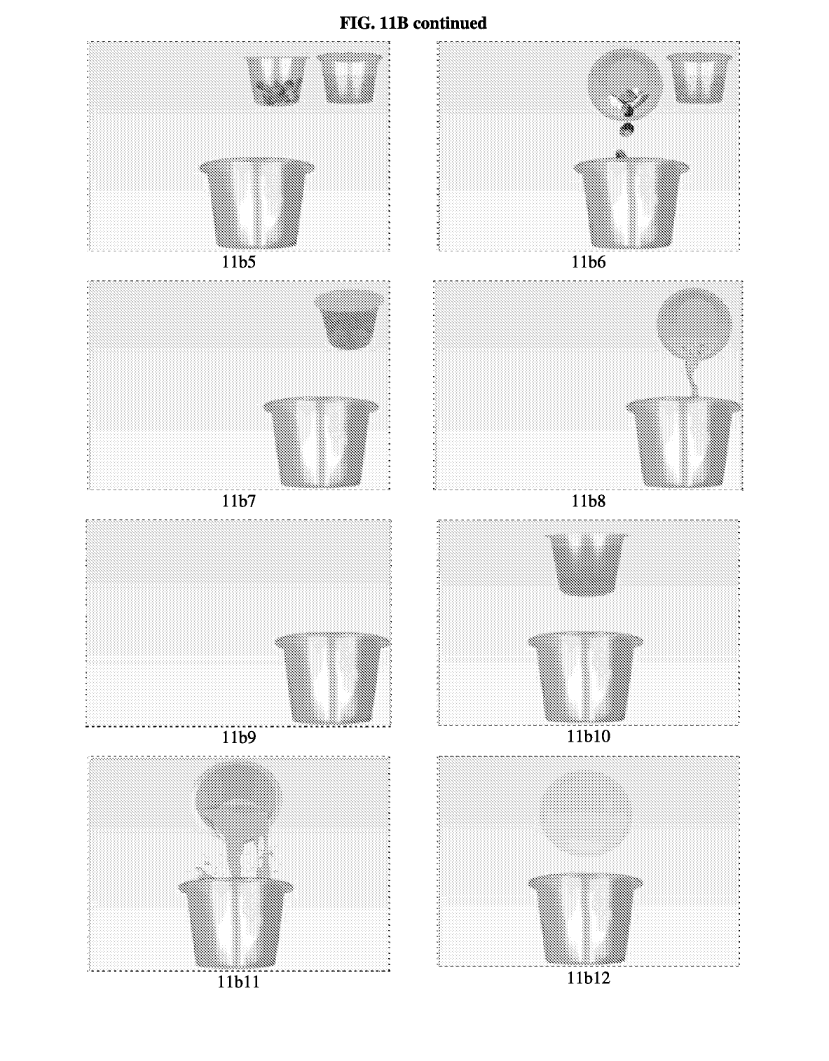

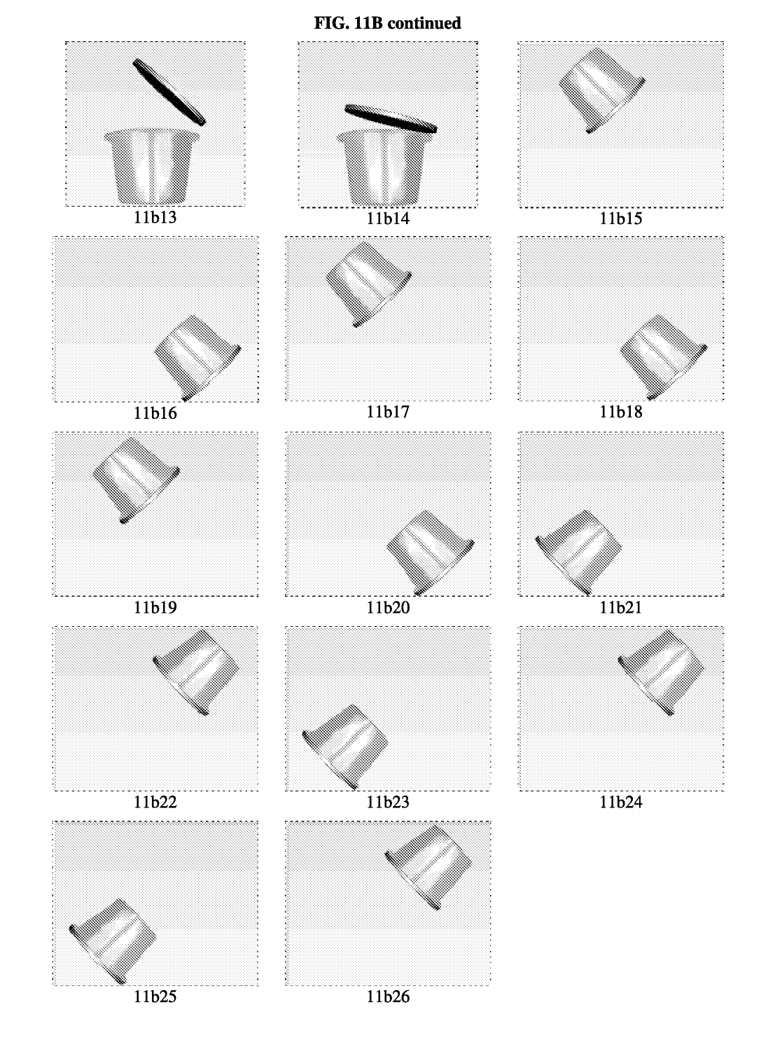

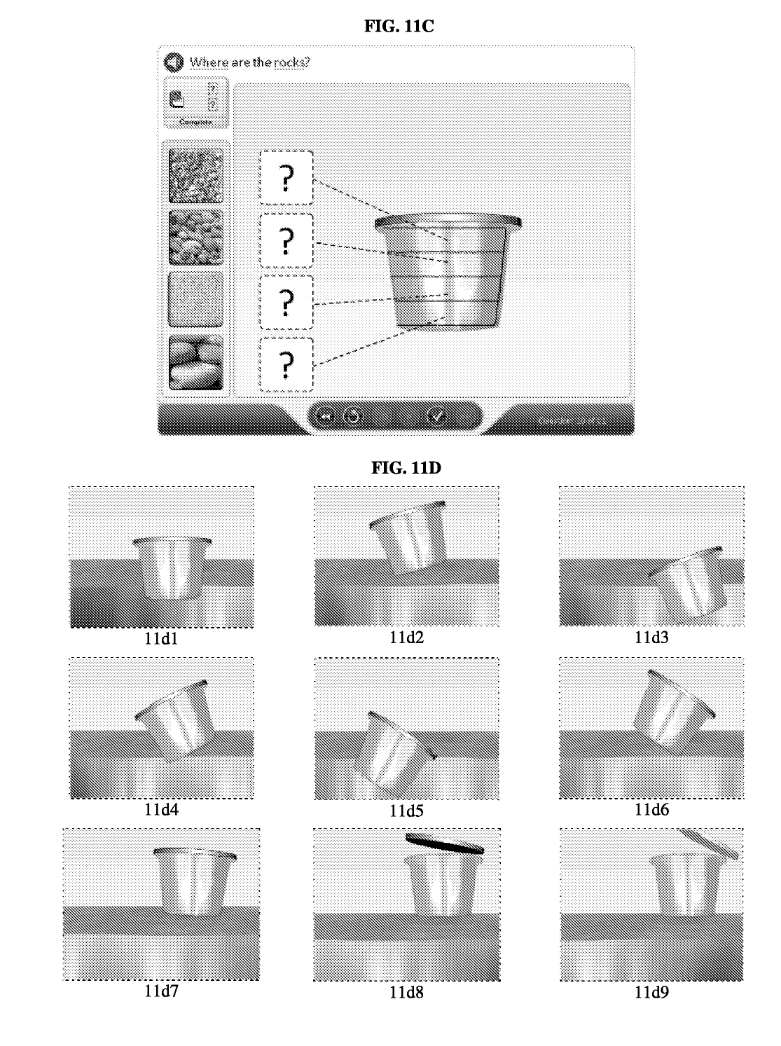

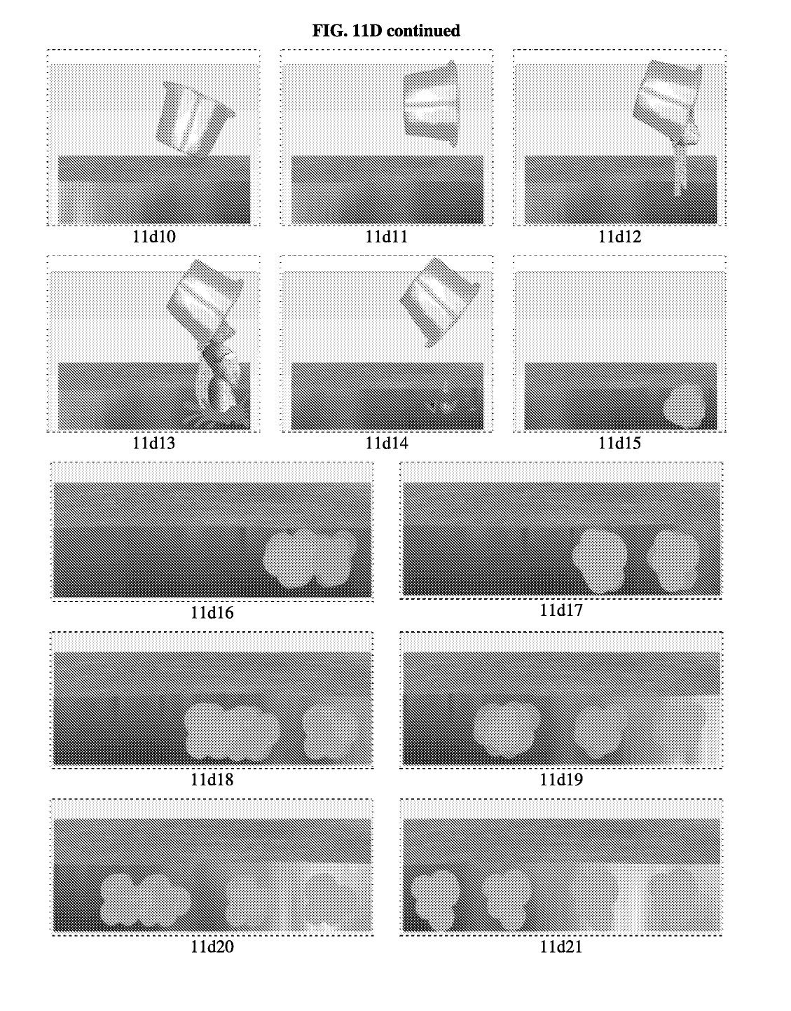

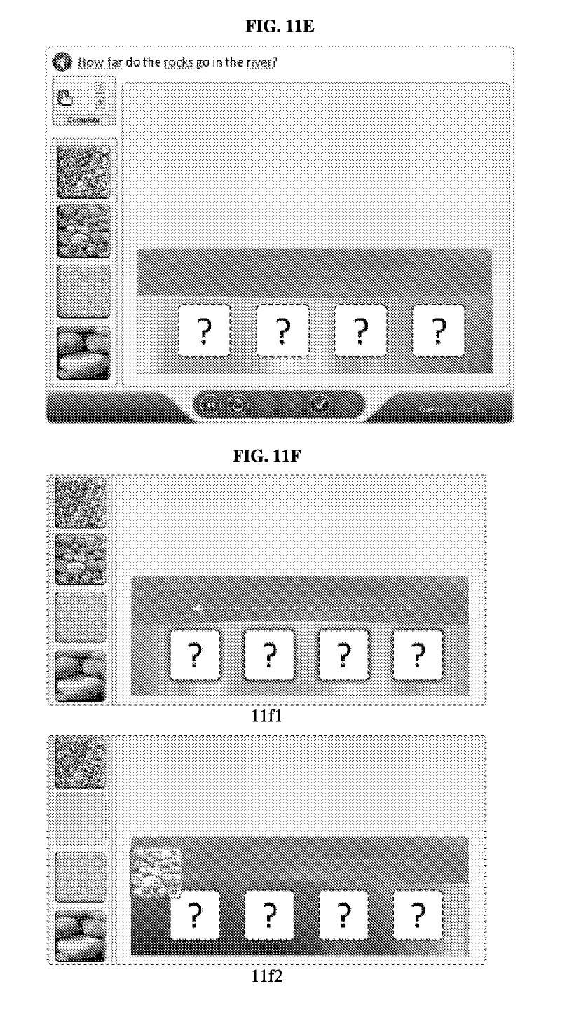

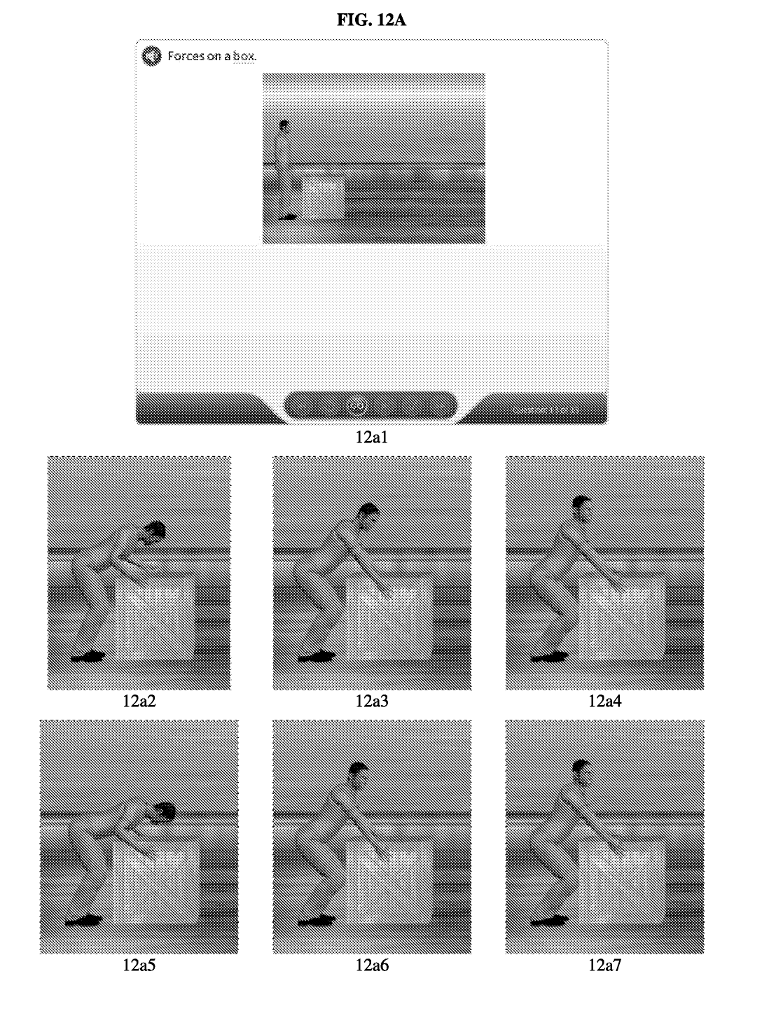

FIG. 11A shows the introductory screen and animation in sample item 7. The screenshots in FIG. 11B demonstrate that four types of material are added to a container (11b1 through 11b9), then water is poured in (11b10 through 11b12), and a lid placed on the container (11b13 and 11b14). The container is then shaken to mix its contents (11b15 through 11b26). As shown in FIG. 11C, a problem is posed regarding the relative position of the contents of the container following the mixing.

FIG. 11D shows that, in a subsequent section, the same container is again mixed (11d1 through 11d7), its lid removed (11d8 and 11d9), and its contents poured into a leftward-flowing body of water (11d10 through 11d14). The contents are then shown separating out from each other by animating a process of “budding” of components from each other (11d15 through 11d21). A problem is then posed as shown in the screenshot of FIG. 11E, this time asking the relative position of the container's contents once dumped into a flowing body of water. It should be noted that the body of water here is animated using undulating waves to demonstrate that it is flowing and thus pulling particles along according to their natural characteristics.

FIG. 11F demonstrates some of the interactivity features of the sample item. For example, when “How far” is scrolled over, an arrow appears over the boxes with the question marks to clarify what is meant by the phrase, as shown in screenshot 11f1. Screenshot 11f2 shows one of the components of the container being dragged to one of the available positions.

### Sample Item 8

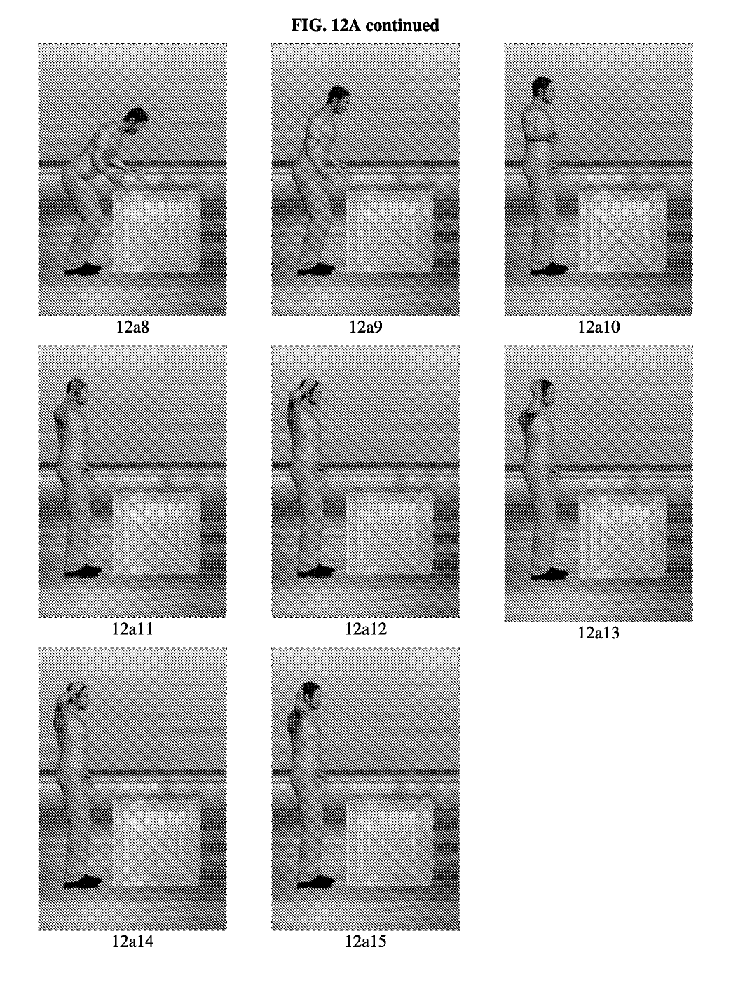

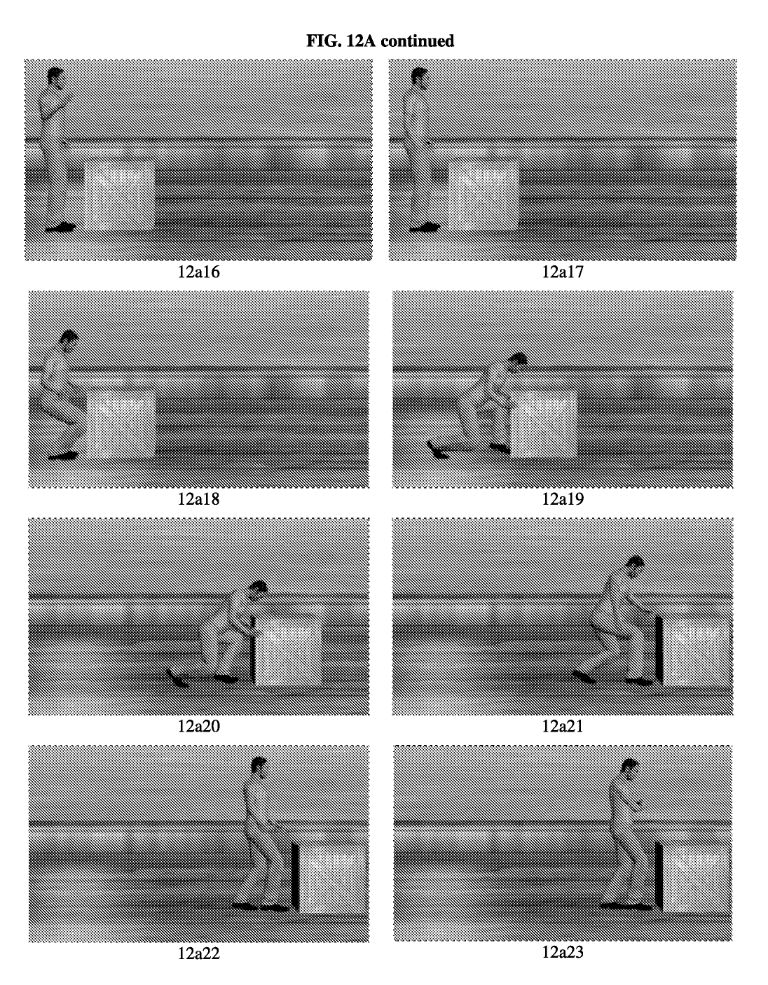

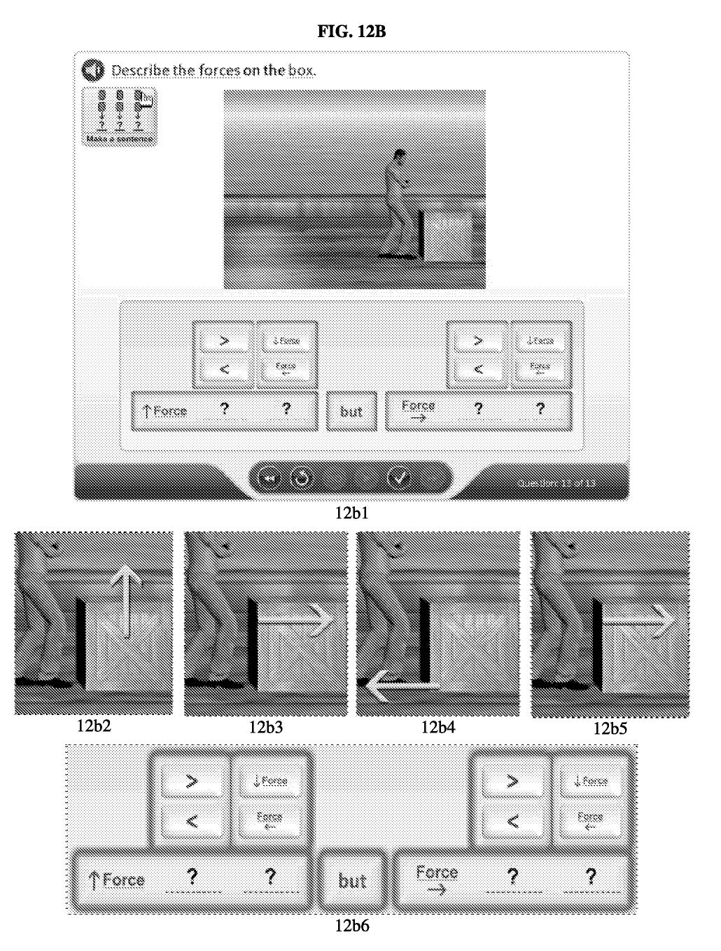

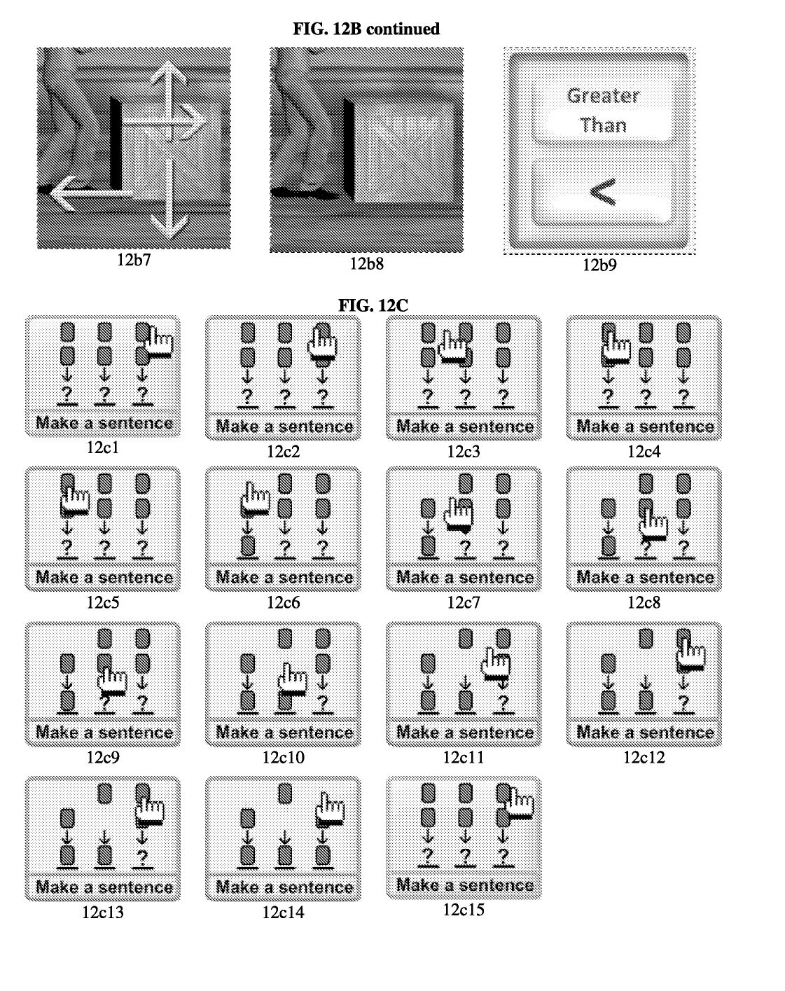

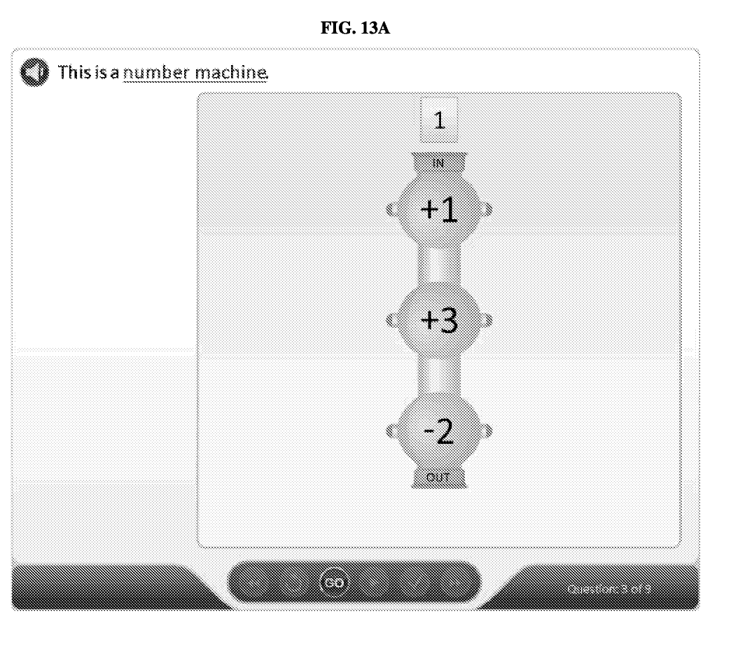

Sample item 8 begins with a man standing in front of a wooden crate, as shown in screenshot 12a1 of FIG. 12A. Screenshots 12a2 through 12a15 show the man exerting himself to attempt lifting the crate to no avail, after which he rubs his head as a result of his quandary. Having given up on his attempt to lift the crate, he instead decides to slide it along horizontally, as shown in screenshots 12a16 through 12a22. He then stands over the crate with arms crossed, as shown in screenshot 12a23, as if to ponder the situation.

Screenshot 12b1 of FIG. 12B shows a first problem posed regarding the forces experienced by the wooden crate. Scrolling over the arrowed forces displays arrows over the crate, as shown in screenshots 12b2 through 12b5. Scrolling over “Describe,” “the forces,” and “box” results in the highlighting of the relevant portions of the response space, as shown in screenshots 12b6 through 12b8. Scrolling over the relational operators displays the meaning of the operators, such as “Greater Than” shown in screenshot 12b9.

It is noted that the interactivity of the screens may continue despite the progression of an animation. For example, in FIG. 12A, scrolling over “box” may highlight the box even as it is being moved, aiding the subject's level of comfort and familiarization with the item.

It is also noted that the animation during which the man exerts himself and rubs his head communicates the situation and context to the subject in a manner that overcomes cultural perceptions and language proficiencies. Such “cultural neutrality” is one of the advantages of the present sample item.

FIG. 12C describes the animated icon labeled “Make a sentence.” States 12c1 through 12c15 show the hand selecting gray boxes from available choices for insertion into the spaces with question marks.

Through the incorporation of varying input devices, another exemplary version may use the methods and systems of the present invention to evaluate subjects with physical limitations.

Sample Item 9

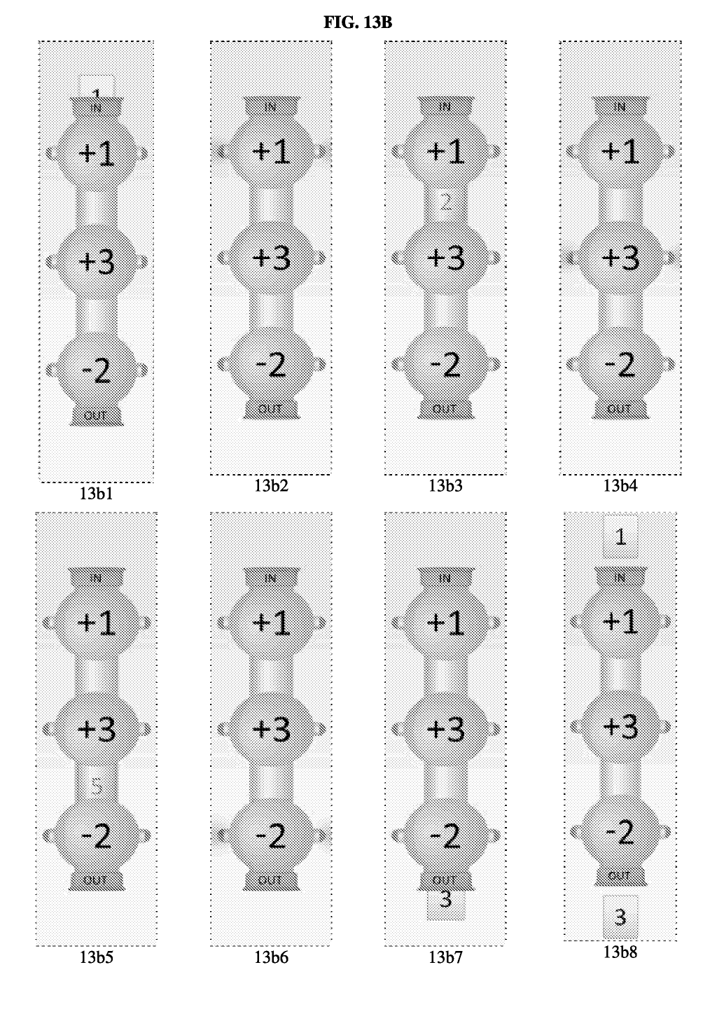

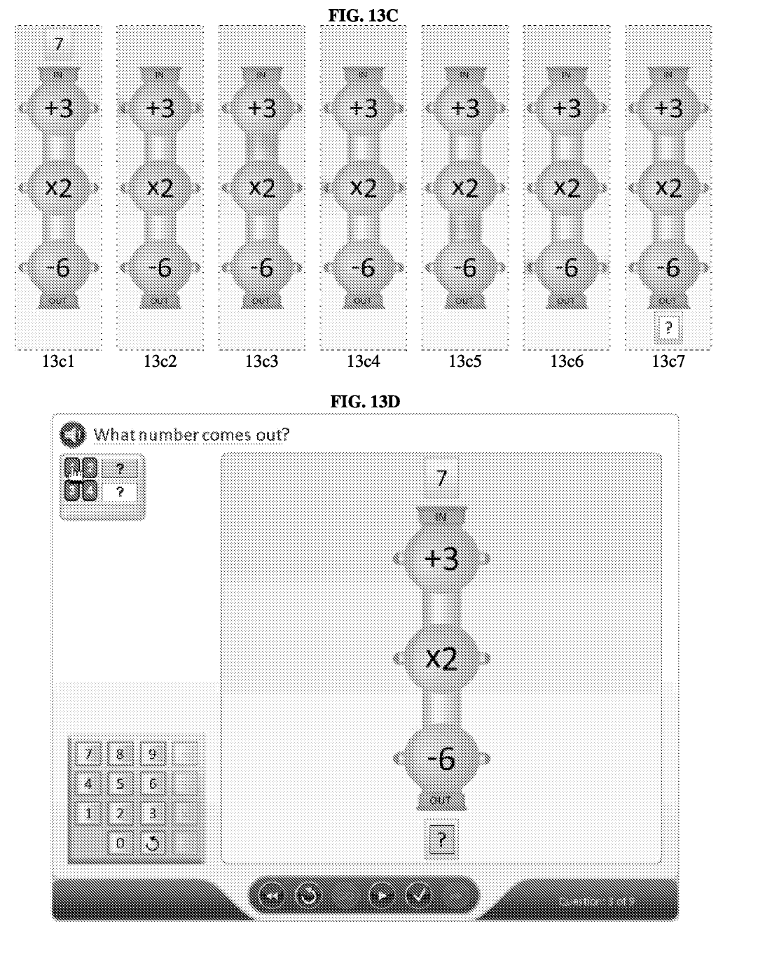

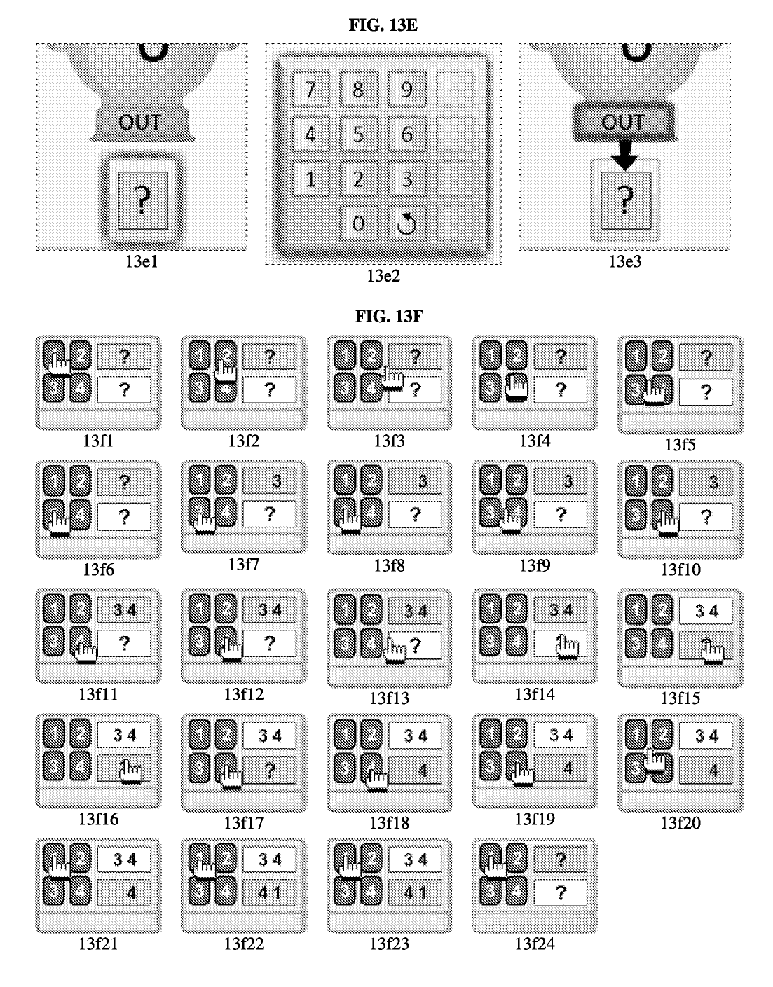

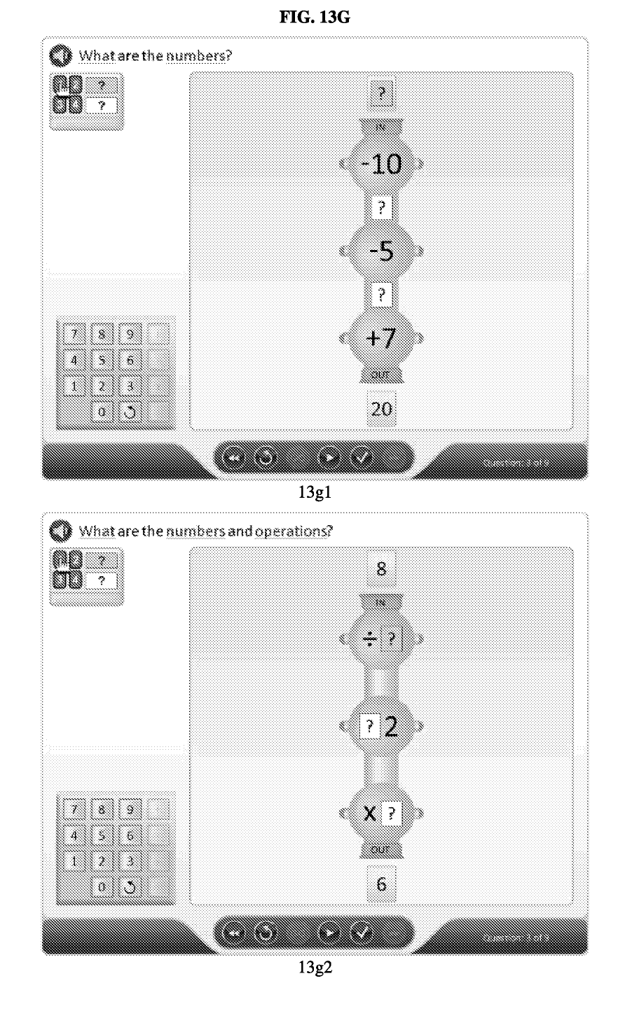

FIG. 13A shows the introductory screen of a number machine problem. The number machine has at least one input and at least one output, and processes numbers or variables that are input to the machine through various stages. The machine performs operations on the input numbers or variables, and outputs the resulting values.

Screenshot 13b1 in FIG. 13B shows a “1” entering the top of the number machine. The first stage of the machine, labeled “+1,” receives the number one and performs the identified operation on the input value. The red light shown in screenshot 13b2 indicates that the given stage is “on,” “activated,” or otherwise performing an operation on its input. Screenshot 13b3 shows the resulting “2” exiting the first stage, obtained by taking the number one that was input and performing a “+1” operation on it. Similarly, the number 2 enters the second and third stages of the number machine, exiting the numbers 5 and 3, respectively, as shown in screenshots 13b4 through 13b8. This contextual animation familiarizes the subject with the function and role of the number machine, preparing the subject for mathematical problems posed visually.

Screenshot 13c1 of FIG. 13C introduces a modified number machine with three different stages. This time, a number 7 is input into the number machine, and the intermediary results of the stages is not displayed as the number moves through the machine, as shown in screenshots 13c2 through 13c7. Screenshot 13c7 shows that a question mark has exited the last stage of the number machine, and the screenshot in FIG. 13D shows a first problem posed, along with a numerical keypad to be used in responding to the problem. Here, the subject is to consider what number exits the last stage of the number machine when a 7 has entered the machine to be processed by the “plus three,” “times two,” and “minus six” operations. The displayed screen is interactive, and scrolling over “What,” “number” and “comes out” highlights the relevant portions of the screen as shown in screenshots 13e1 through 13e3 of FIG. 13E.

Along with the problem is provided an animated icon explaining how to respond to the problem posed, as shown in screenshot 13f1 of FIG. 13F. It is noted that the top box with a question mark is shaded, indicating that it is the selected input box of the response space that is represented by the animated icon. Screenshots 13f2 and 13f3 show, once the animated icon is activated by the subject, the hand moving toward the top gray box, suggesting to the subject that the hand icon is free to move about the task demand space. After a brief pause, screenshots 13f4 through 13f6 show the hand moving toward the “3” box. Screenshots 13f7 and 13f8 show the hand selecting and deselecting the “3” box, making a number 3 appear in the top question box to replace the question mark. Screenshots 13f9 and 13f10 show the hand moving toward the “4” box, and screenshots 13f11 and 13f12 show the hand selecting and deselecting the “4” box, making a 4 appear in the selected input box. The hand icon then moves to the bottom question box and selects it, as shown in screenshots 13f13 through 13f16, so that it becomes the new input box. It is noted that the top right box is now no longer shaded because it is no longer the selected input box, whereas the bottom question box is now shaded to indicate it is the target of the numerical inputs in the response space. The hand icon then moves toward the numbers 4 and 1 and selects them for input into the shaded input box, as shown in screenshots 13f17 through 13f23. Screenshot 13f24 shows the animated icon returning to its initial state, ready to be activated again if the subject wishes to review the demonstration of the response function.

In subsequent sections, the sample item may, for example, present problems inquiring as to the intermediate values of the number machine stages, as well as the operators that perform operations on given numbers to yield particular results, as suggested by screenshots 13g1 and 13g2 of FIG. 13G.

It is noted that the number machine need only have one stage, but may be modified to possess any number of stages as deemed appropriate. The number machine may be modified to operate on variables (for example, “n+2”) as well as numbers, provide additional functionality and operations, and take other forms or aesthetic designs. Modifications may be deemed desirable to, for example, change the level of difficulty of problems posed.

### Sample Item 10

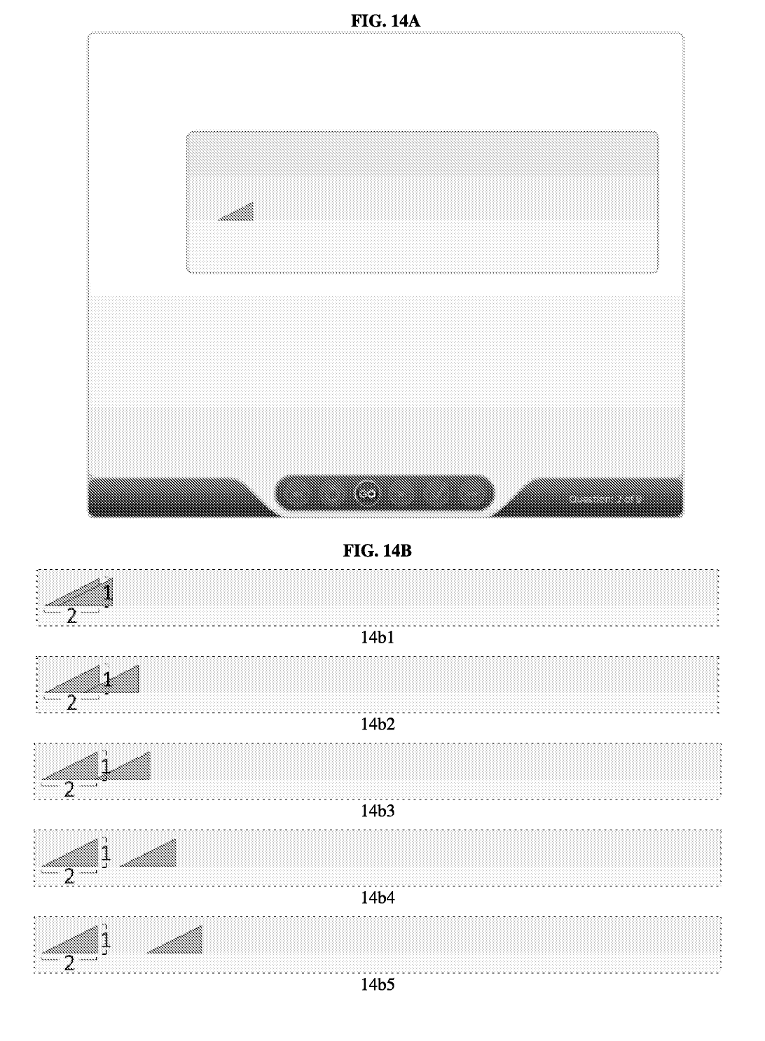

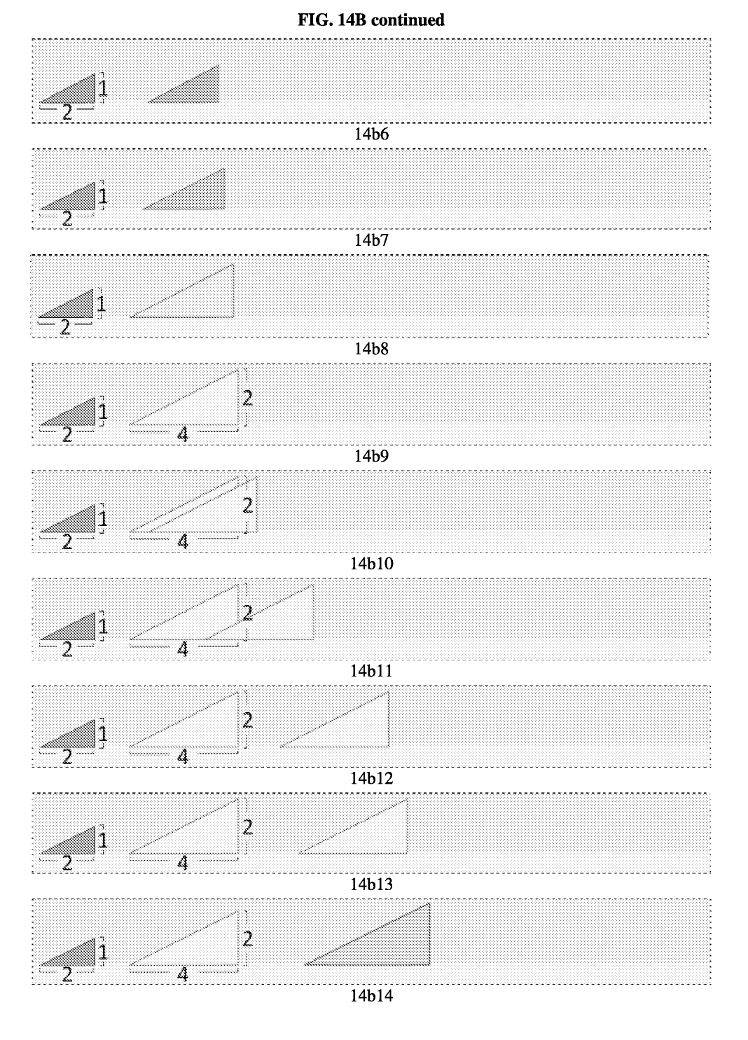

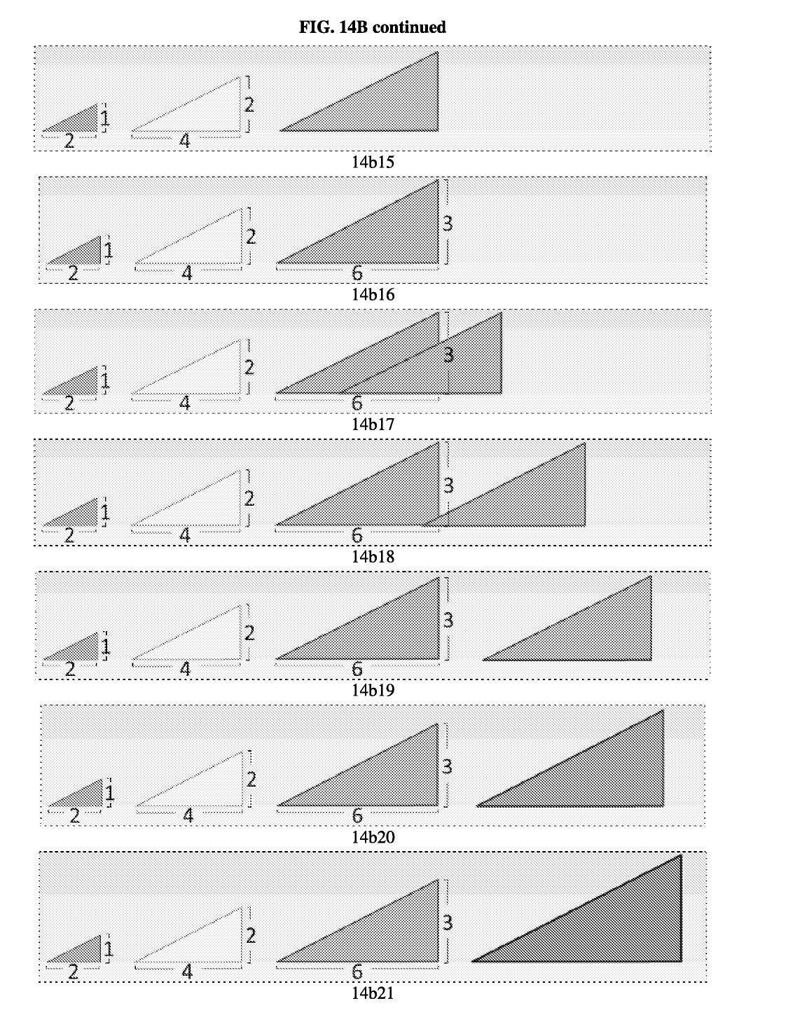

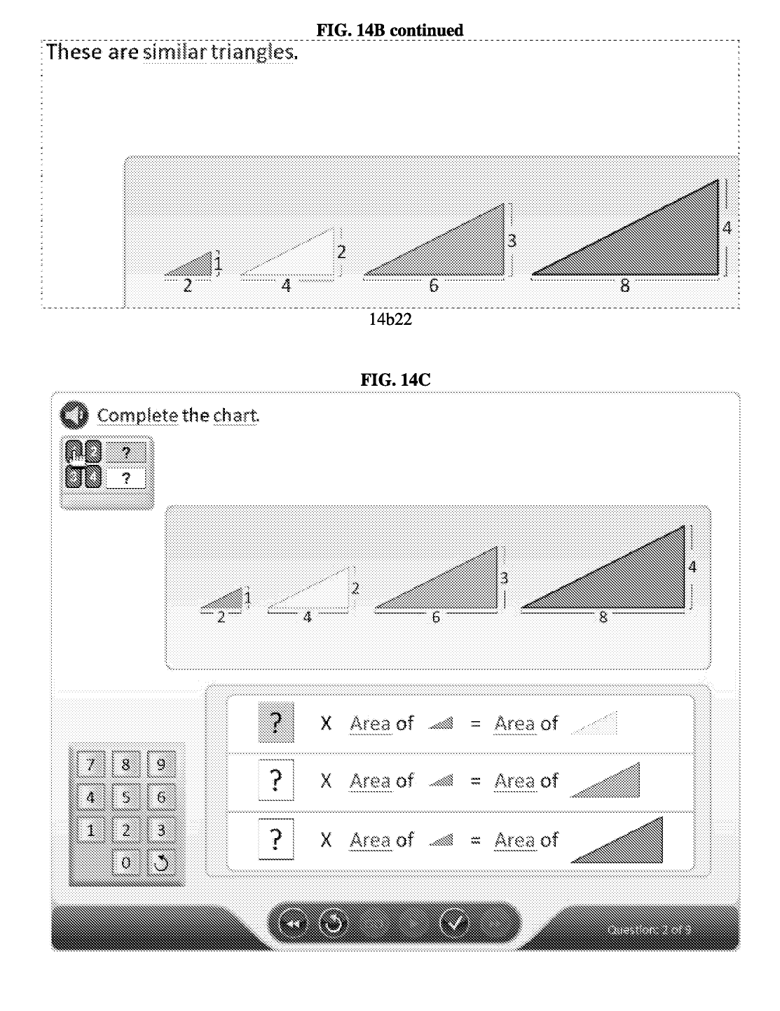

The screenshot of FIG. 14A provides the introductory screen of a geometry-related sample item. The subject is first shown a pink triangle, and an identical pink triangle buds away from the first triangle, as shown in screenshot 14b1 of FIG. 14B. The identical pink triangle moves to the right of the first triangle, and proportionally expands to a new size, as shown in screenshots 14b2 through 14b8. It is noted that the color of the second pink triangle changes when the second pink triangle begins to expand to provide another visual cue that the second triangle is no longer identical to the first triangle.

Once the second triangle has completed expanding, it settles on a yellow color and obtains values for the lengths of its sides, as shown in screenshot 14b9. In an analogous manner, another triangle buds off the yellow triangle, moving to the right and maintaining its yellow color until it begins proportionally growing in size to become a third triangle of cyan color, as shown in screenshots 14b10 through 14b16. Screenshot 14b17 also shows the next triangle budding off to move to the right and proportionally expand to become the purple-colored fourth triangle, as shown in screenshots 14b18 through 14b22. Once the four triangles have formed, a message appears informing the subject that the four triangles are “similar” triangles, as shown in screenshot 14b22. The screenshot in FIG. 14C shows a potential problem posed as a follow-up to the contextual animation suggested by the previous screenshots.

It is noted that this contextual animation demonstrates what is meant by a “similar” triangle, as the subject may understand the concept but not be aware that they are referred to as “similar” triangles. It is also noted that this approach may serve the dual approach of educating as it evaluates, as the subject who may have known the concept of “similar” triangles may now learn this nomenclature as he or she progresses through the item.

### Sample Item 11

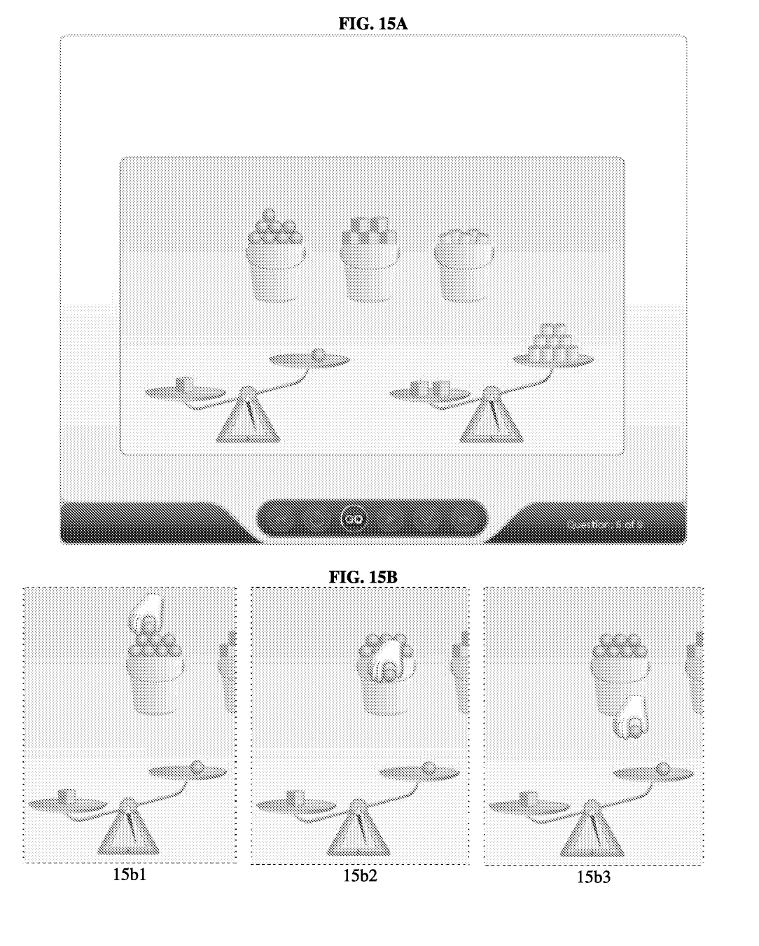

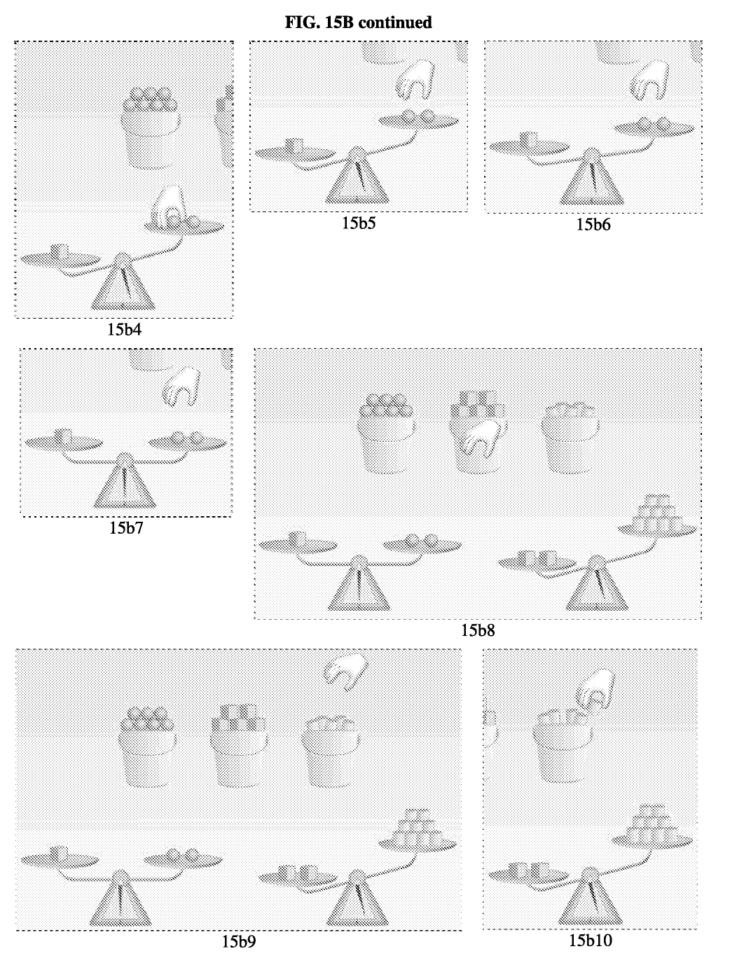

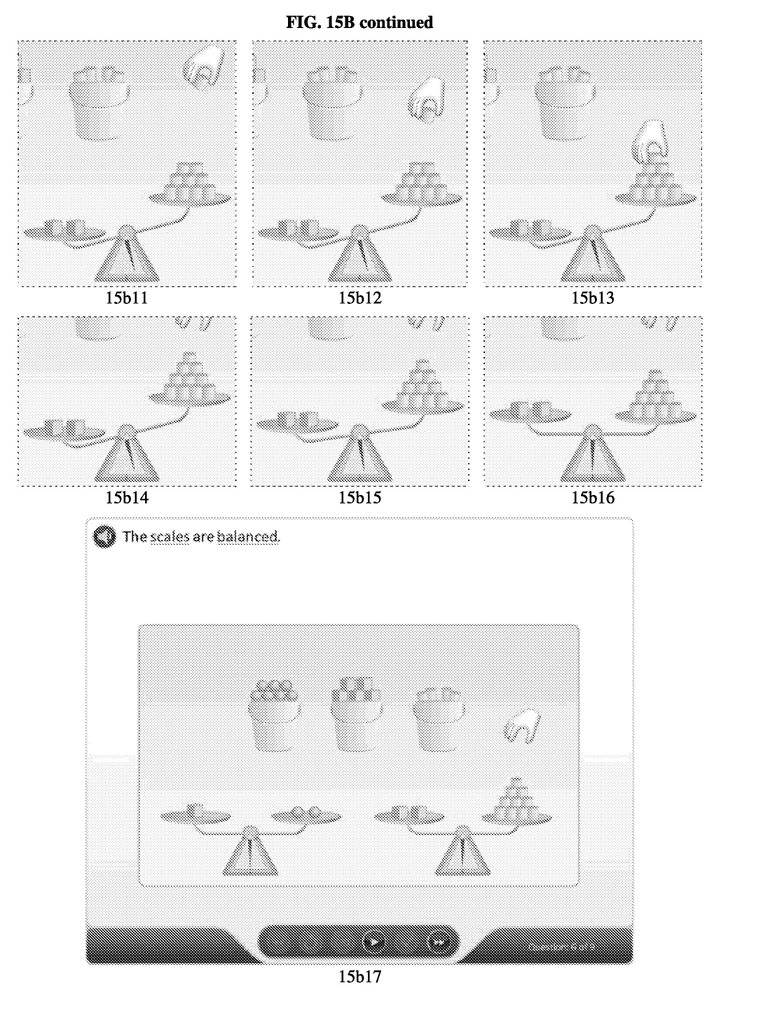

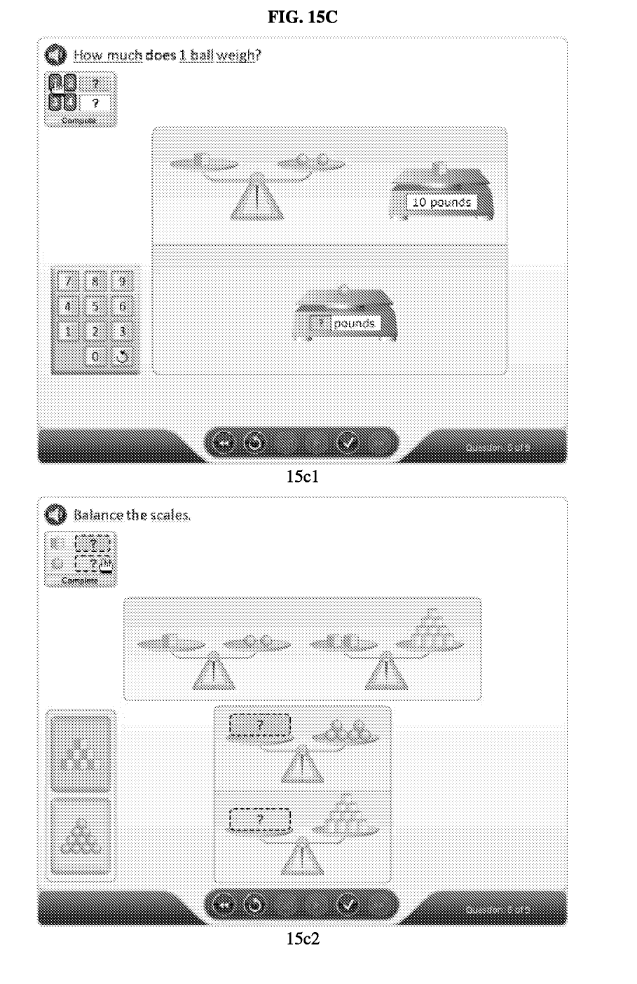

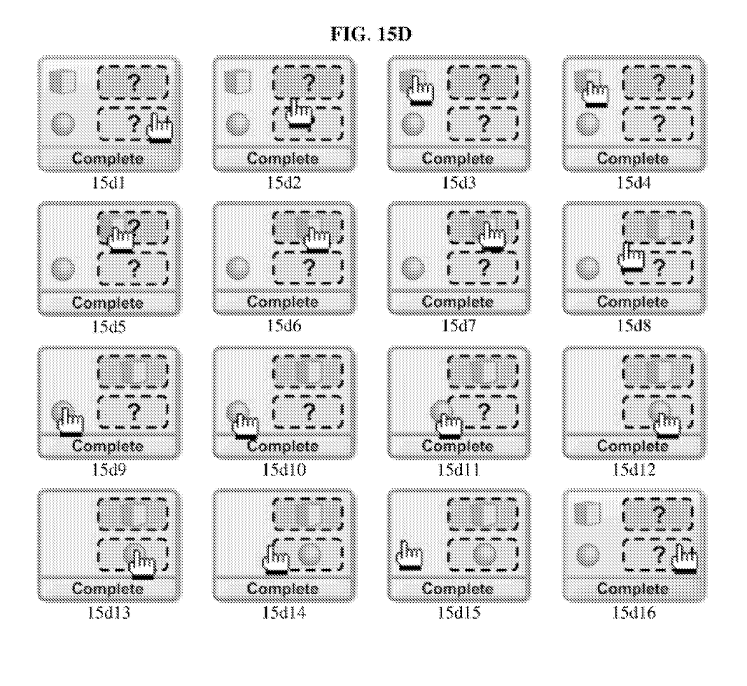

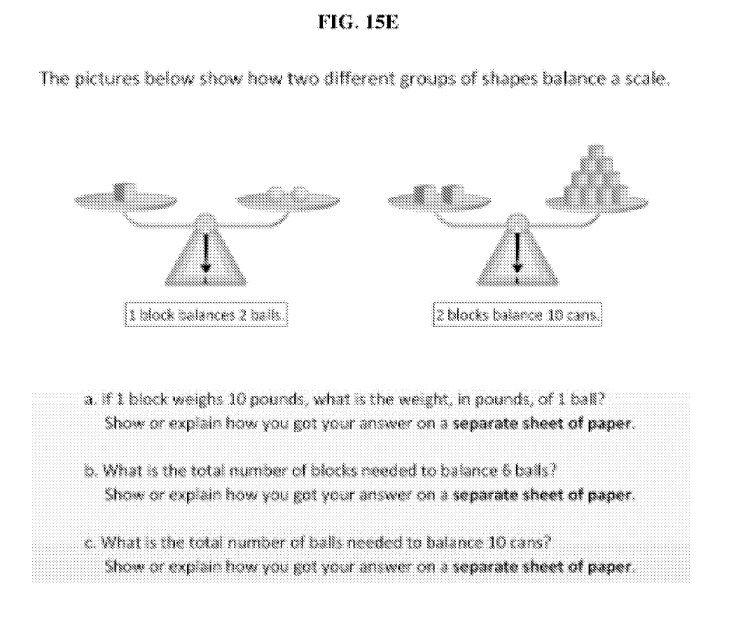

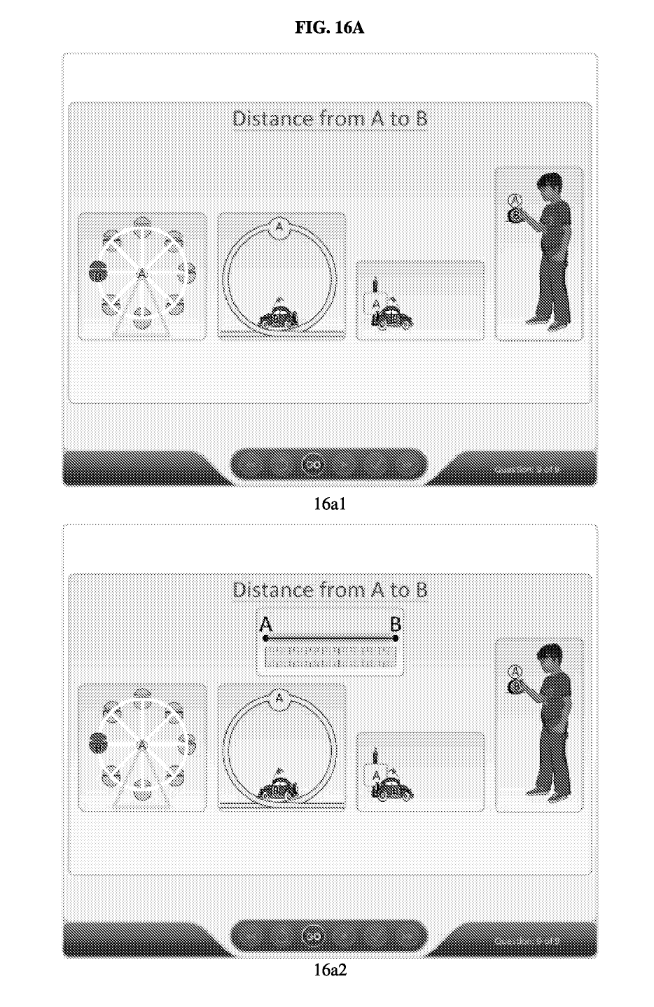

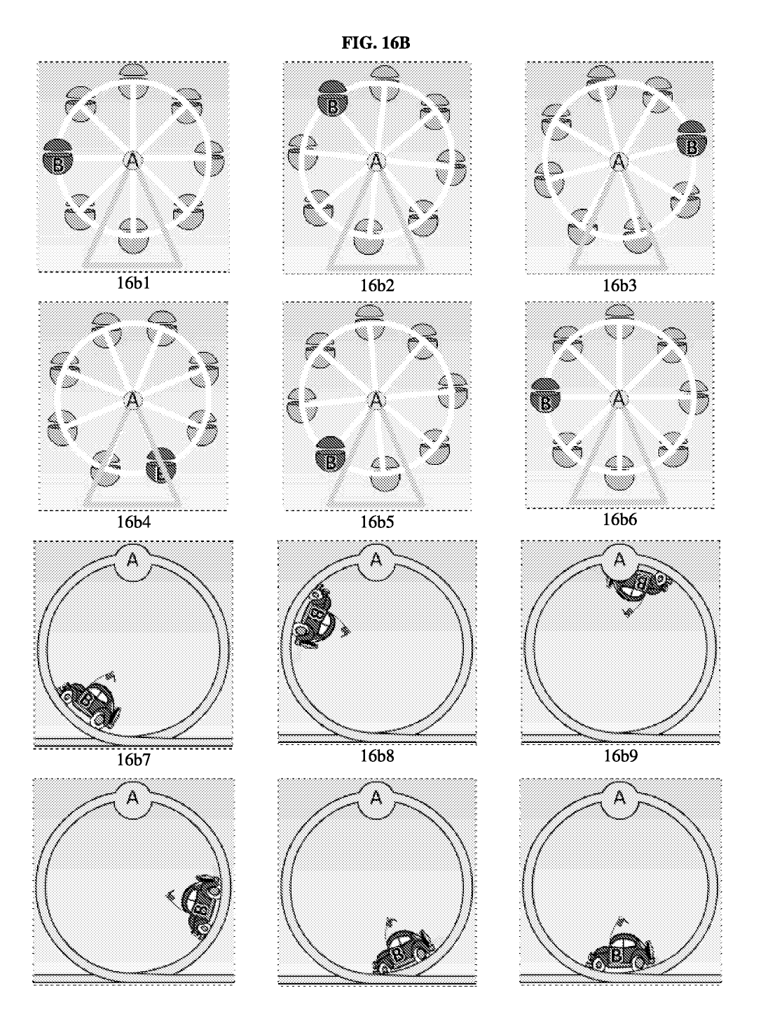

The screenshot in FIG. 15A provides a potential introductory screen in this sample item. Screenshots 15b1 through 15a17 of FIG. 15a depict a contextual animation demonstrating that different items are placed on scales so that they balance two scales. Among other things, the animation visually demonstrates that one green cube weighs the same as two purple balls, and two green cubes weigh the same as 10 pink cylinders. In 15b1 through 15b5, a hand places a ball on the right plate of the scale on the left. And in 15b5 and 15b6, the left scale tips and becomes balanced, demonstrating that the weight of the one cube is the same as the weight of the two balls. In 15b8 through 15b14, the hand moves over to bucket of cylinders, removes a cylinder, and adds one to the right place of the right scale. And 15b15 and 15b16 show that the scale on the right tips and becomes balanced, demonstrating that the weight of two cubes is the same as the weight of ten cylinders. Screenshot 15b17 ends the animation by informing the subject that the scales are balanced. The screen remains interactive after the animation, allowing the subject to explore the graphics, images, icons, text, and other elements on the display area to become more familiar with the material presented.

Potential problems posed based on the above contextual animation are shown in screenshots 15c1 and 15c2 of FIG. 15C.

FIG. 15D shows states of the animated icon labeled “Complete.” A detailed explanation of the depicted states is omitted as its approach is analogous to those of previously-explained animated expository regions. It is noted that the label, positions, color scheme, and other details can be modified or adjusted to better suit various sample items, as appropriate. It is also noted that here the colors of the shapes (and their destinations) in the animated icon correlate with the colors of the shapes (and their destinations) that are to be manipulated by the subject in the response space. This helps make it apparent to the subject that the space represented within the animated expository region is the task demand space of the display area.

For comparison, FIG. 15E shows a text-intensive, non-interactive, non-facilitative conventional problem targeting similar concepts. It is readily apparent that the reduced language load, interactivity, animations, animated icons, and other features of sample item 11 provide many advantages over conventional approaches.

### Sample Item 12

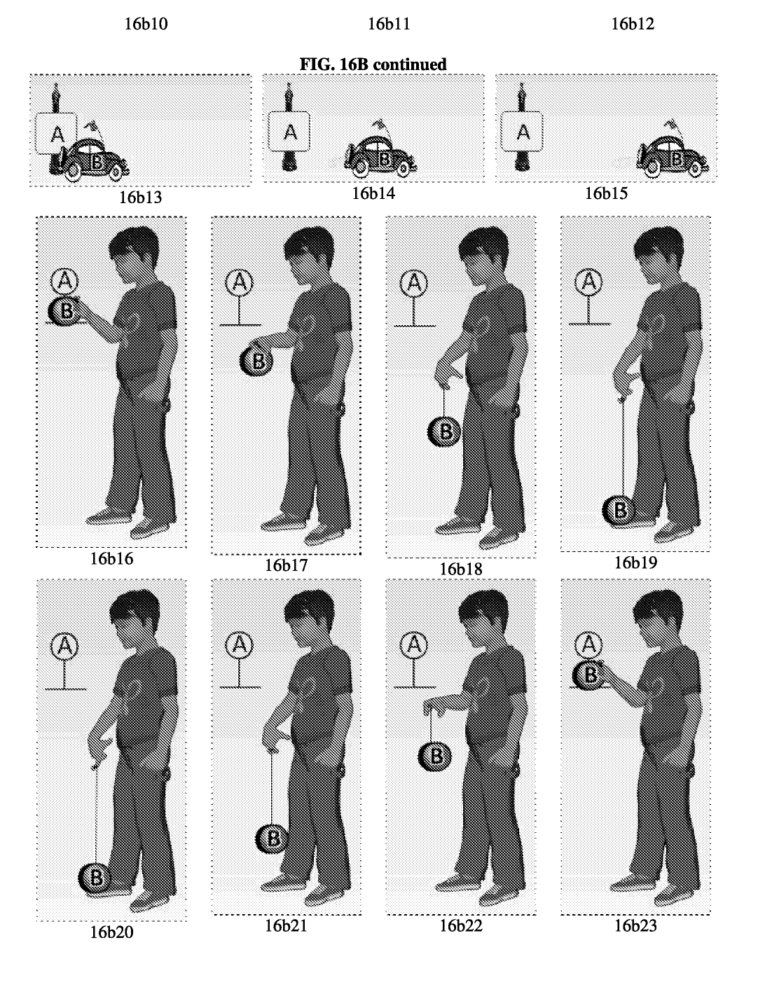

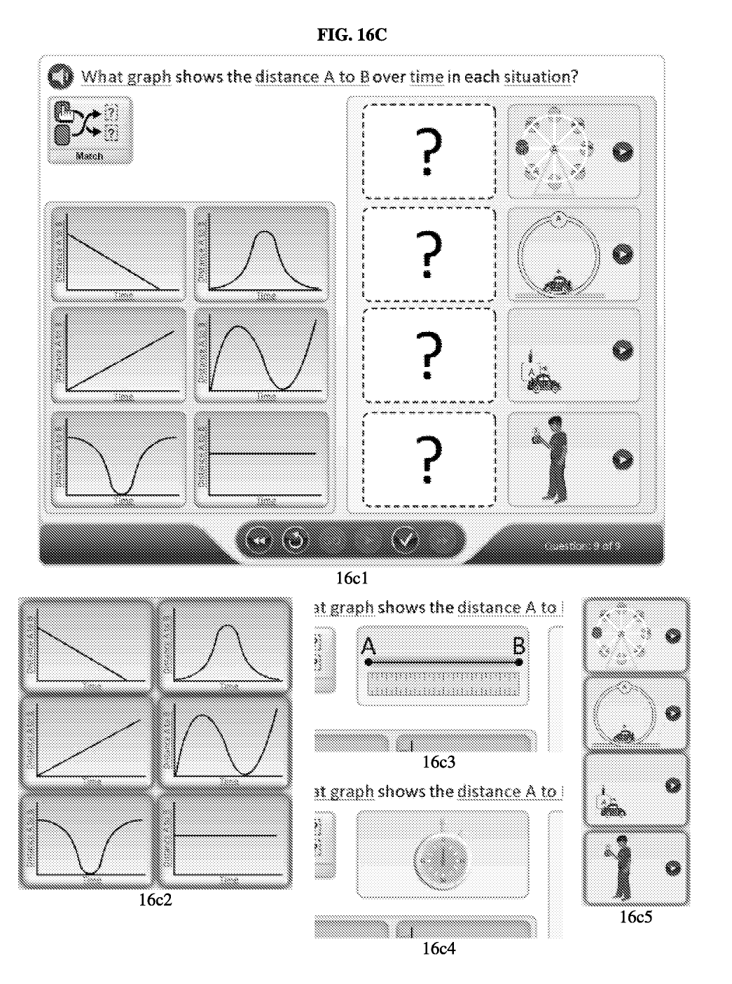

Screenshot 16a1 of FIG. 16A shows an introductory screen aimed at acquainting the subject with the concept of two positions (labeled “A” and “B”) and the distance separating them. Screenshot 16a2 shows the image (of a ruler between two points labeled “A” and “B”) that appears if the subject interacts with the text “Distance from A to B” by scrolling over it.

FIG. 16B shows contextual animations in which the two positions (“A” and “B”) move in relation to one another. Screenshots 16b1 through 16b6 show the Ferris wheel rotating, with the center of the wheel labeled “A” in yellow and one of the cars labeled “B” in red. Screenshots 16b7 through 16b12 show the red car labeled “B” driving around on the inside of a loop, the top of which is labeled “A” in yellow. Screenshots 16b13 through 16b15 show the red car labeled “B” driving horizontally from the lamppost with a yellow “A” label. And screenshots 16b16 through 16b23 show the boy on the right bouncing a yo-yo labeled with a red “B” down away from a yellow circle labeled “A.” It is noted that this contextual animation animates each of the four motions sequentially in order to avoid confusion, but the four animations may occur in parallel if deemed appropriate. It is also noted that the screenshots in FIG. 16B only show the enlarged relevant portions of the display area of FIG. 16A. That is, the animations in FIG. 16B occur within the corresponding regions of 16a1.

It is noted that the red car in the second and third animations (the loop and the car driving away from the lamppost) is animated with a puff of smoke exiting its tailpipe in part to further emphasize to the subject that movements require particular attention.

Screenshot 16c1 of FIG. 16C shows a first problem posed based on the contextual animation of FIG. 16B. The subject is asked to match graphs of distance versus time with each of the animations. It is noted that this screen is highly interactive, permitting the subject, for example, to scroll over the text, receive spoken instructions, and review any or all of the four animations by clicking on the gray “play” buttons (the right arrows contained in circles) located to the right of the Ferris wheel, loop, car next to the lamppost, and the boy with the yo-yo. For example, screenshots 16c2, 16c3, 16c4, and 16c5 show what is highlighted when the subject scrolls over “What graph,” “distance A to B,” “time,” and “situation,” respectively. In this sample item, the image including the ruler in 16c3 and the image with the stopwatch in 16c4 newly appear and are visible only while the subject is scrolling over “distance A to B” and “time,” respectively.

### Sample Item 13

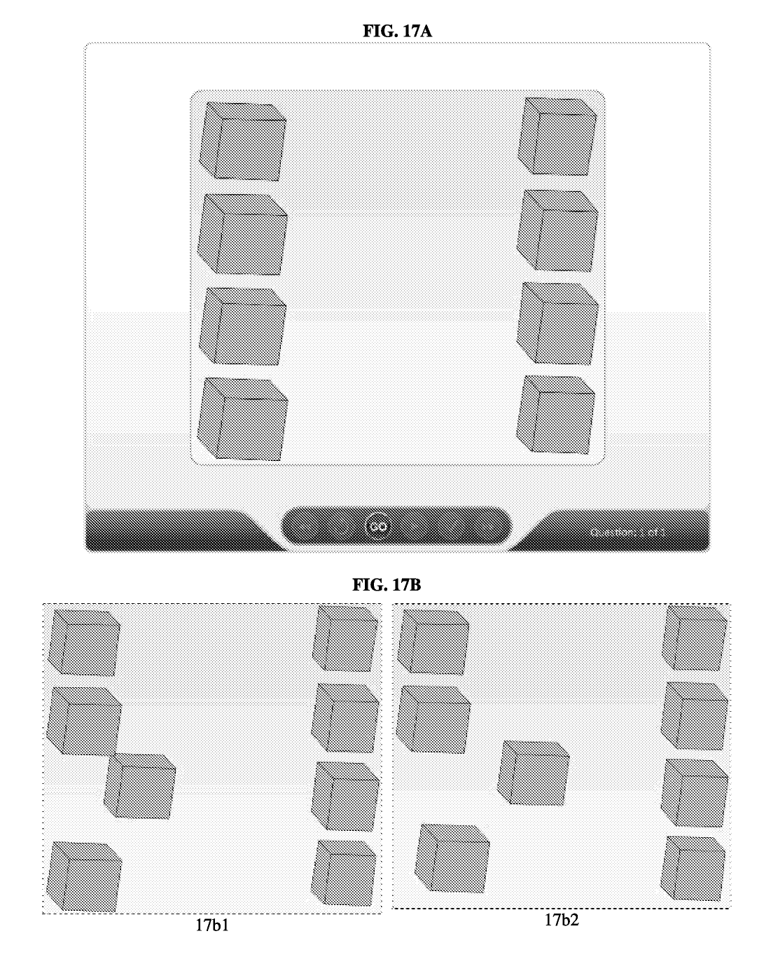

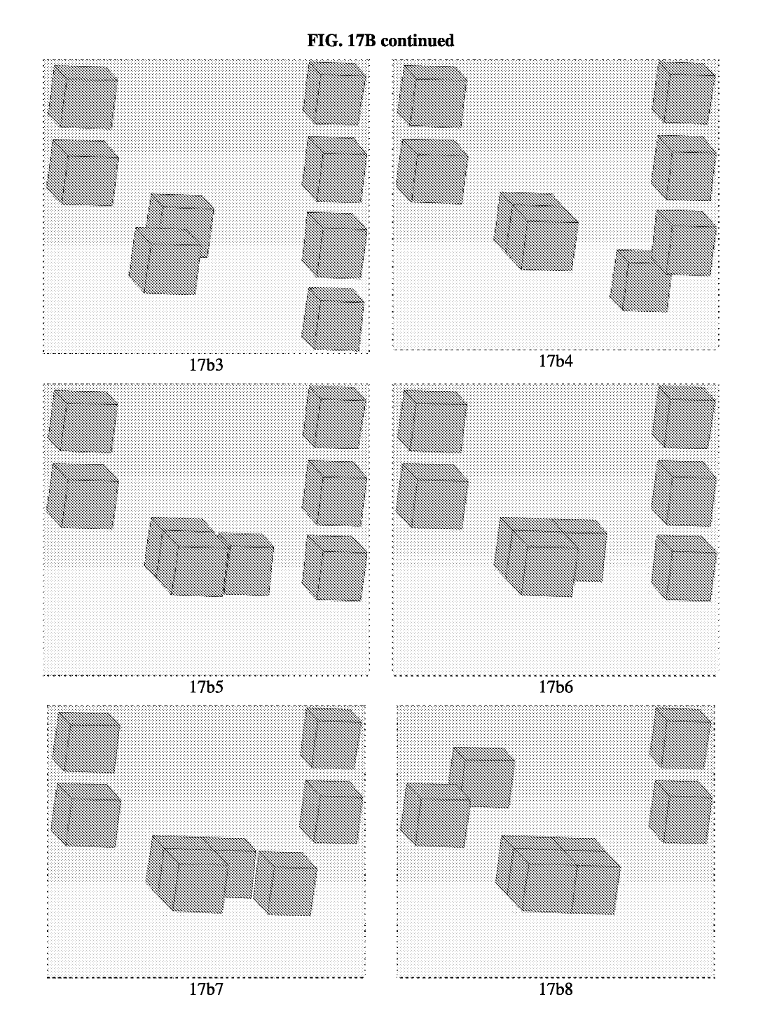

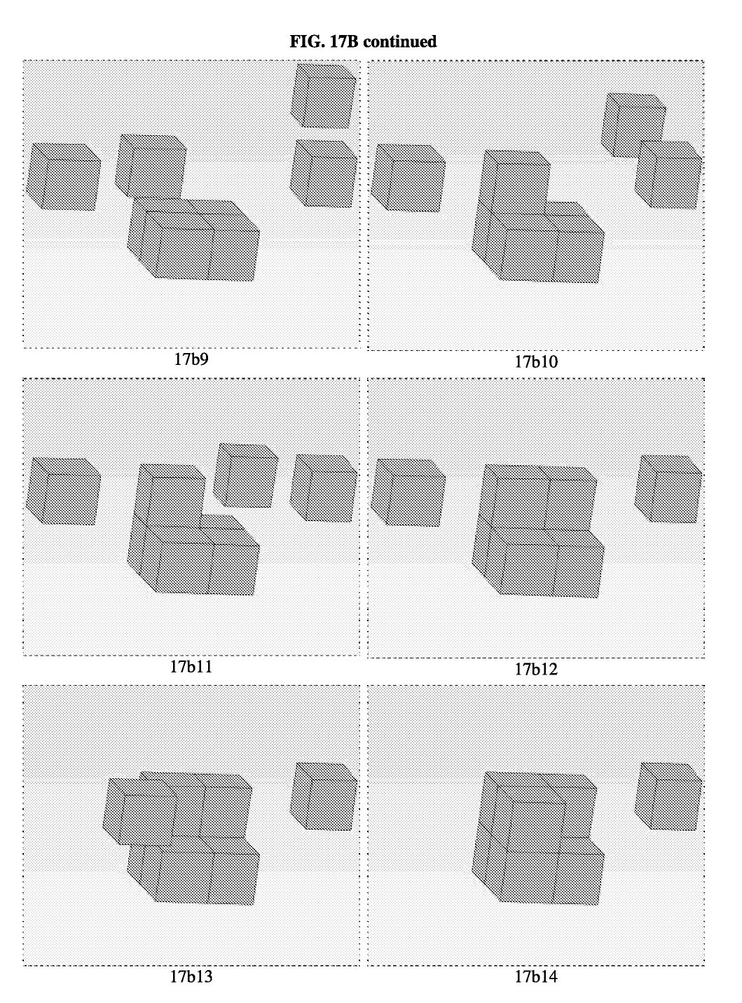

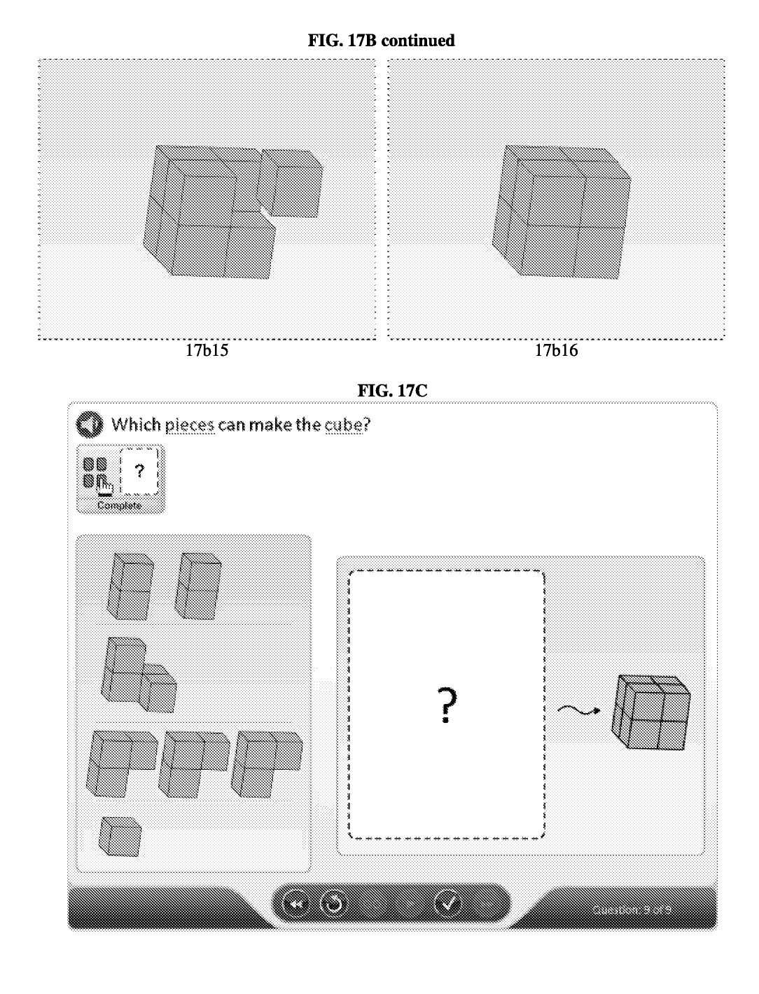

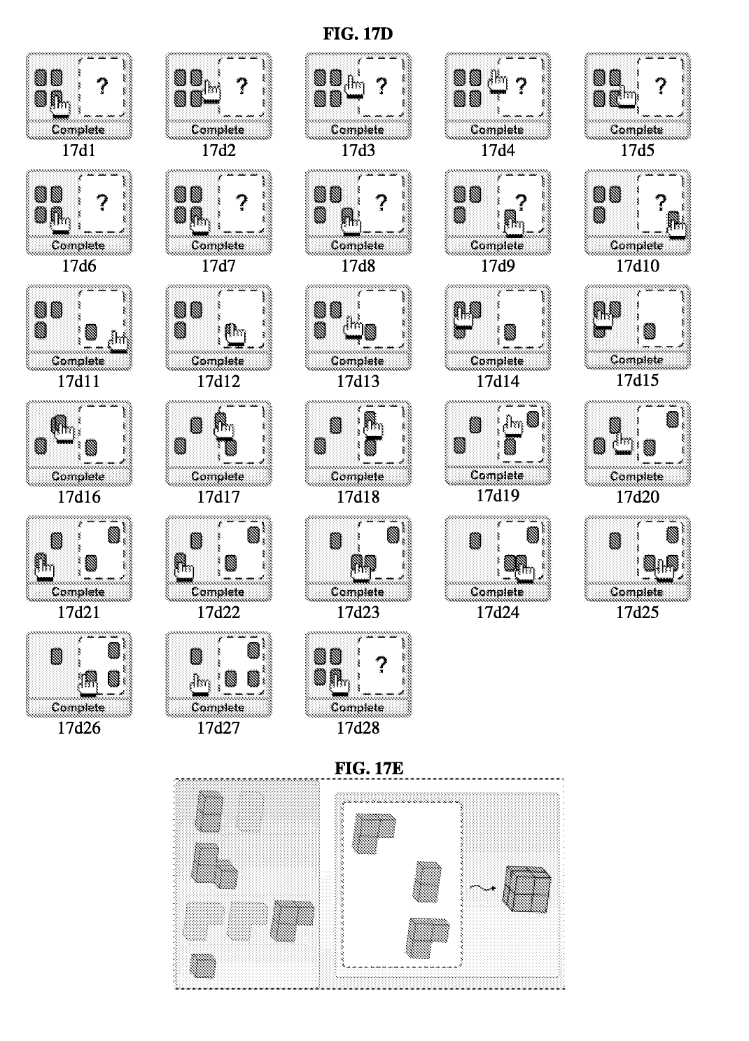

The screenshot in FIG. 17A shows an introductory screen in a sample item related to shapes and geometries. Screenshots 17b1 through 17b16 of FIG. 17B depict a contextual animation demonstrating that cubic pieces are arranged together in a manner that forms another shape, which here is a larger cube. Following this animation, the subject may be presented with a problem, as shown in the screenshot of FIG. 17C. In FIG. 17C, the white space with a question mark is the response space within the task demand space.

The animated icon seen at the top left corner of the screenshot in FIG. 17C is shown in FIG. 17D. The animated icon demonstrates that the given pieces are to be dragged into the box with a question mark (of the response space) to form the given shape (here, the cube at the right of the box with a question mark). It is noted that, even if not explicitly mentioned in a discussion of any particular animation, the different states of any animation may be accompanied by various pauses of different durations at different points in time in order to enhance the animation's effectiveness. For example, in the animation of the animated icon in FIG. 17D, there may be pauses at such states as 17d11 (once the hand unclenches to drop the gray box), 17d14 (once the hand reaches the second gray box), 17d15 (once the second gray box has been selected), 17d18 (once the second gray box has been dragged to the response space), 17d19 (once the hand unclenches to drop the second gray box), 17d21 (once the hand reaches the third gray box), 17d24 (once the third gray box reaches the response space), 17d25 (once the hand unclenches to drop the third gray box), and 17d27 (once the hand has completed the animation and moved aside before the animated icon returns to its initial state of 17d28). FIG. 17E shows a potential partial response entered according to the response function.

It is additionally noted that in this version of an animated icon of this sample item, the boxes “snap to a grid” once they are inserted in the response space (by unclenching the hand). This serves to add a “dropping” or “letting go” effect to the animation, enhancing the realism and physical world correspondence of the animation.

It is further noted that this approach of visualization of geometric shapes and their relative positions of objects aids subjects who may otherwise have cognitive difficulties visualizing how objects may fit together or be positioned three-dimensionally. Three-dimensional shapes, objects, positions, and motions are particularly difficult to capture using conventional educational and evaluative methods, and such visualization of the relative movement of such components enhances subjects' cognitive sophistication and aids evaluation of subject's conceptual understanding.

Sample Item 14

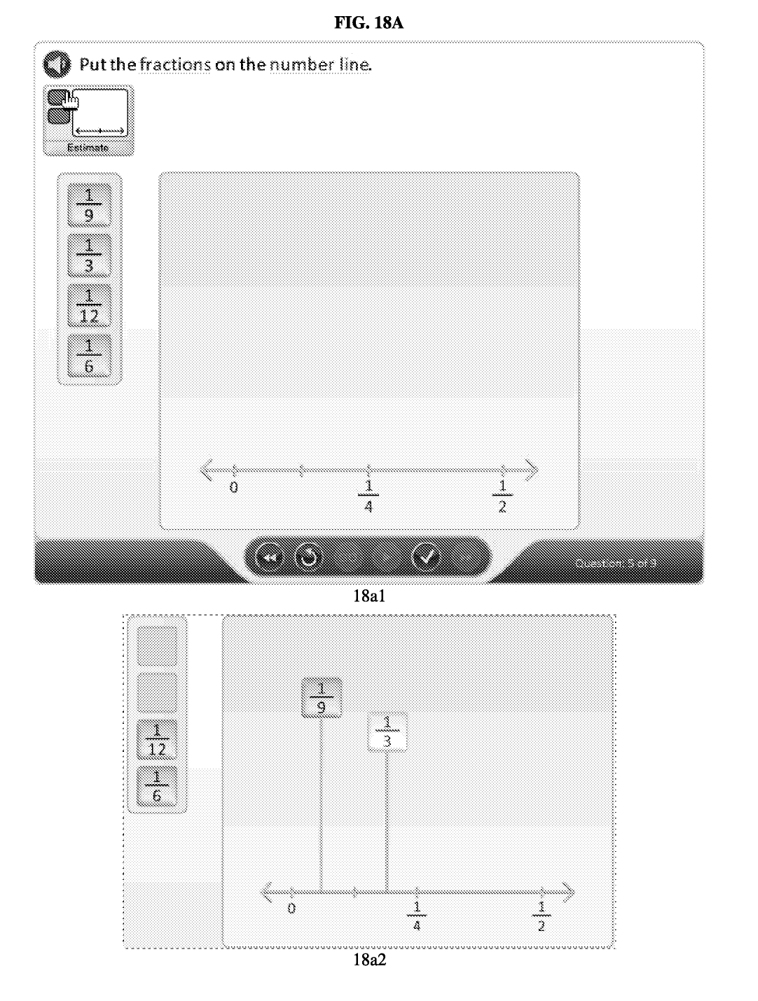

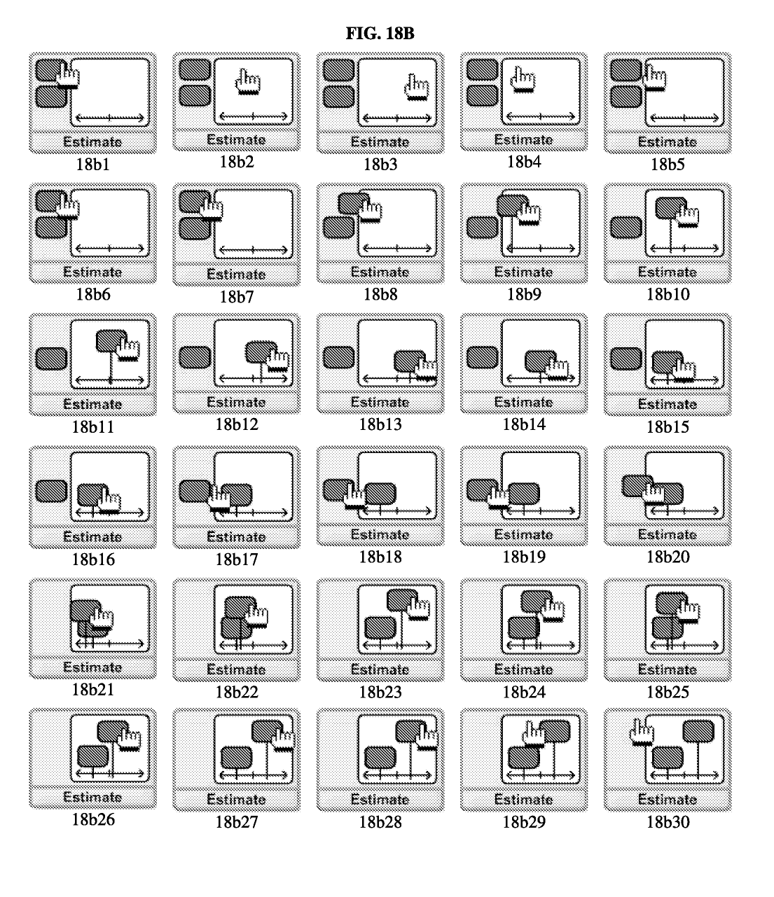

Screenshot 18a1 of FIG. 18A shows an introductory screen as part of a section of a larger item (not shown in its entirety), in which the subject is asked to show his or her understanding of fractions by placing them on a number line relative to each other. Screenshot 18a2 shows a potential partial response, wherein the subject has dragged two fractions over the horizontal number line, their positions over the number line indicated by the two vertical lines.

FIG. 18B shows states of the animated icon labeled “Estimate. In states 18b1 through 18b3, the animated icon is in an introductory phase during which the image of the hand moves to one side of the represented response space (that is, the represented white work area of FIG. 18A). In a demonstrative phase (18b4 through 18b28), the image of the hand selects each of the gray content boxes and drags them into the represented response space to place them at a desired location on the represented number line. Screenshots 18b29 and 18b30 show a conclusory phase during which the hand image moves out of the represented response space to the top-left of the represented task demand space. The animated icon would then conclude by returning to its initial state of 18b1.

### Sample Item 15

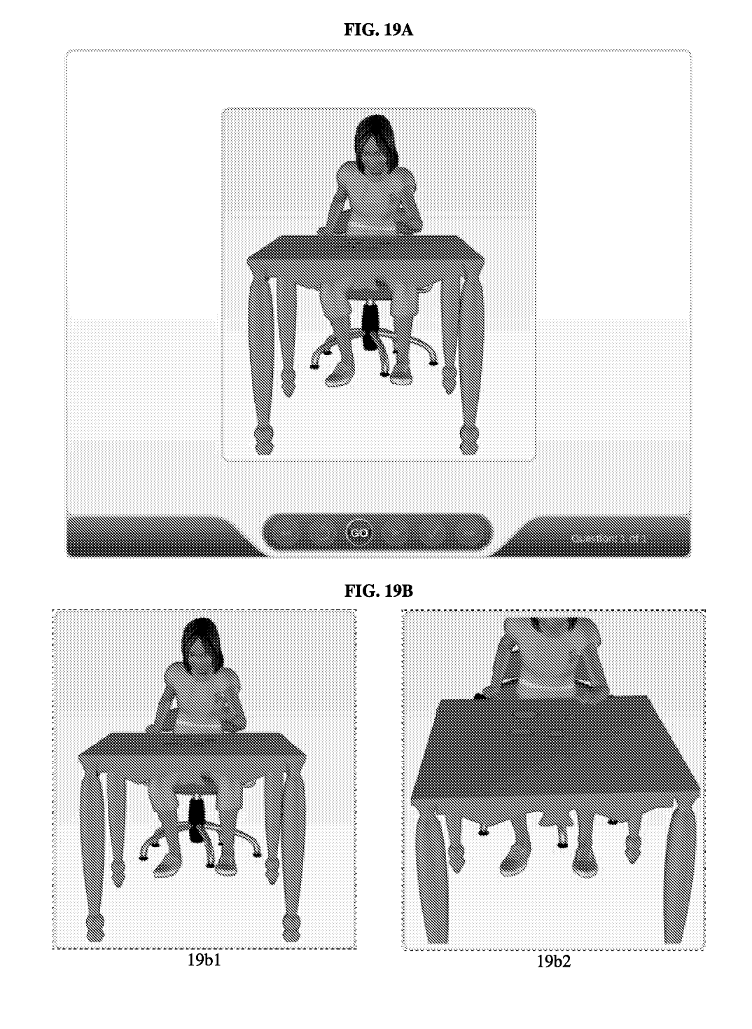

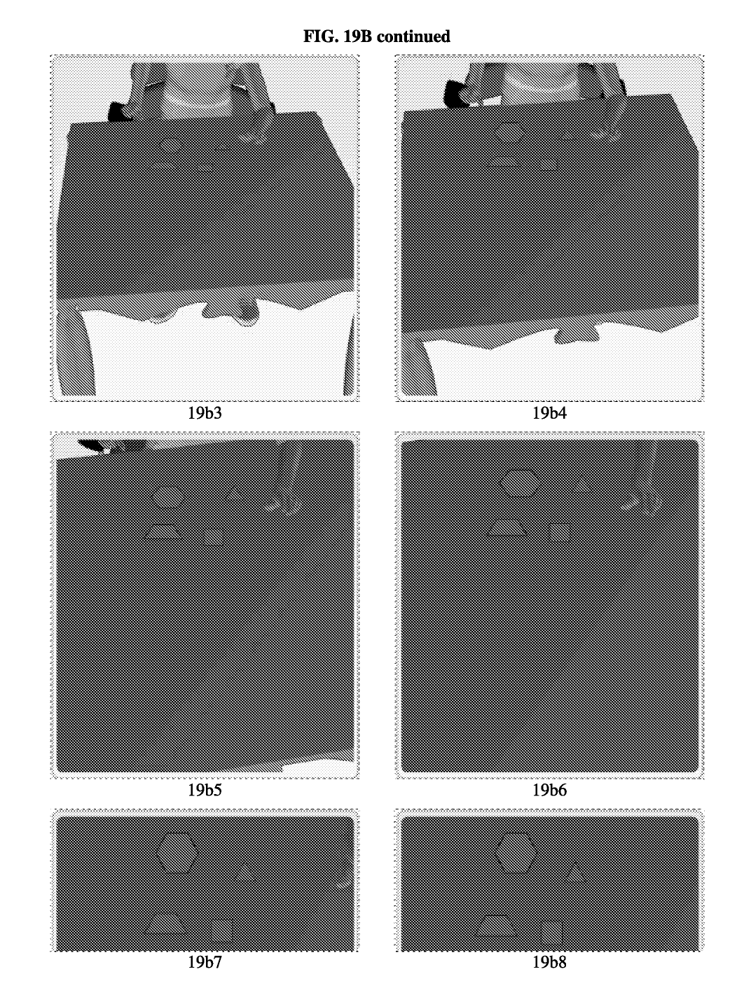

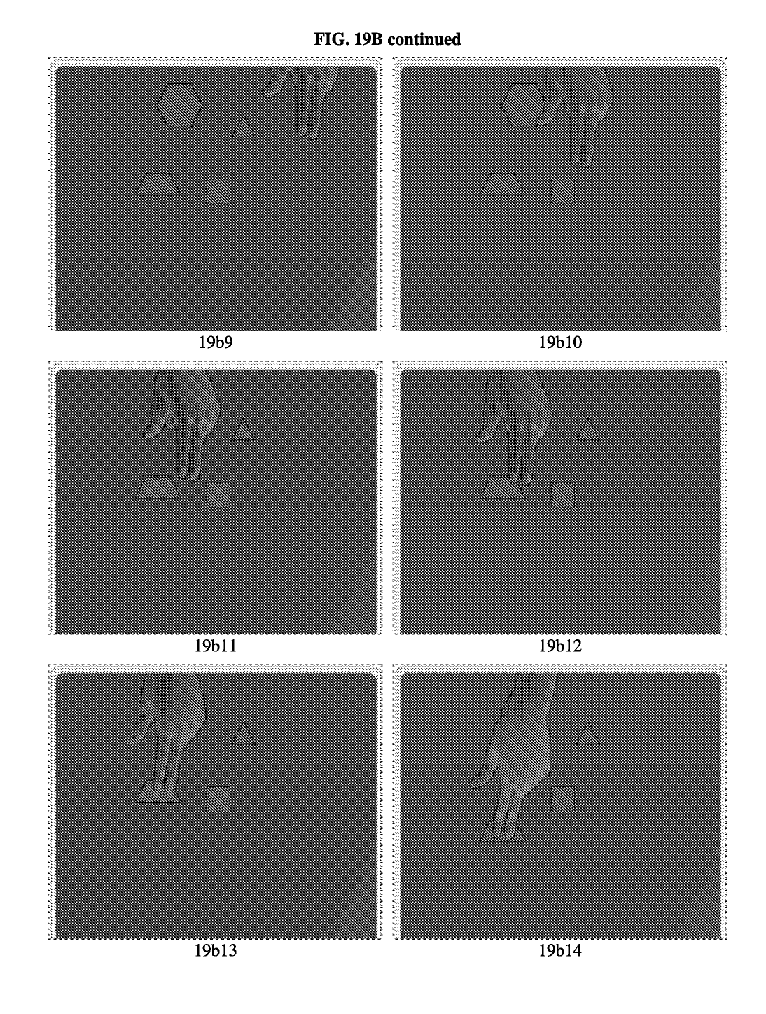

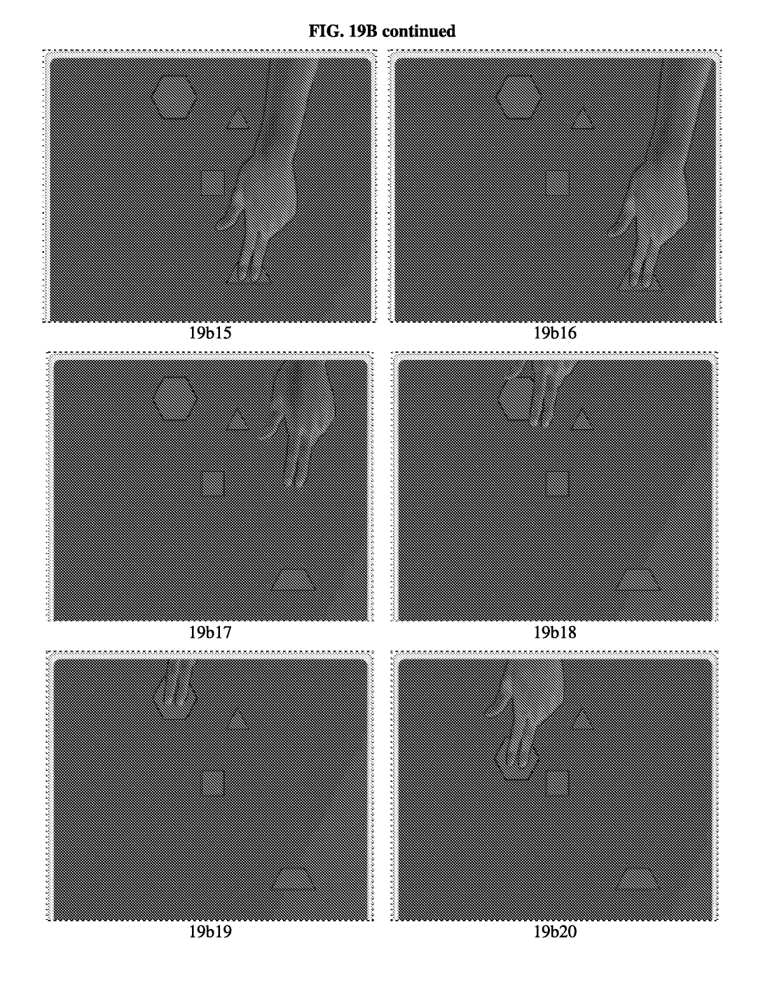

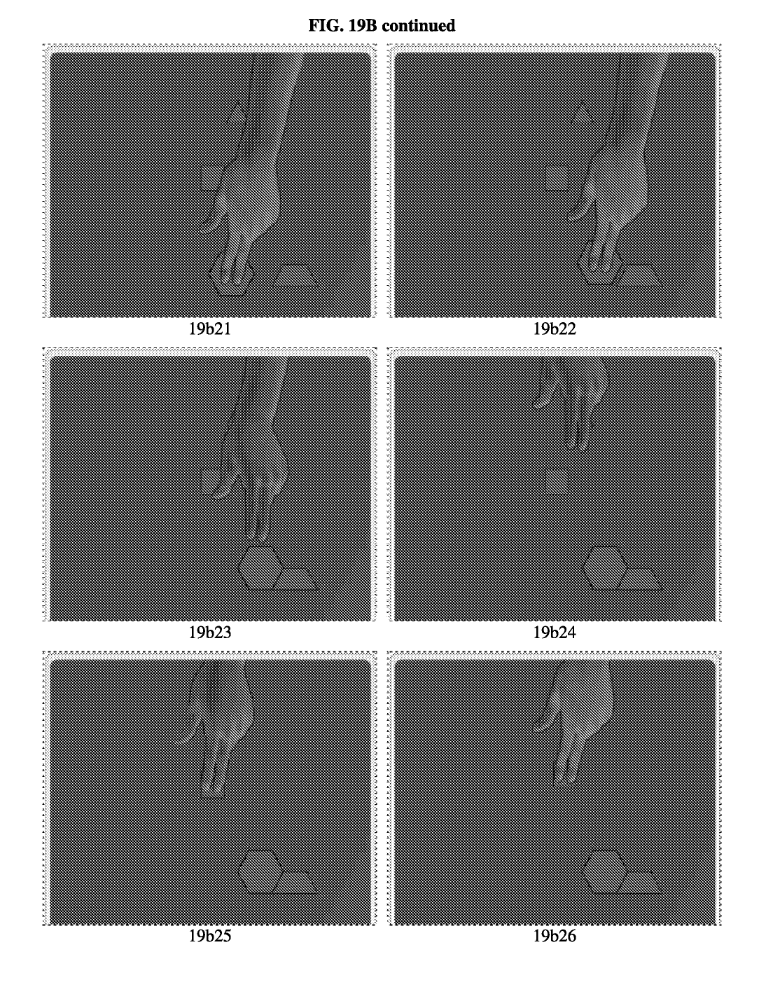

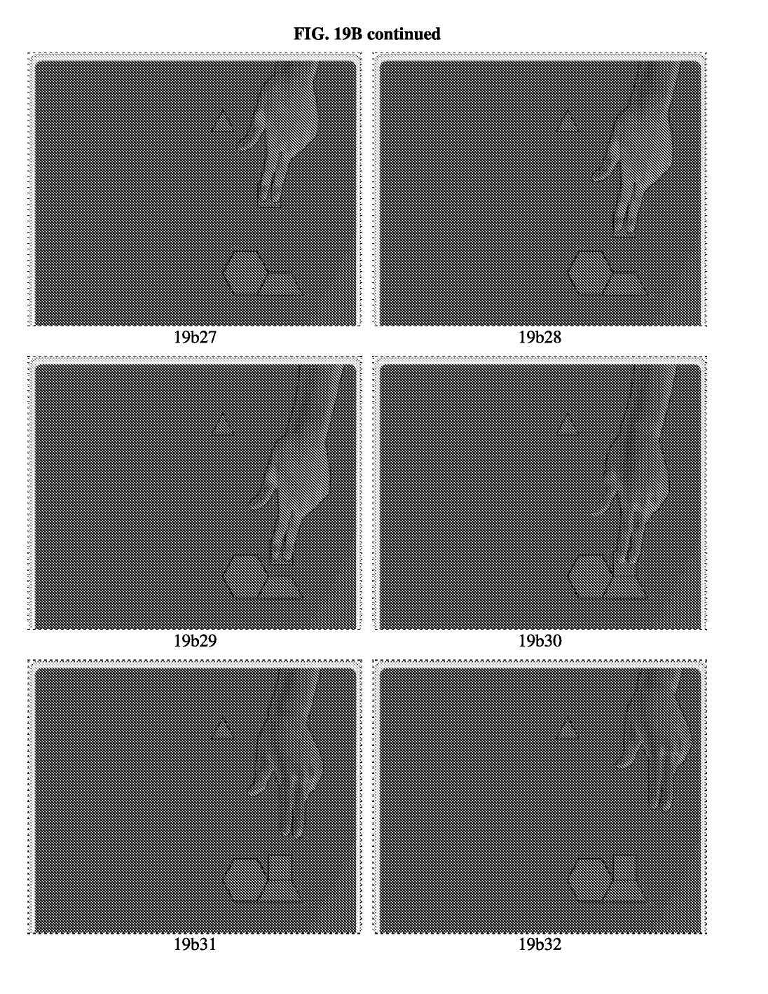

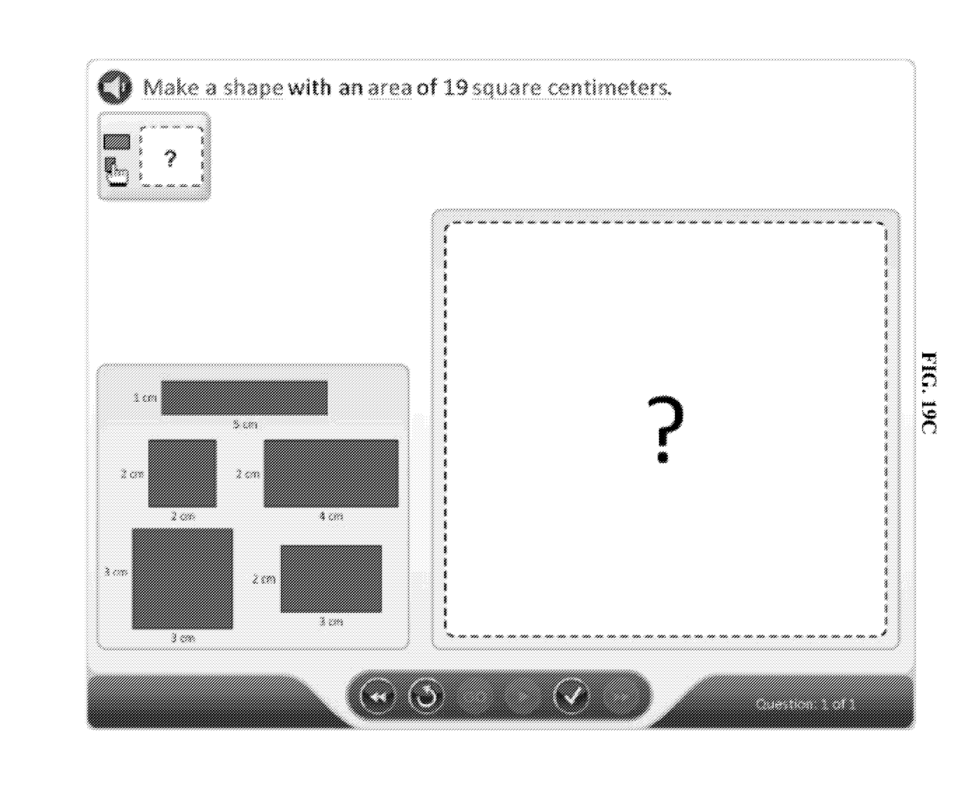

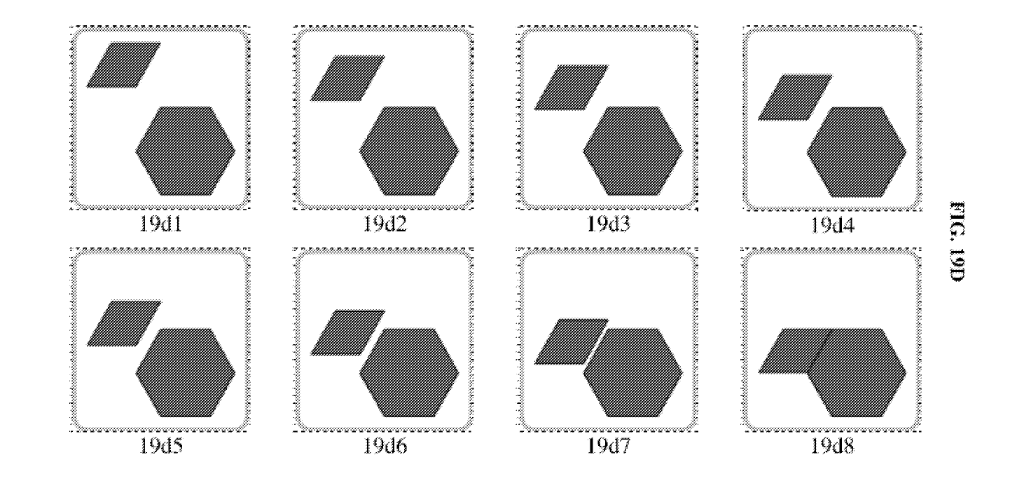

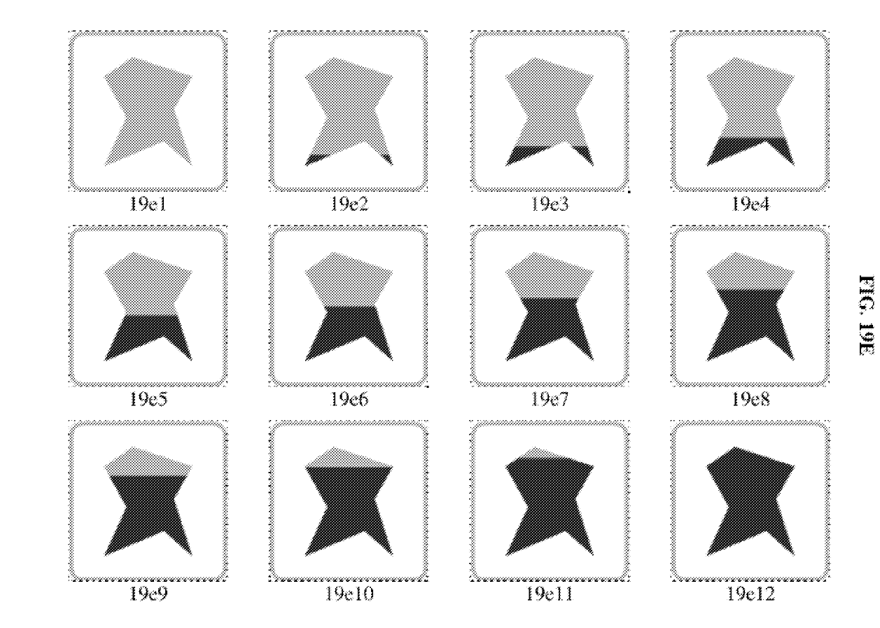

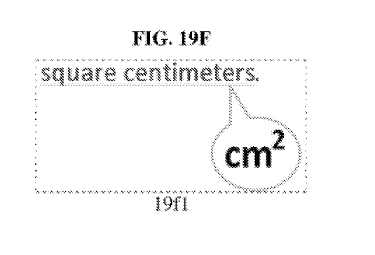

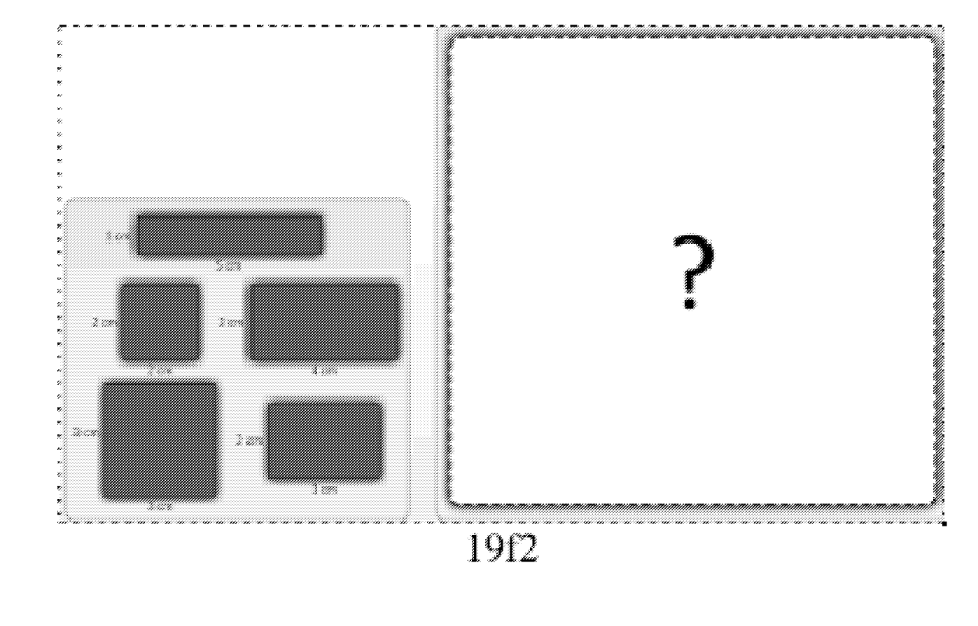

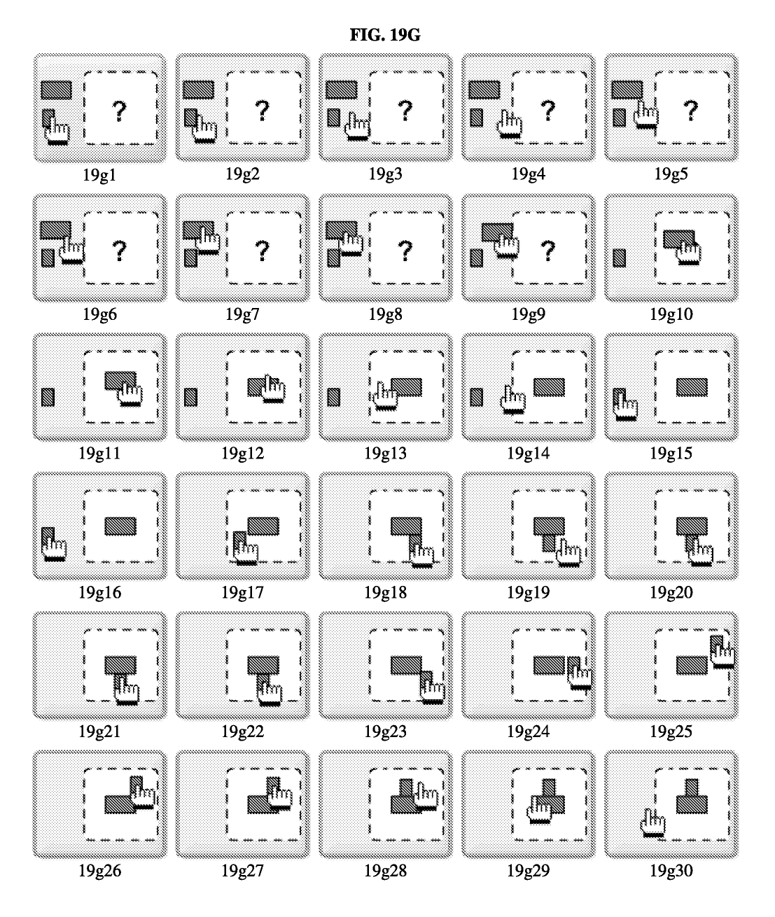

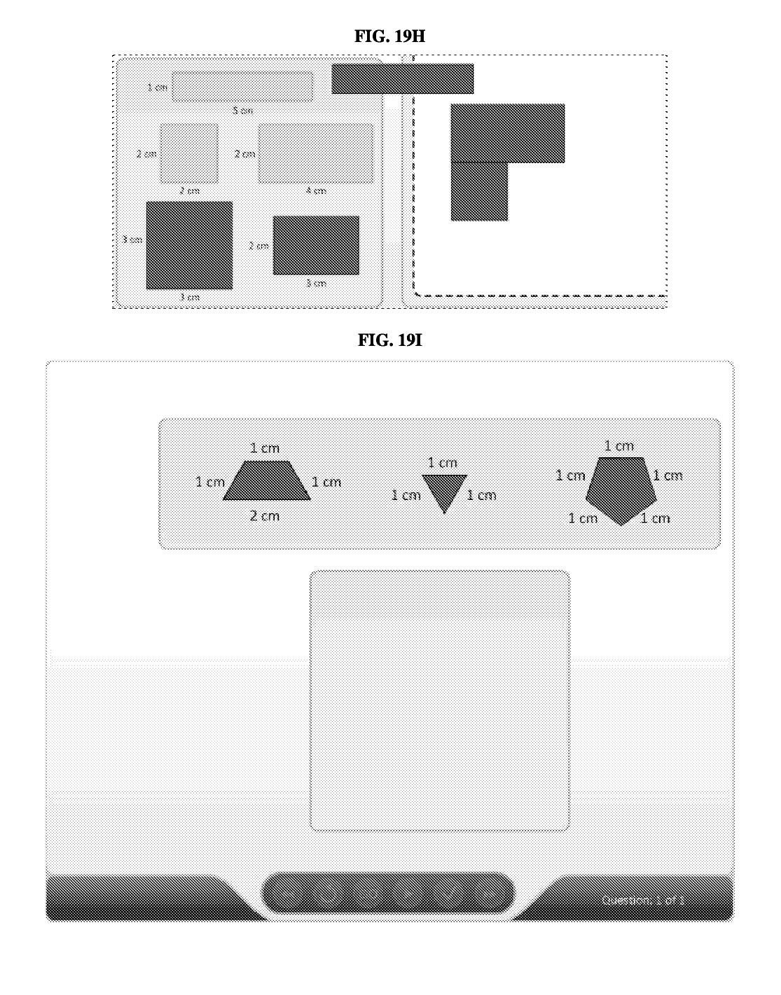

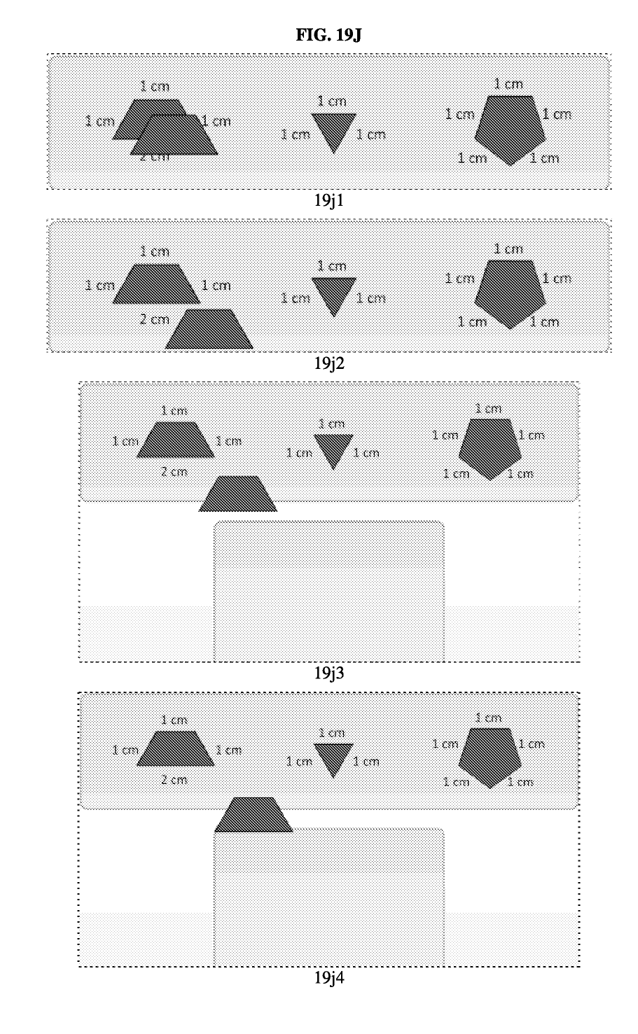

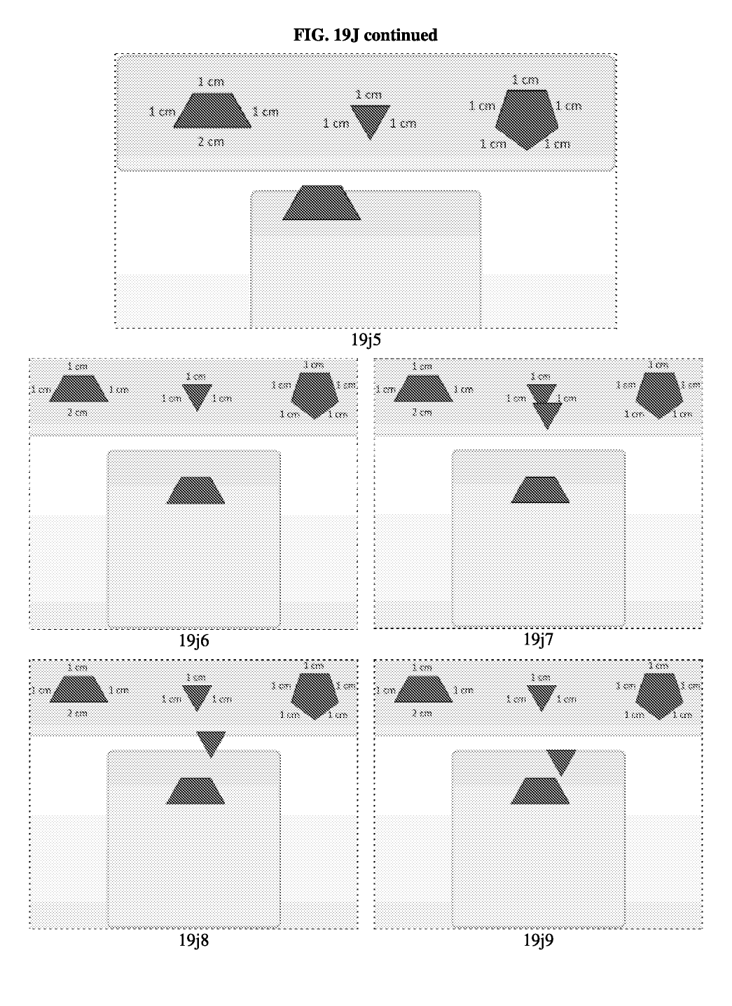

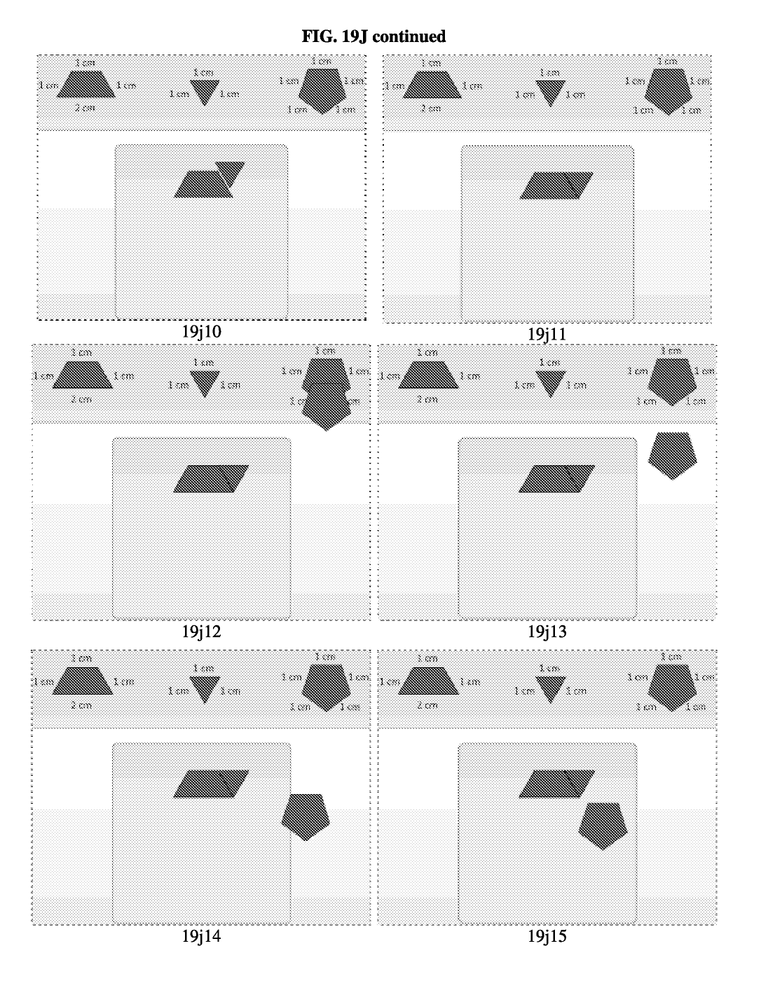

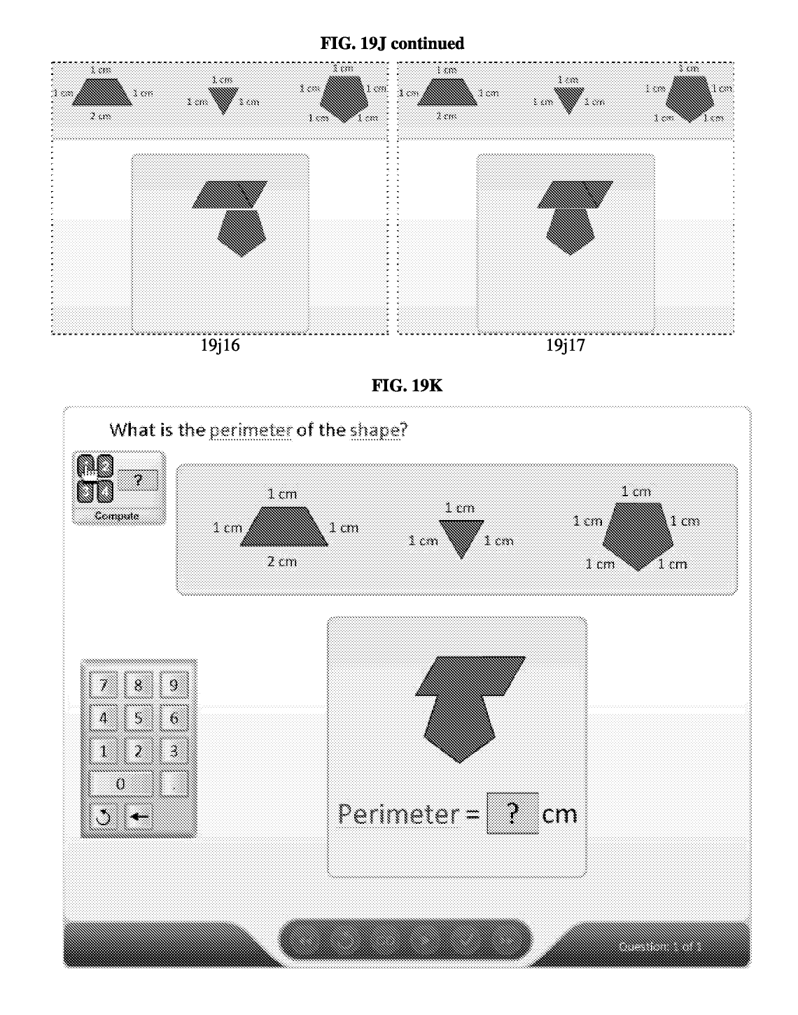

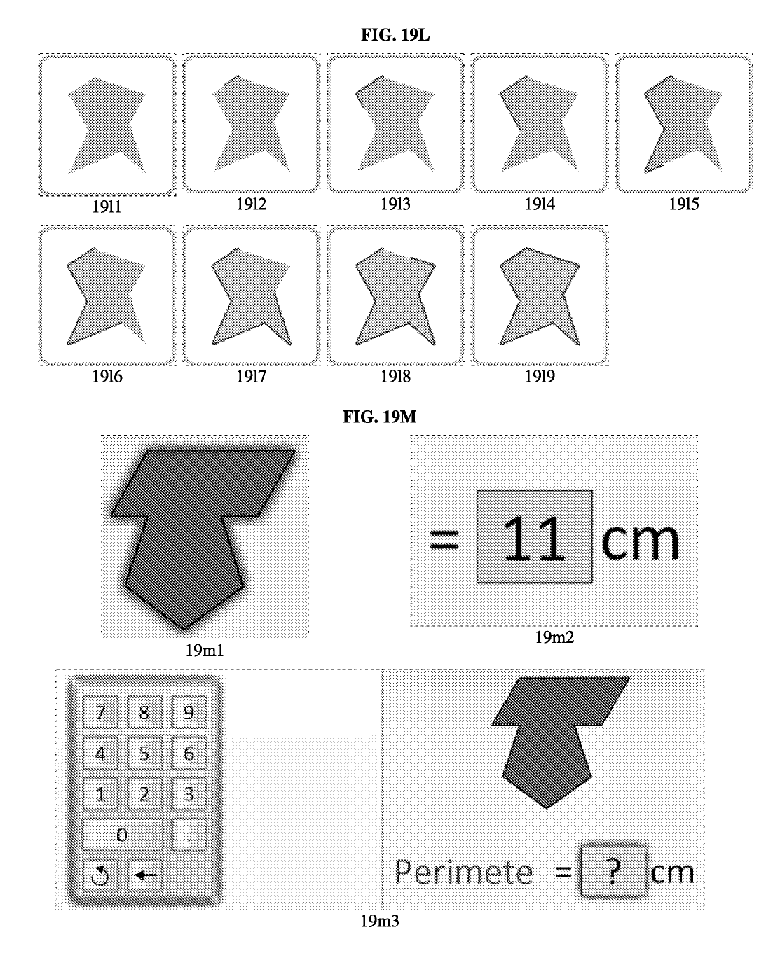

The screenshot in FIG. 19A shows an introductory screen as part of a sample item dealing with building shapes. Screenshots 19b1 through 19b8 show the beginning of a contextual animation in which we see a girl sitting at a table, a zooming into the surface of the table, and four shapes sitting on top of the table. After a brief pause, the girl's hand begins putting available shapes together to form a larger shape, as shown in screenshots 19b9 through 19b32. Because the passage of time between screenshots is not identical, the number of screenshots shown for an animation is not necessarily indicative of the duration of the animation. The duration of animations and the use of pauses within an animation can be tailored as deemed appropriate to conveying the necessary information.

A first problem is posed in the interactive and dynamic screen of FIG. 19C. If the subject scrolls over “Make a shape,” a supplementary image and an animation appear (as shown in FIG. 19D) in the available white space beneath the animated icon. Specifically, the screenshots in FIG. 19D represent a supplementary animation that appears in an available region of the screen to demonstrate what is meant by the “make a shape” cue. This supplementary animation begins by showing two shapes, a parallelogram and a hexagon, as can be seen in 19d1. The parallelogram moves toward the hexagon to show the making of a new shape, as shown in screenshots 19d2 through 19d7. Screenshot 19d8 shows a newly-made shape, after which the supplementary animation stops. The animation of FIG. 19D (and the image in screenshot 19d8 once the animation has completed) remains on the screen until the subject scrolls the input-device pointer away from the screen element (“Make a shape”) that initiated the supplementary image and animation. The animation could instead be continuously looped as long as “Make is shape” is selected or scrolled over, such that once the shape-making animation has completed it begins anew or continues from a previous stopping point.

If the subject scrolls over “area” in the clause at the top of the display area, a new supplementary image and animation appears to give definition to the highlighted term, as shown in FIG. 19E. This animation again occurs in an available region below the animated icon, but any available region on the screen can be used. The animation depicted shows a particular light-colored shape that is “empty” but that is “filled” from the bottom with dark-coloration. The supplementary animation depicted in screenshots 19e1 through 19e12 demonstrates that the area of a shape is the amount of space that is required to fill the inside of the shape. It is noted that a unique multi-sided shape that is not available for use in the problem posed, cannot be formed with available shapes, and is otherwise not displayed elsewhere in the sample item is presented in the supplementary animation so as to convey the concept of the area of any shape and not to suggest that only a particular shape is the focus of the problem.

Screenshot 19f1 of FIG. 19F shows the image that appears if the subject scrolls over “square centimeters,” and 19f2 shows that the box of shapes and the response space with the question mark are highlighted if the subject scrolls over the animated icon.

Screenshots 19g1 through 19g30 of FIG. 19G show the states of the animated icon for the making a shape response function. FIG. 19H shows a screenshot of a rectangular shape being dragged to into the response space to make a new shape according to the response function.

FIG. 19I shows an introductory screen of a second section for this sample item. Without delay, a contextual animation begins to set the stage for a subsequent problem to be posed, as shown in FIG. 19J. Here, screenshots 19j1 through 19j17 show that particular shapes with defined dimensions are combined to form a particular larger shape. Brief pauses after 19j6 and 19j11 help make the animation easier to understand. FIG. 19K shows a second problem that is posed in the sample item, asking the subject about the perimeter of the shape that was formed in the animation.

The dynamic introductory screen permits the subject to interact with the term “perimeter,” as a result of which a supplementary animation demonstrating what is meant by the term begins. This supplementary animation, shown in FIG. 19L, draws a line around the perimeter of a unique multi-sided shape. When the subject scrolls away from the term “perimeter,” the animation disappears from the region below the animated icon. It can be reviewed again by the subject if he or she scrolls over the screen component again. Screenshots 19m1 and 19m3 of FIG. 19M show what is highlighted or otherwise emphasized if the subject scrolls over “shape” and the animated icon, respectively. Screenshot 19m2 shows a potential response of 11 entered into the response space defined by the box with the question mark.

A subsequent section with a third introductory screen is shown in FIG. 19N. There is no accompanying animation, and the third problem is posed in the introductory screen. The subject may interact with “Make a shape” and “perimeter” as before, and scrolling over “centimeters” shows the supplementary image in 19o1 of FIG. 19O. Scrolling over the animated icon highlights the response space containing the box with a question mark along with the box containing the available shapes, as shown in 19o2. A potential shape is being made according to the response function in 19o3.

### Sample Item 16

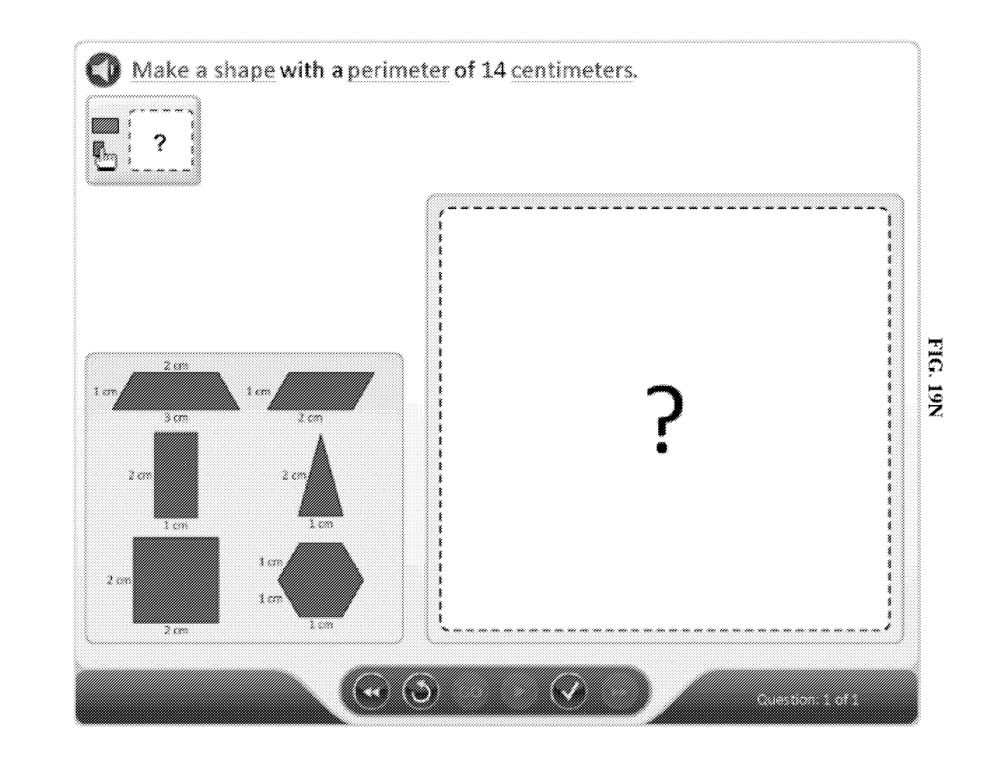

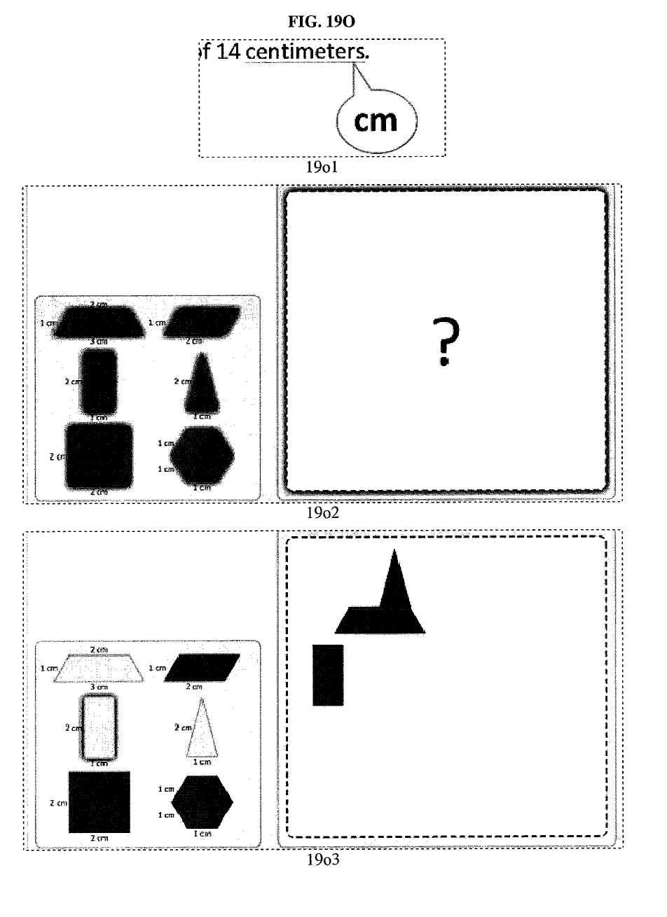

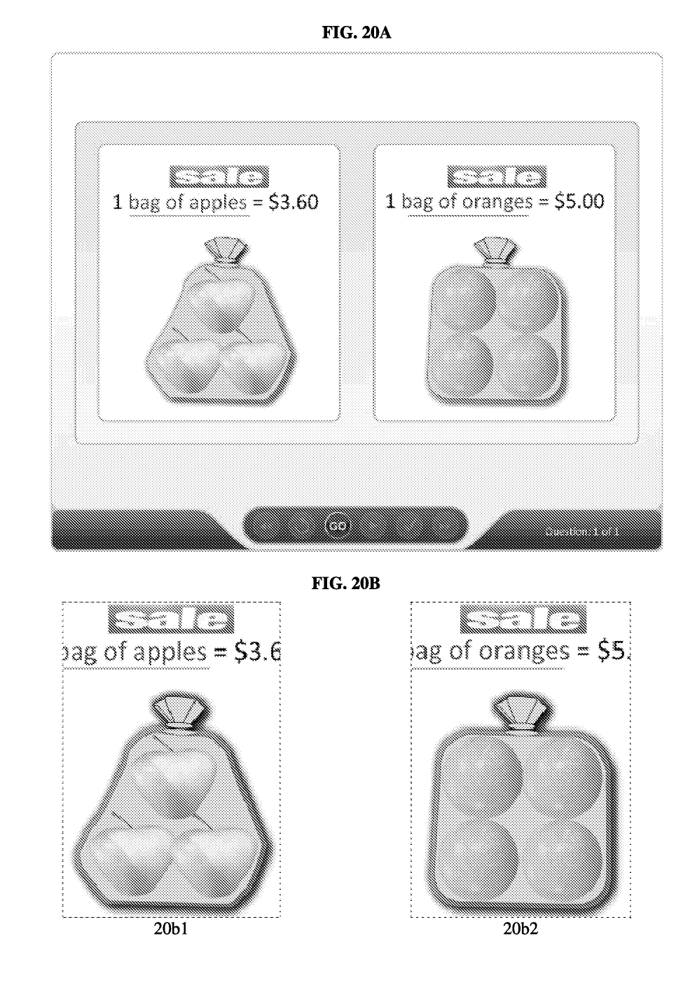

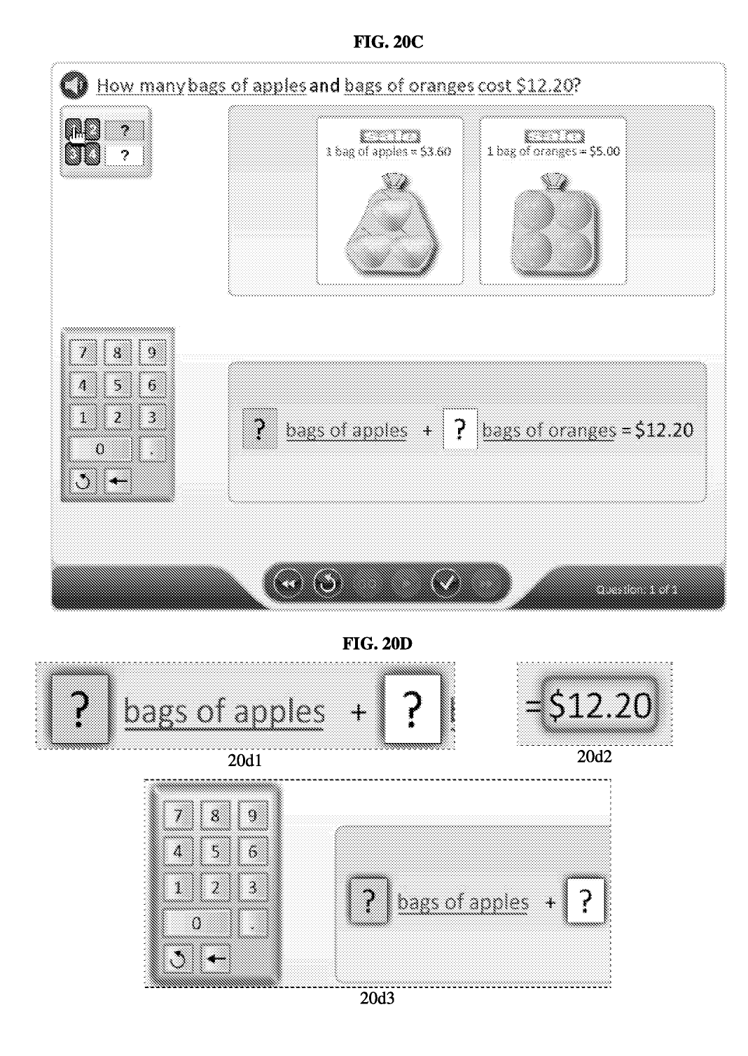

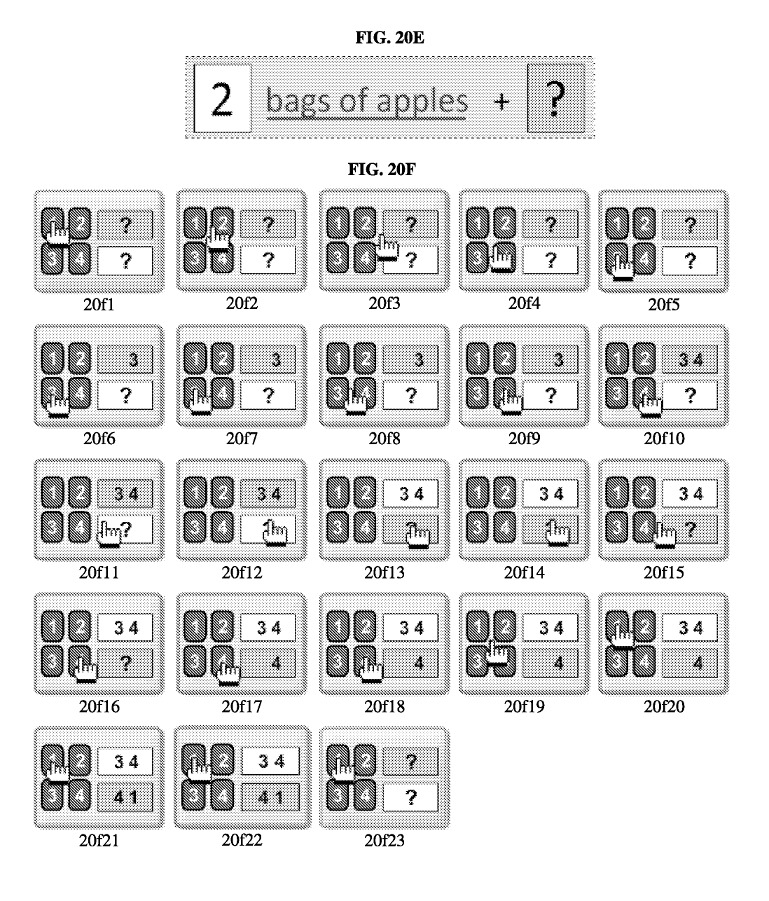

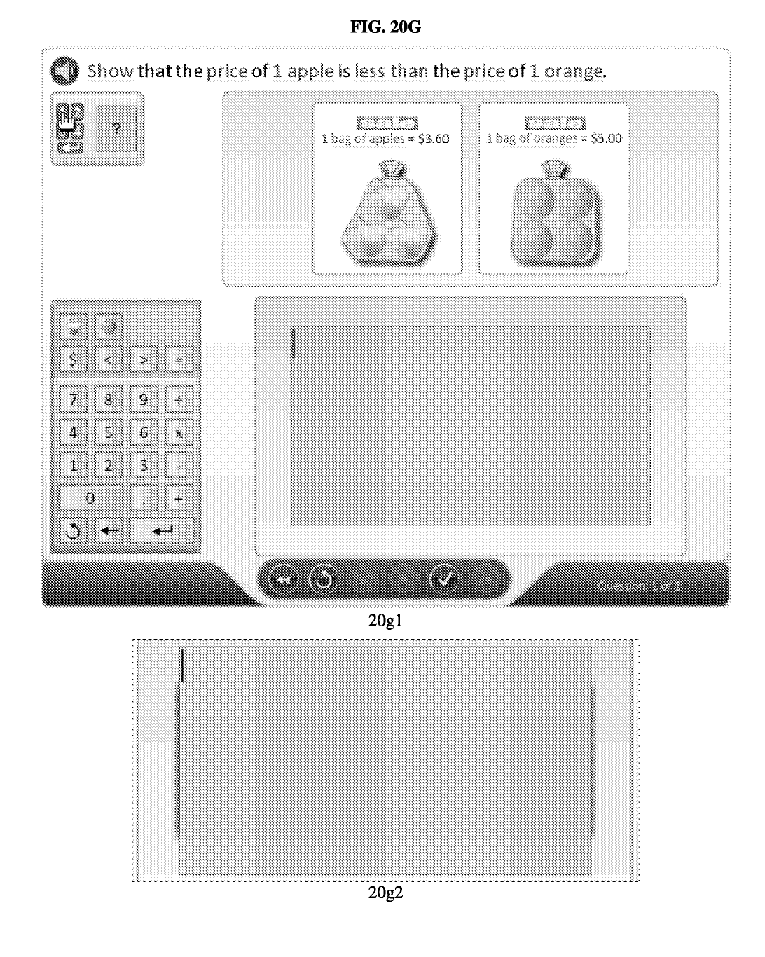

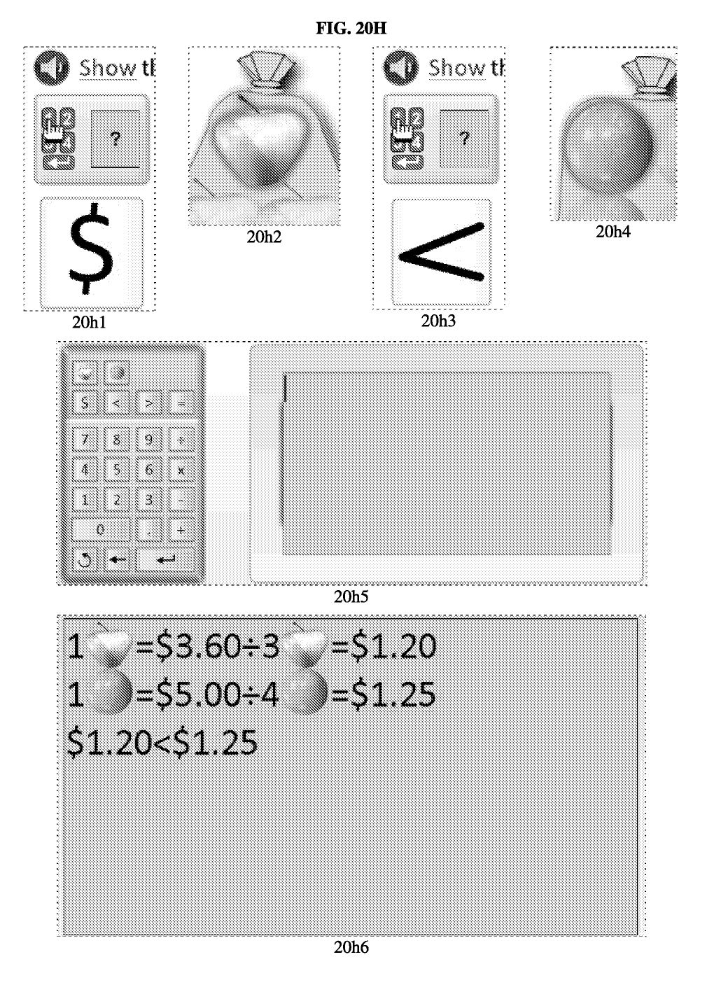

FIG. 20A shows a first introductory screen in a sample item related to mathematics. This introductory screen is interactive, and scrolling over “bag of apples” and “bag of oranges” highlights the bags as shown in 19b1 and 19b2 of FIG. 19B.

FIG. 20C shows a first problem that is posed once the subject presses the checkmark in the navigation bar to navigate away from the introductory screen. Scrolling over “How many,” “cost $12.20,” and the animated icon result in emphasis of the components as shown respectively in the three screenshots of FIG. 20D. FIG. 20E shows a “2” entered into the left blank of the response space, and the right question box highlighted to show preparation for entry. The screenshots of FIG. 20F show the animated icon for the first section of this sample item. States 20f1 through 20f3 include the image of the hand moving away from its original position in an introductory phase of the animated icon. Screenshots 20f4 through 20f22 show a demonstrative phase of the animated icon, during which the represented keypad entry into a represented response space is visually demonstrated. Screenshot 20f23 shows a conclusory phase of the animated icon, during which the animated icon resets to its initial state.

Screenshot 20g1 of FIG. 20G shows another problem being posed in a second section once the subject navigates past the first problem of the first section. Scrolling over “Show” highlights the free-form area of the response space, as shown in 20g2. Interacting with “price,” “1 apple,” “less than,” “1 orange,” and the animated icon results in the screen displays of 20h1 through 20h5, respectively, of FIG. 20H. An example response entered into the free-form area of the response space using the provided keypad is shown in 20h6. It is noted that the available keys on the keypad provided can be tailored as appropriate, in part to adjust the difficulty of the problem being posed.

The sequence of states in the animation of the animated icon for this section is shown in FIG. 20I. States 20i1 through 20i3 occur during an introductory phase of the animated icon, during which the image of the hand moves away from its initial location. Screenshots 20i4 through 20i31 occur during a demonstrative phase of the animated icon, during which keypad entry using a represented keypad and a represented response space is demonstrated. Screenshot 20i32 occurs during a conclusory phase of the animated icon, during which the animated icon resets to its pre-activated state.

The motions of the hand icon in the animated icon are smooth and can vary in speed, but pauses (that is, relatively higher passage of time) between any two states can break up the flow of the animation to aid understanding. Pauses can be of varying durations, as appropriate, at different points in the animation. When pauses are used, the lack of a pause between two states (for example, between a clenched-hand state and the unclenching of the hand) helps represent to the subject that the selection accomplished by the clenching is a relatively quick selection process accomplished by, for example, pressing and releasing a button (such as through a mouse click). In other words, the passage of time in an animation is itself used to represent activities, ideas, and concepts in a manner that is independent of language.

### Sample Item 17

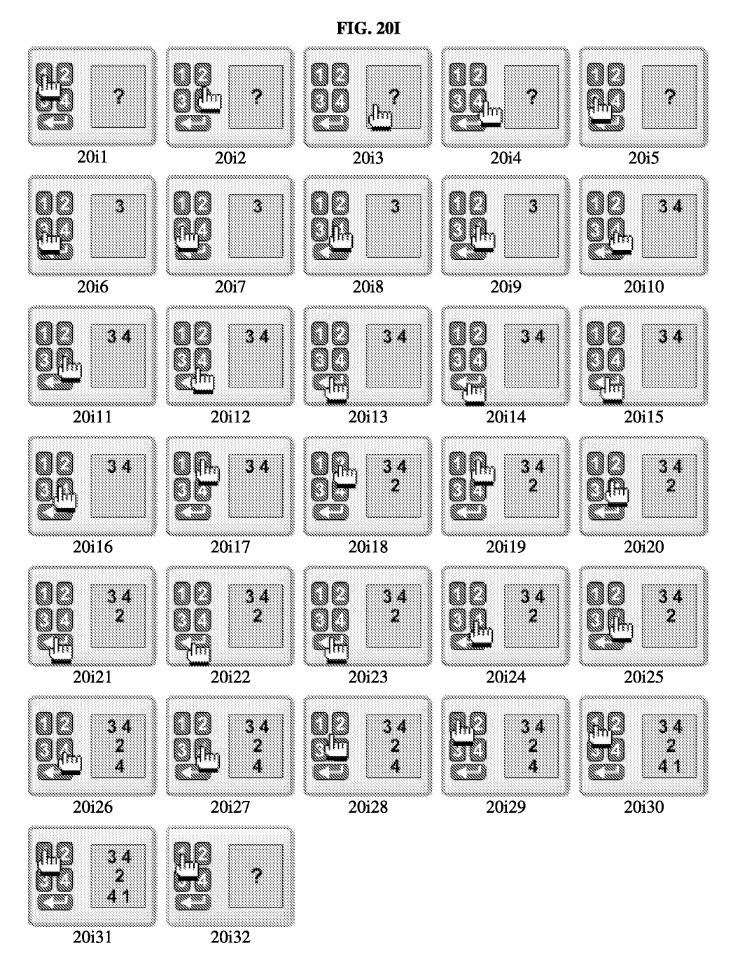

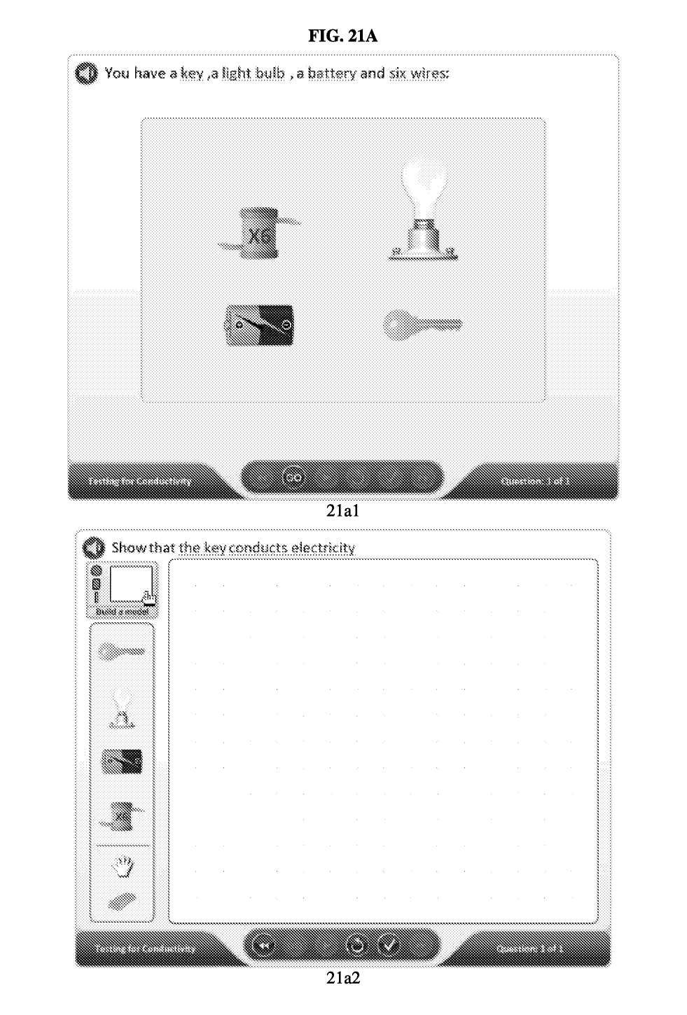

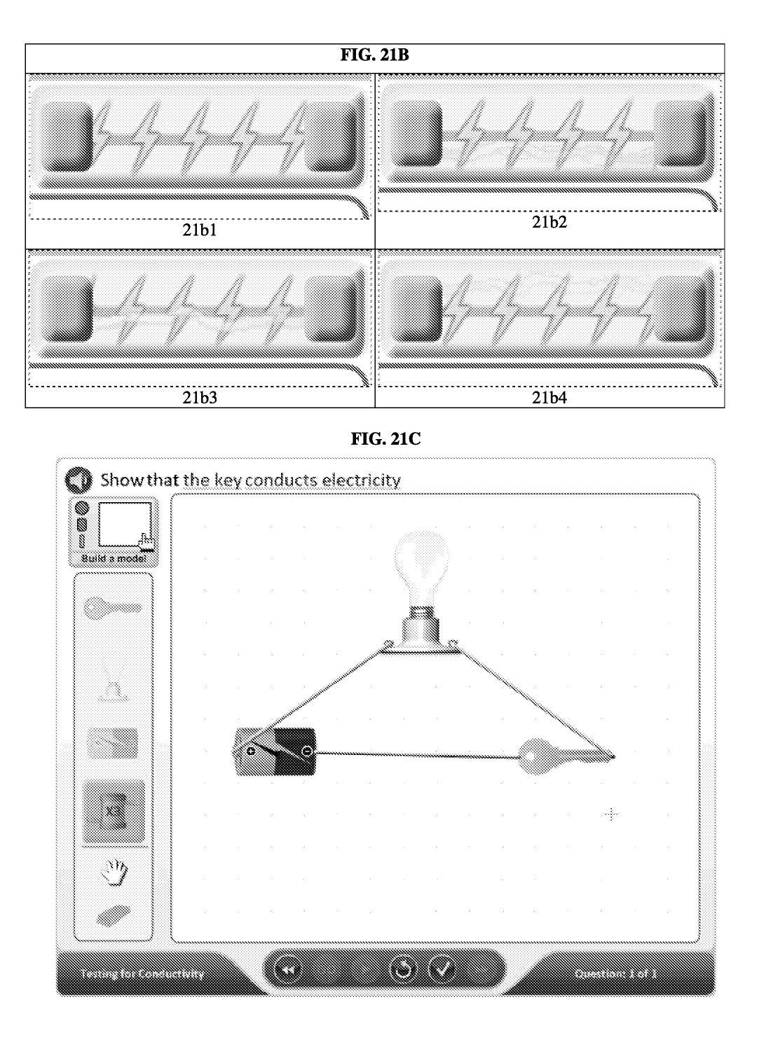

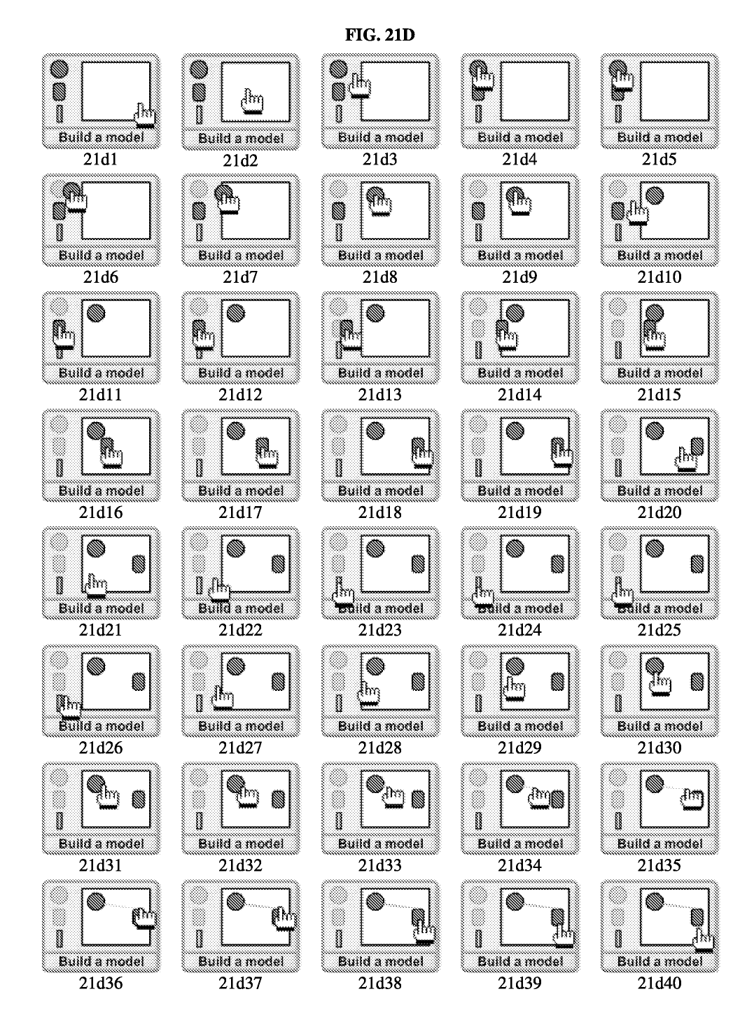

Screenshot 21a1 of FIG. 21A shows an introductory screen of a sample item related to the concepts of electricity. This screen is interactive, and scrolling over the terms “key,” “light bulb,” “battery,” and “six wires” highlights the respective image on the screen (not shown). 21a2 shows a first problem posed in this sample item. A large portion of this screen is the white work area (to the right of the animated icon) that is part of the response space. If the subject scrolls over “conducts electricity,” a supplementary animation is engaged (in an available region to the right of the “Show that the key conducts electricity” clause) through which an electrical current is represented, as shown in FIG. 21B. In this animation, “thunderbolt” icons scroll over the line in the middle, from the left gray box to the right gray box. The gray boxes suggest two connection points, with the line in the middle representing a conducting wire. As the thunderbolt icons are scrolling, a lightning bolt streams from the bottom to the top of the animation, suggesting that electricity is being conducted through the wire, as shown in 21b2 through 21b4. It is noted that audio may be added to enhance the ability of animations to better convey information and enhance understanding. In this supplementary animation of the conduction of electricity, for example, the sound of electricity crackling through a high-voltage wire could overcome additional barriers between the subject and the concepts being taught or evaluated.

FIG. 21C shows a potential partial response that may be entered into the white work area of the response space. The subject is able more directly to demonstrate his or her knowledge of the concepts related to electricity by building a model, overcoming internal and external barriers to evaluation. FIG. 21D shows the states of a build-a-model animated icon.

### Sample Item 18

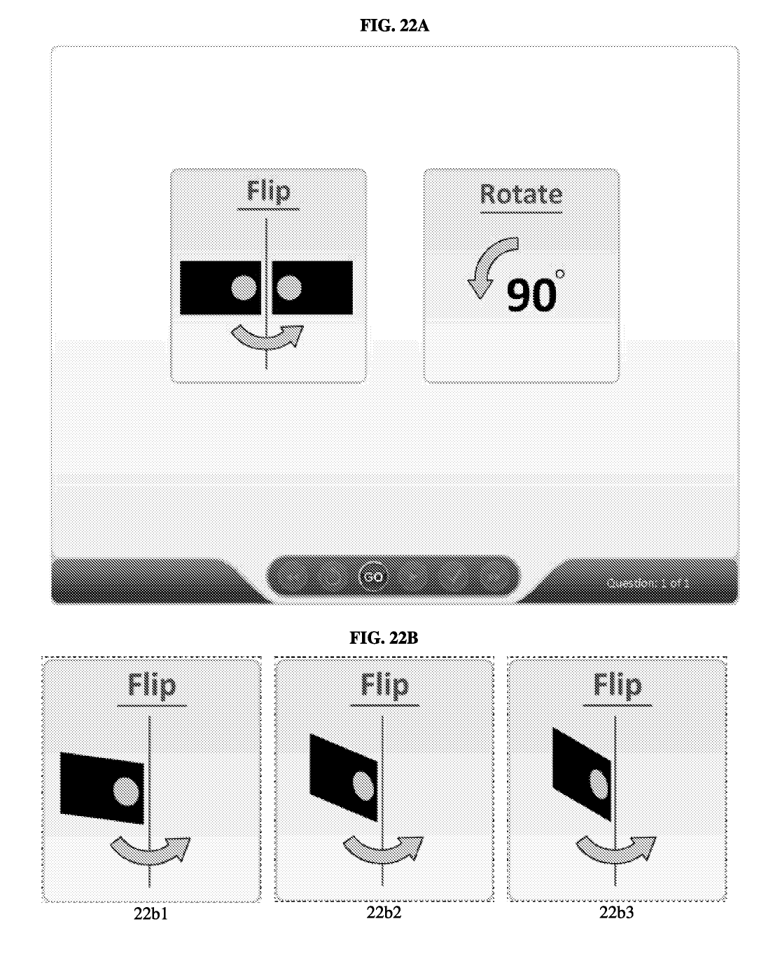

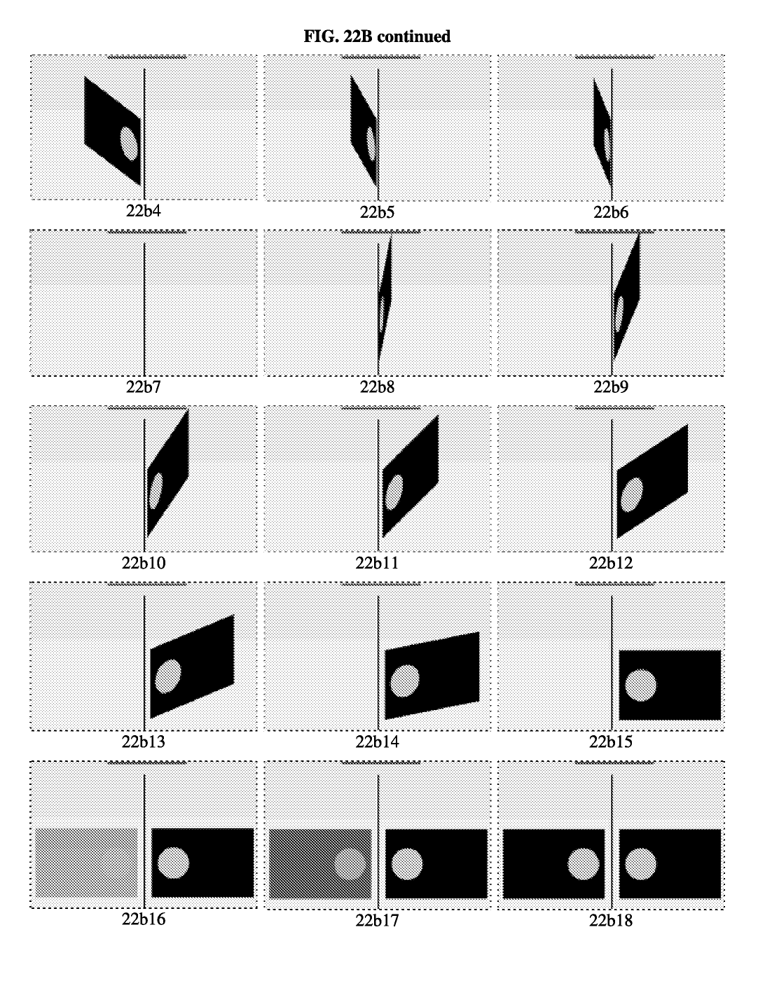

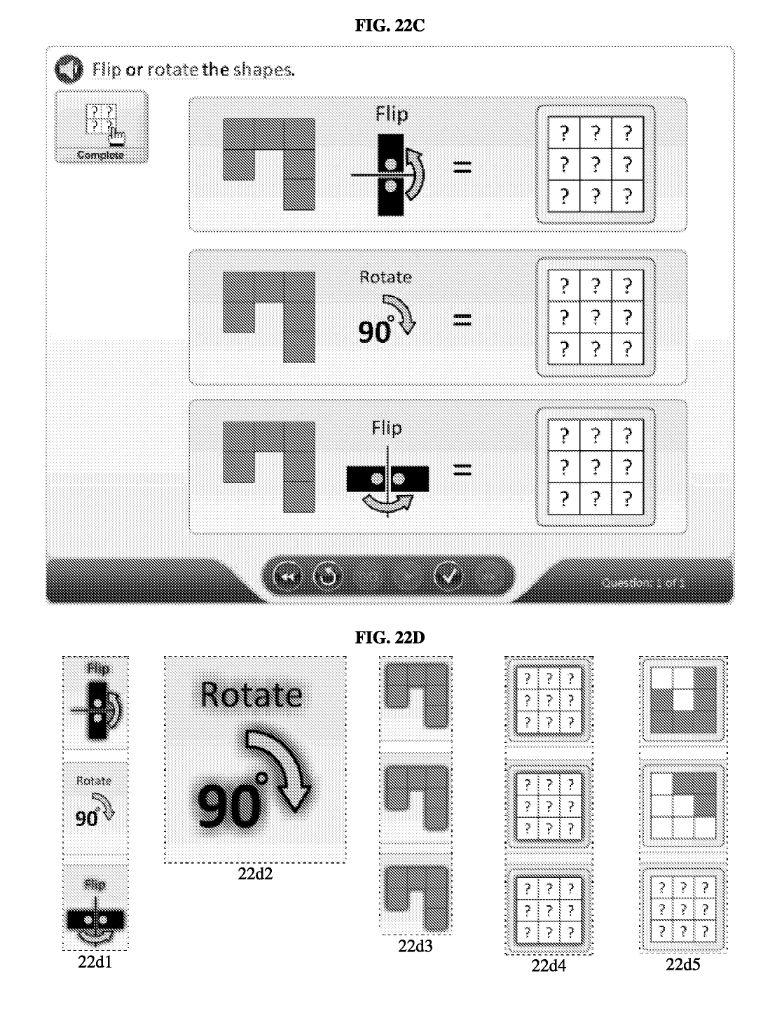

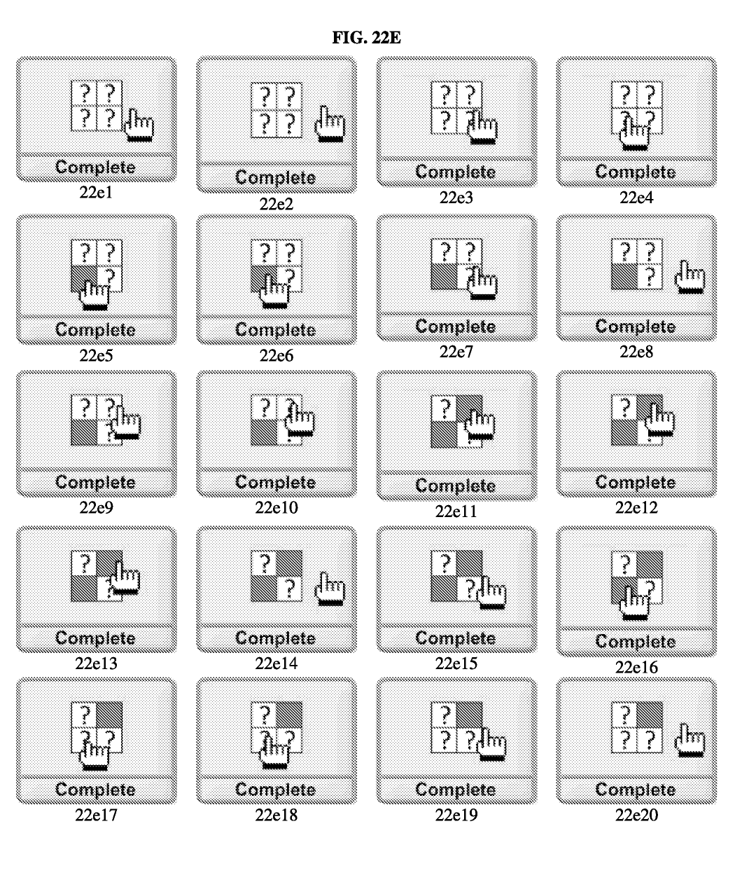

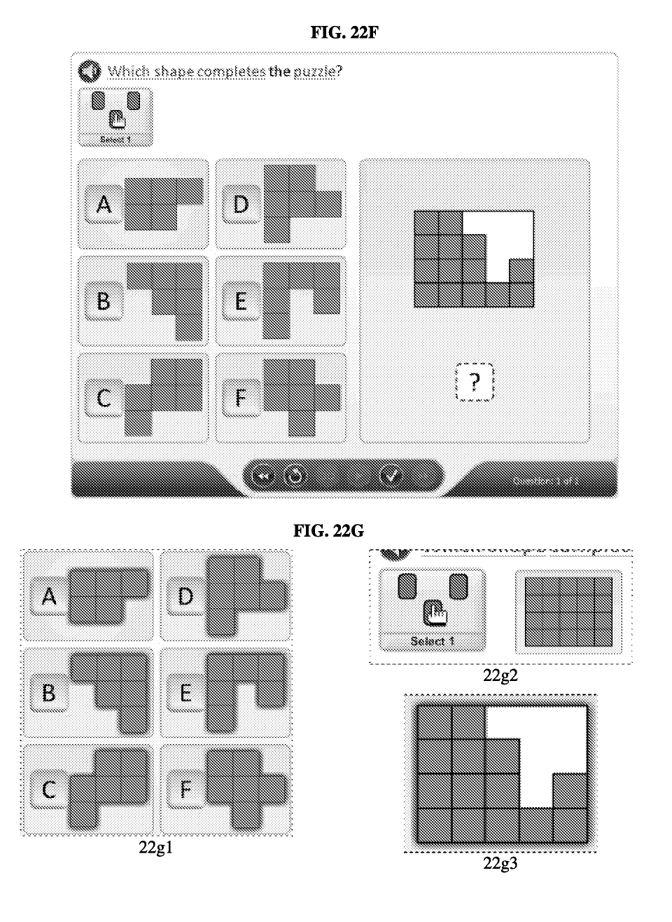

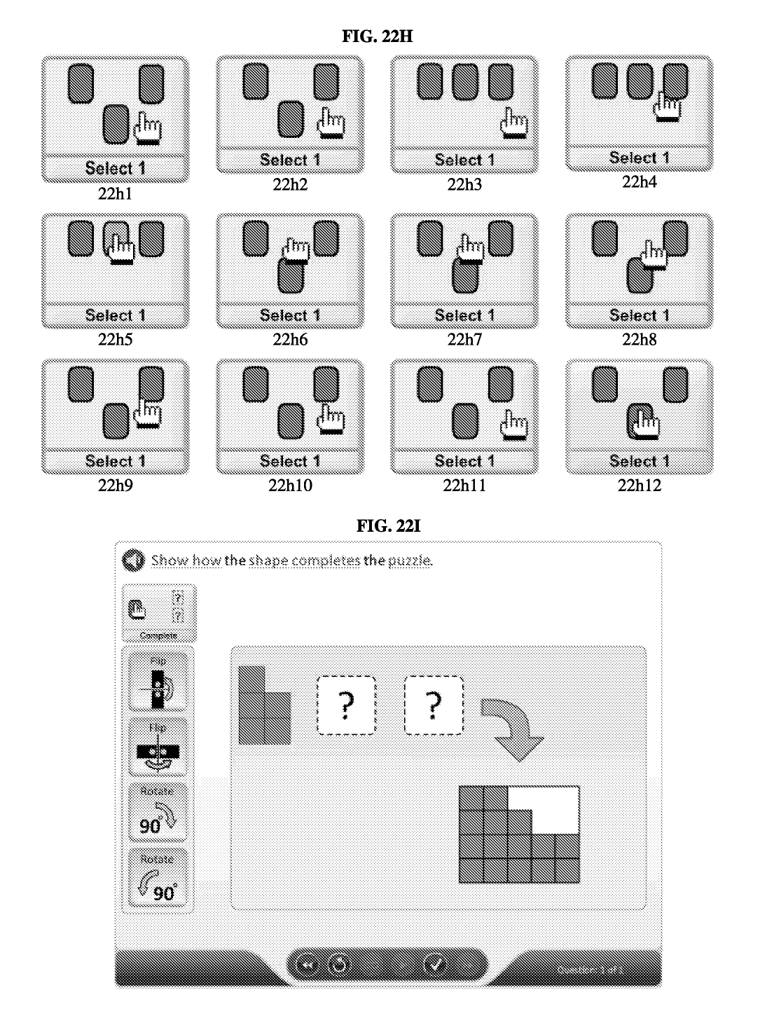

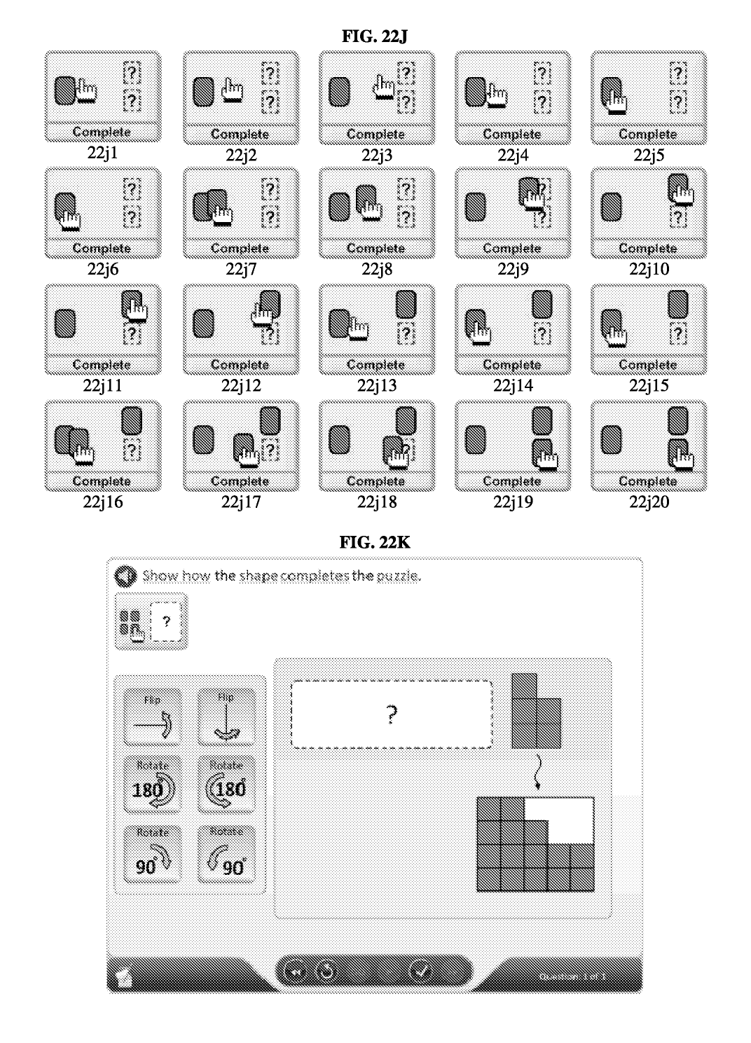

FIG. 22A shows an introductory screen of a sample item related to a puzzle. A contextual animation demonstrating the concept of flipping is depicted in FIG. 22B. It is noted that the relevant portions of the display area of FIG. 22A are cropped and zoomed into as appropriate.

FIG. 22C shows a first interactive problem. The first four screenshots of FIG. 22D show what occurs if the subject scrolls over “flip,” “rotate,” “shapes,” and the animated icon, respectively. Screenshot 22d5 shows a partially-complete response in the response space of the first problem. FIG. 22E depicts an animated icon demonstrating the response function for solving the puzzle posed in the first problem.

FIG. 22F shows a second problem being posed in a second section of the sample item. If the subject scrolls over “Which shape” or “puzzle,” the shapes and puzzle are highlighted, as shown in screenshots 22g1 and 22g3, respectively, of FIG. 22G. If the subject scrolls over “completes,” however, a supplementary image appears to the right of the animated icon to show a rectangle with a completed grid representing the completion of the puzzle. The states shown in FIG. 22H represent the animated icon for this section of the sample item.

FIG. 22I shows a third problem being posed in a third section of this puzzle sample item. As suggested by the empty box at the top left of the response screen, one or more operations need to be selected to complete the puzzle. For this screen the subject must determine how many and which operations complete a given puzzle, and a correct response here (there are several possible approaches), demonstrates the subjects' conceptual grasp of this abstract mathematical concept. Incorrect responses are captured as well and scoring algorithms determine where and how the student misunderstands the targeted operations for this item. By linking this correct or incorrect response with responses on the previous screens, the scoring algorithms within the entire item provide defensible information about the stability and defensibility of the subject's grasp of the cognitive skill focused on in the item.

The screenshots in FIG. 22J depict the animated icon for this section of the sample item. FIG. 22K shows a fourth problem being posed in a fourth section of this puzzle sample item. Subjects are free to develop their own solution, and FIG. 22L depicts one potential response to the problem posed.

### Sample Item 19

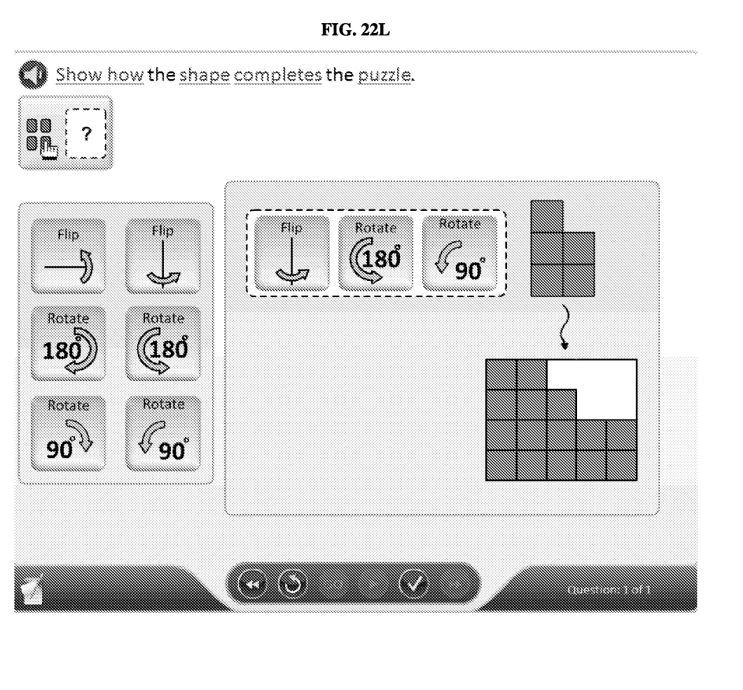

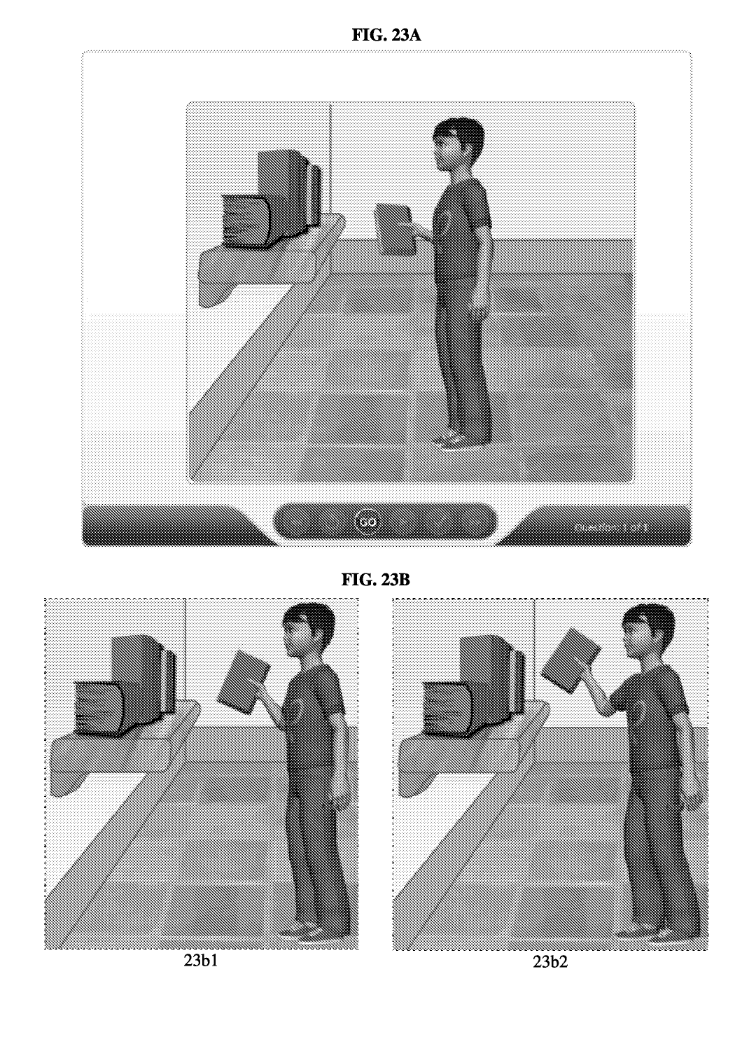

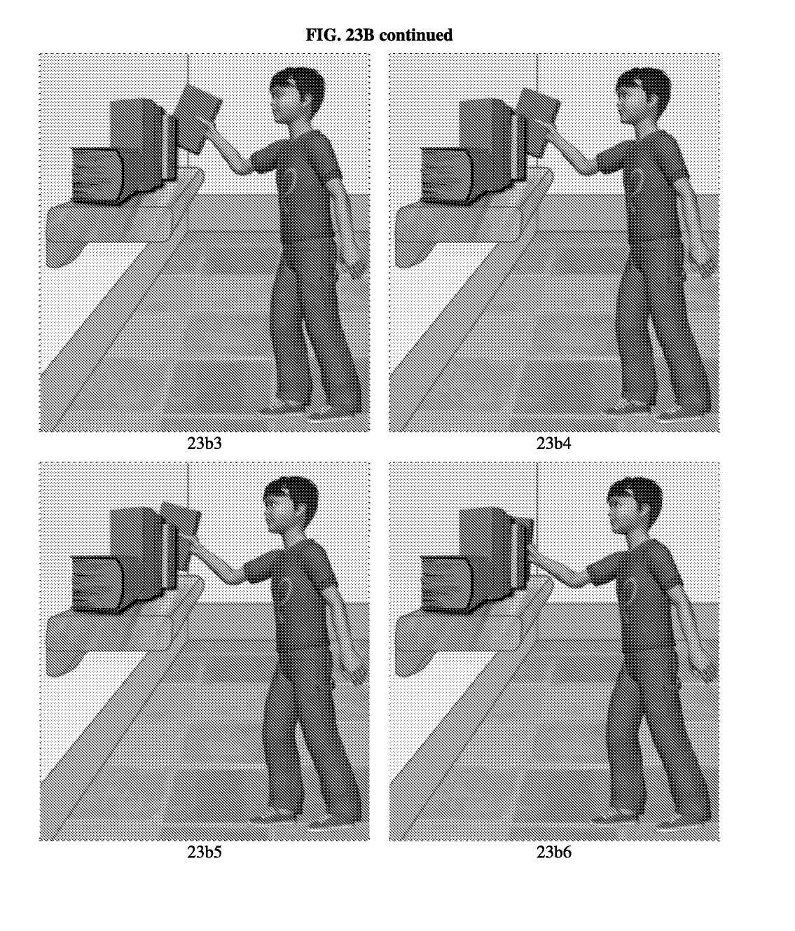

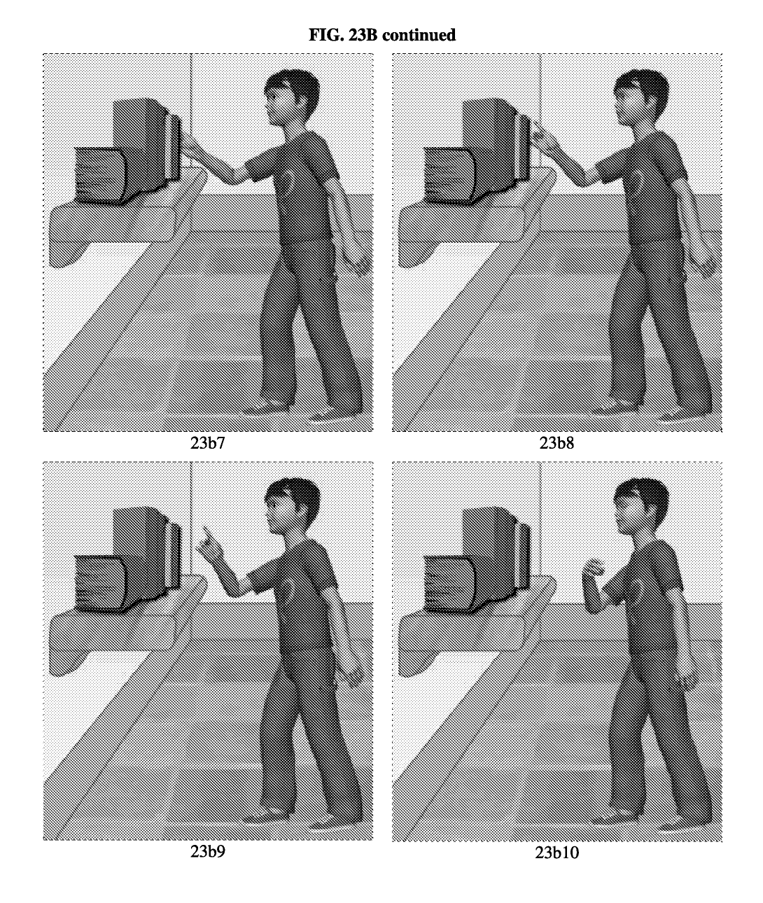

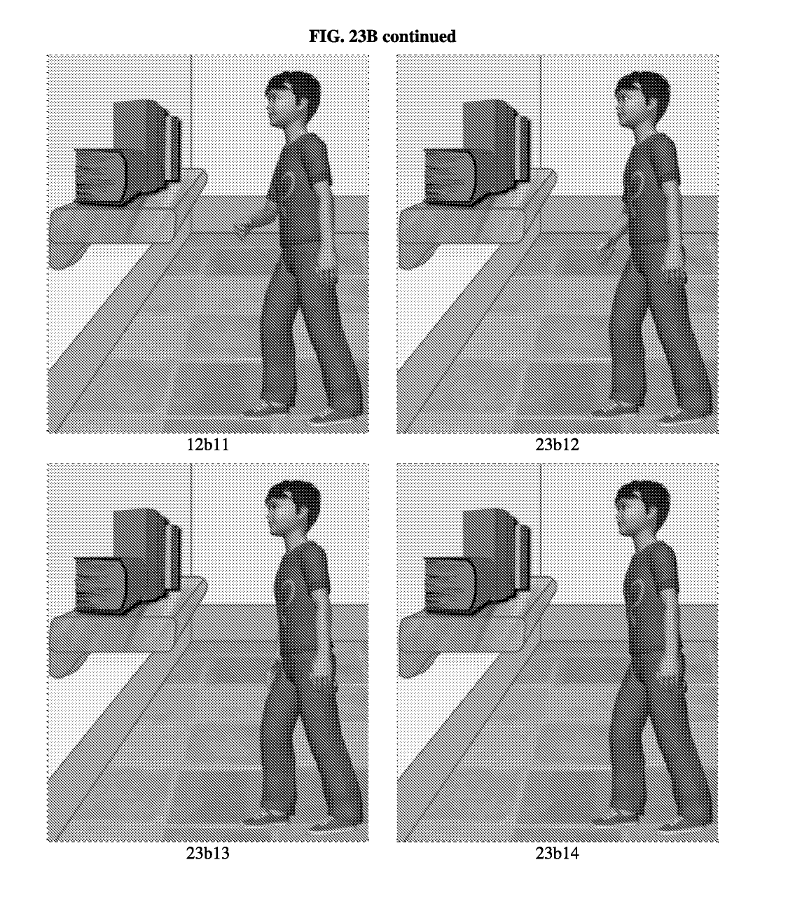

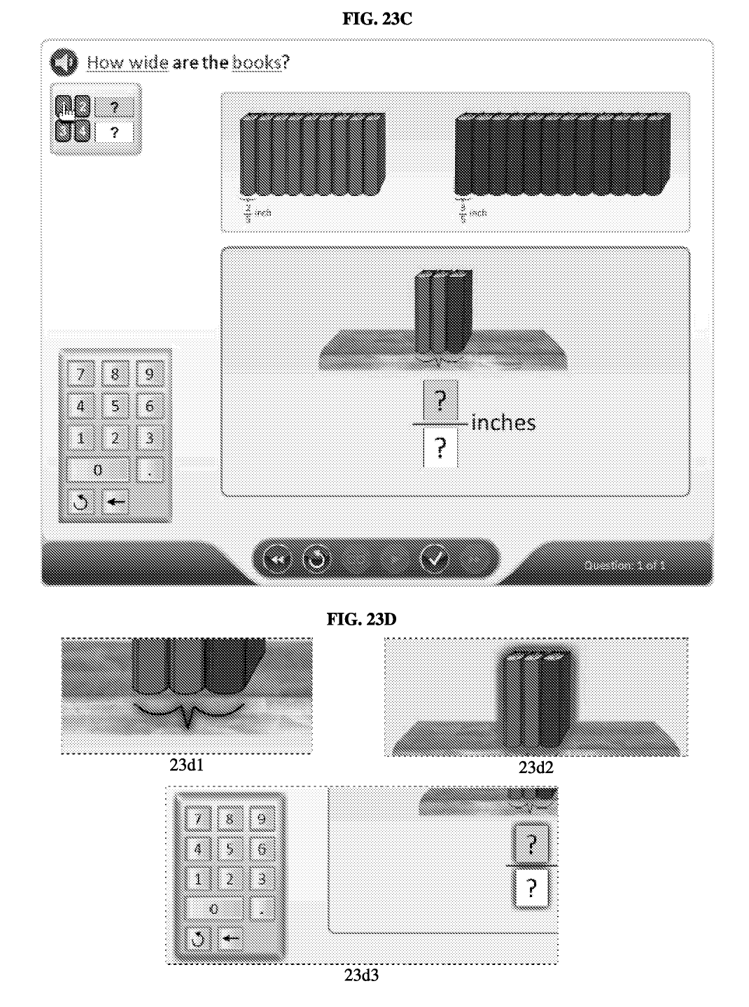

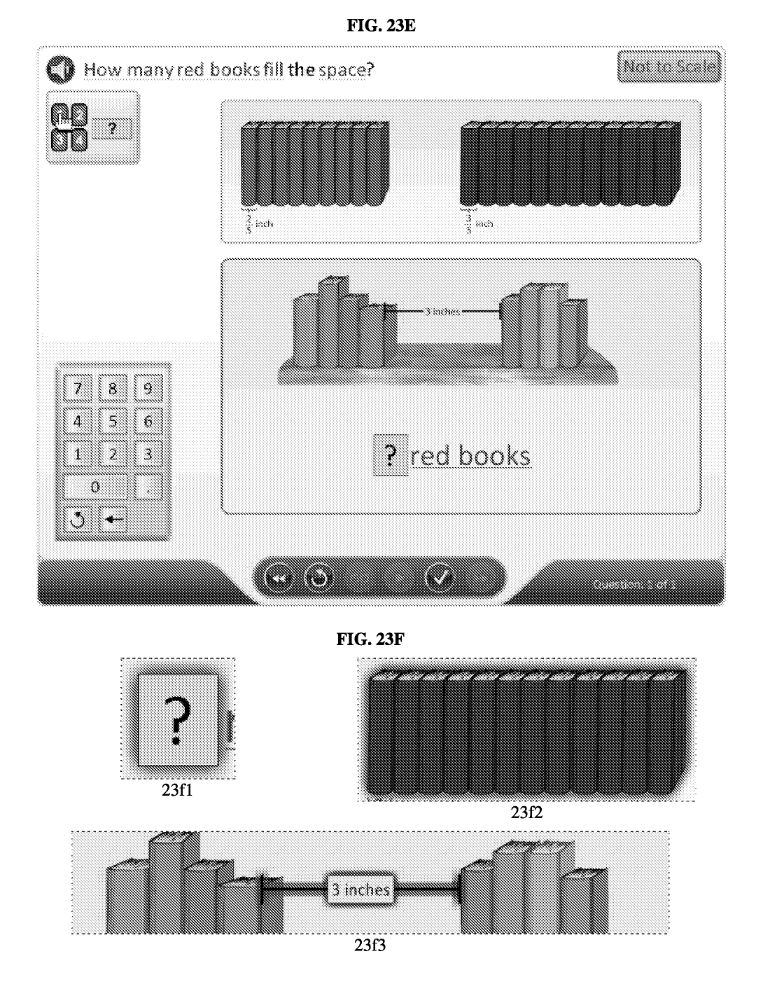

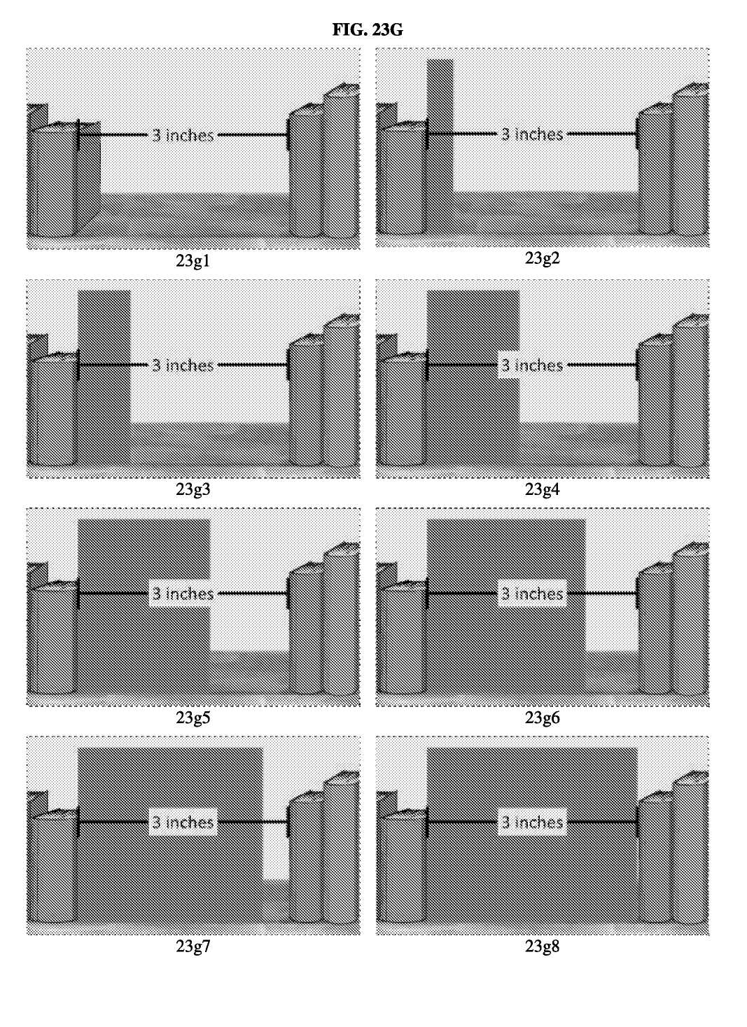

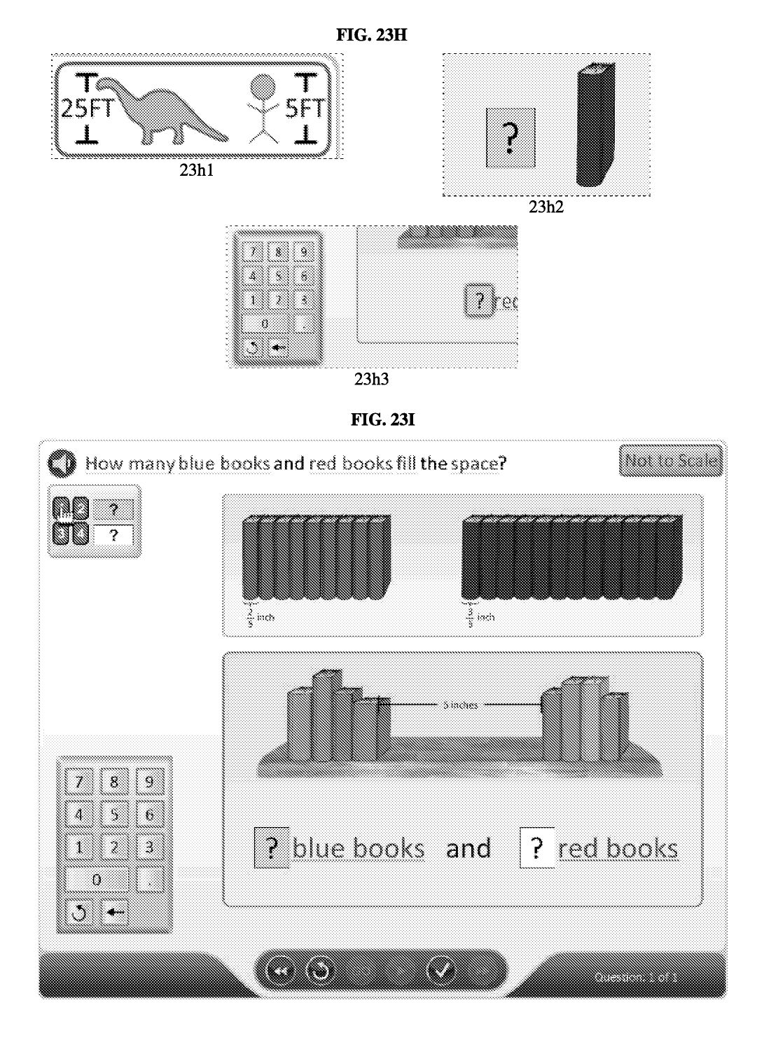

FIG. 23A shows an introductory screen for this mathematics-related sample item. In the screenshots of FIG. 23B, a contextual animation in which a boy places a book on a bookshelf is depicted. It is noted that, using the navigation buttons at the bottom of the display area, the subject may review the contextual animation from the beginning. FIG. 23C shows a first problem being posed, and the three screenshots of FIG. 23D show the effects of scrolling over “How wide,” “books,” and the animated icon, respectively.

FIG. 23E shows a second introductory screen and second problem being posed at the beginning of the sample item's second section. The three screenshots of FIG. 23F show the effects of rolling over “How many,” “red books,” and “space.” respectively.

If the subject scrolls over “fill” in the clause at the top of the display area, a supplementary animation within the task demand space is engaged, as shown in FIG. 23G. Specifically, to demonstrate what is meant by “fill,” the three-inch gap between the books on the bookshelf is filled up by an expanding colored rectangle, as shown in 23g1 through 23g8. Scrolling away from “fill” terminates the animation, and scrolling over “fill” engages the animation again for review by the subject.

Screenshot 23h1 of FIG. 23H shows the effect of scrolling over the “Not to Scale” rectangle at the top-right of the display area. Specifically, the clause is replaced by an image showing that a dinosaur and a person may be drawn to the same height even though one is 25 feet tall and the other is five feet tall. Screenshots 23h2 and 23h3 show the effects of scrolling over the bottom “red books” and the animated icon, respectively. Specifically, scrolling over the bottom “red books” textual clause replaces the text with an image of a red book for as long as the subject remains scrolled over the “red book” text.

FIG. 23I shows a third introductory screen and third problem being posed in a third section of the sample item. This section poses a related problem intended to further delve into the subject's actual understanding of the relevant concepts.

### Sample Item 20

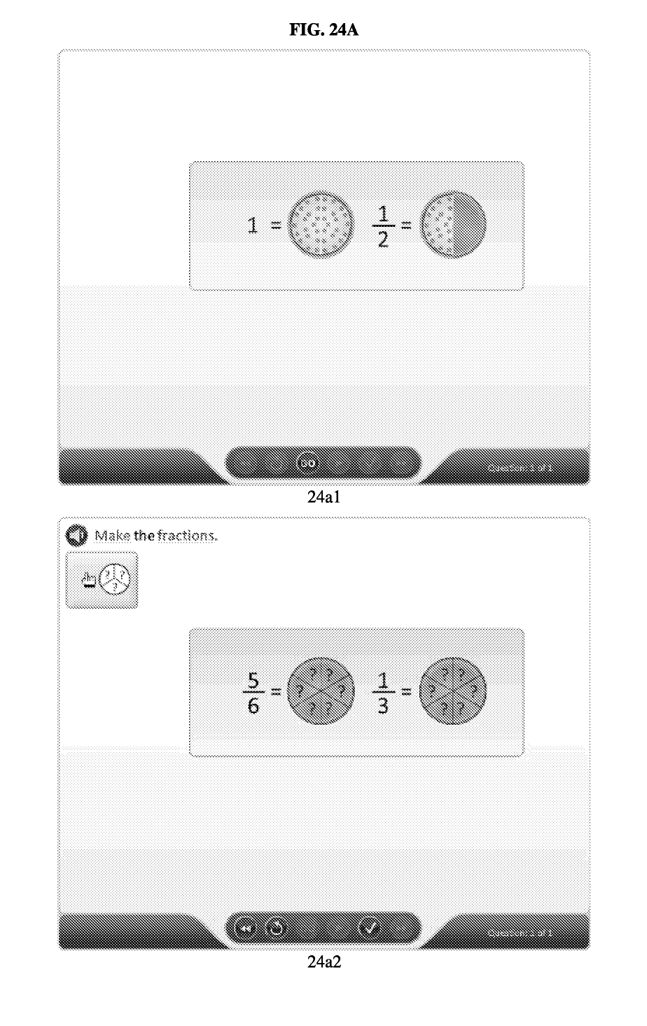

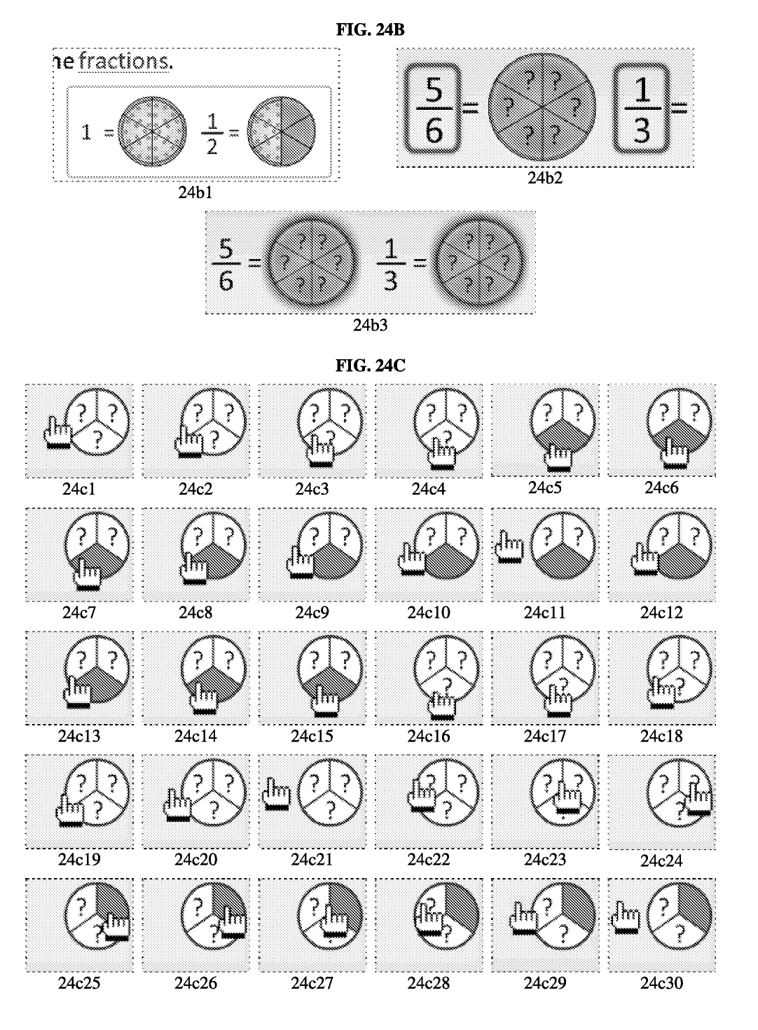

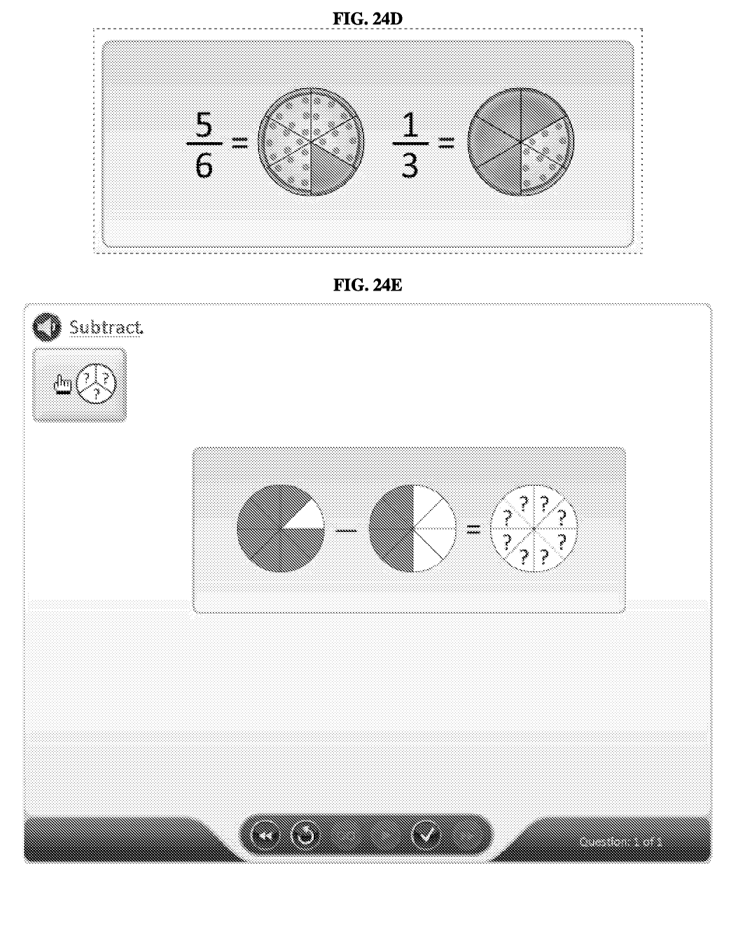

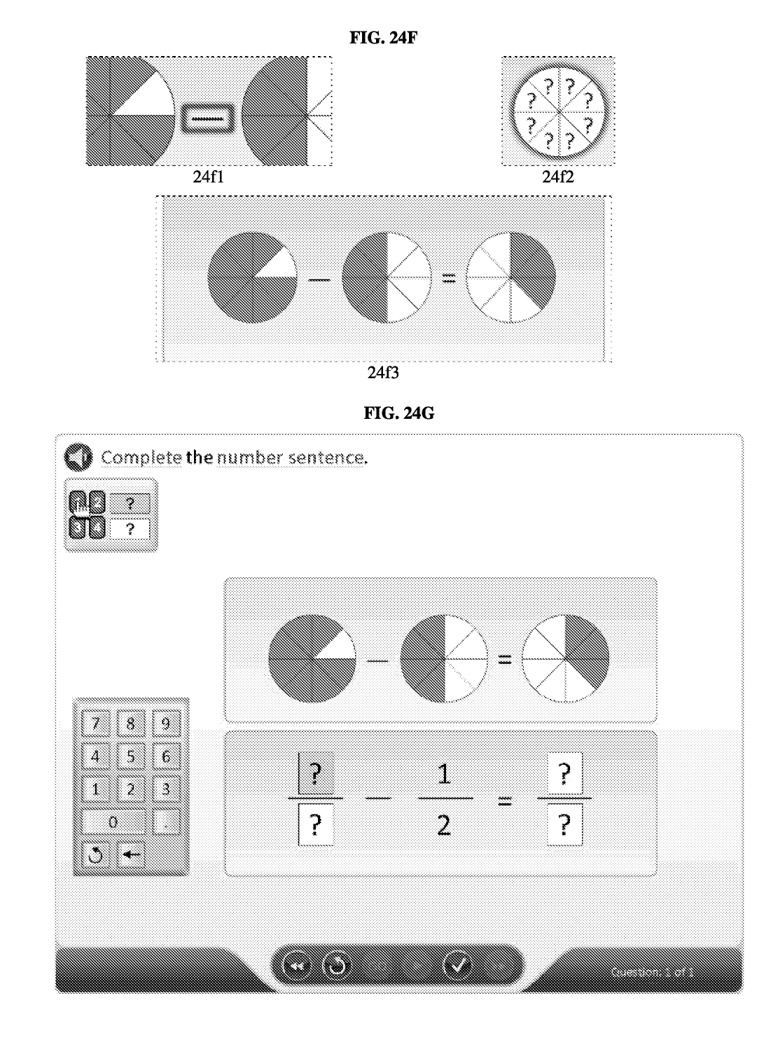

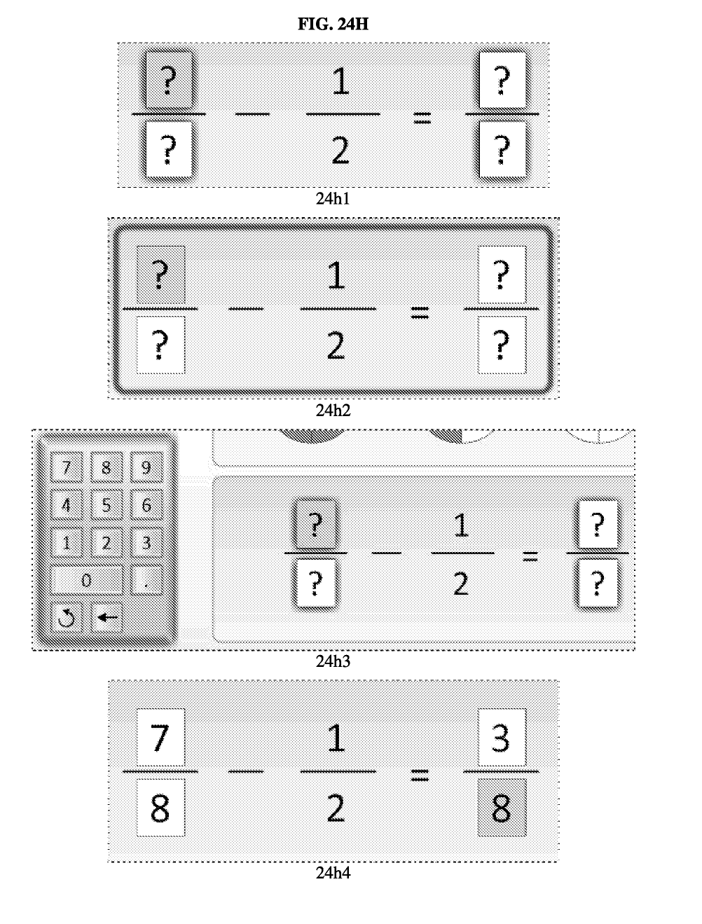

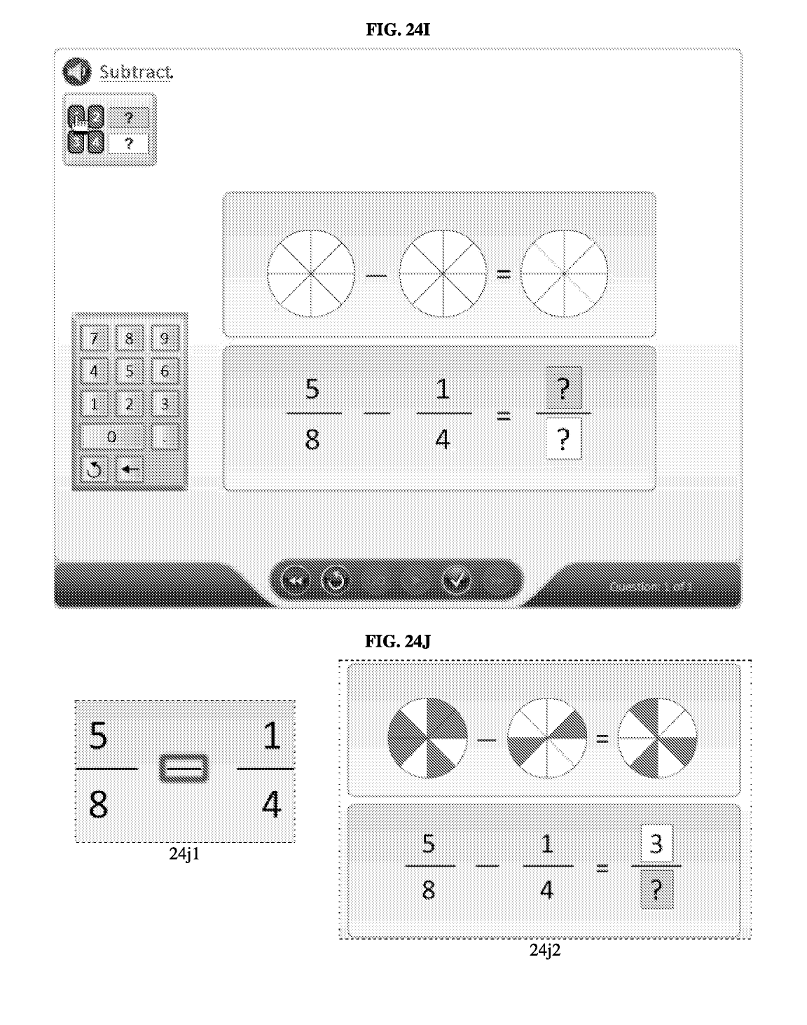

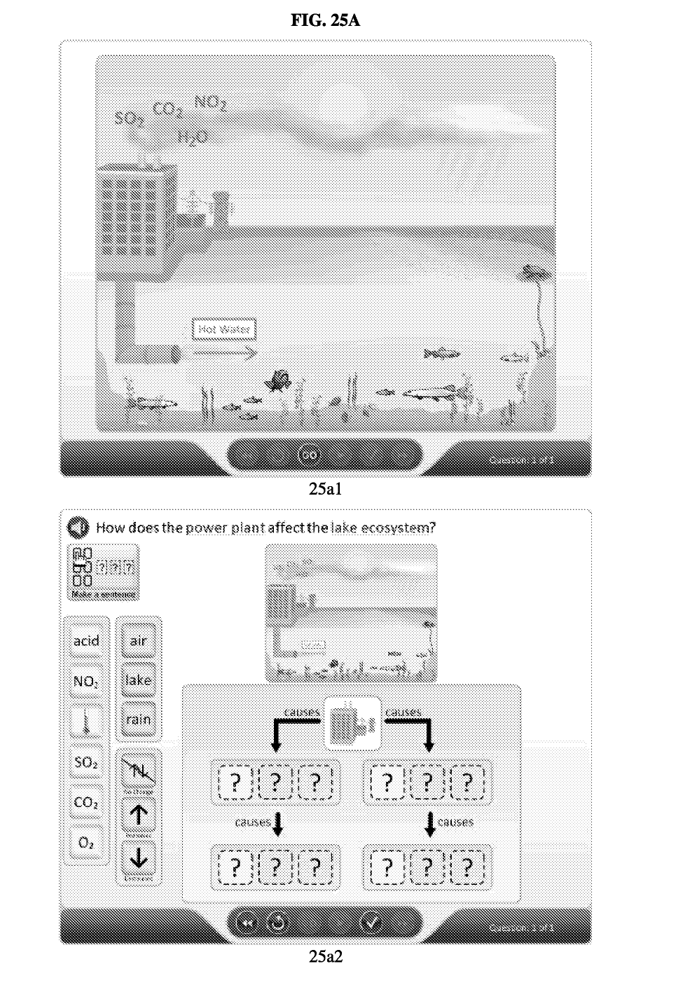

Screenshot 24a1 of FIG. 24A shows an introductory screen of a sample item related to mathematics and 24a2 depicts a first problem being posed. The three screenshots of FIG. 24B show the effects of scrolling over “Make,” “fractions,” and the animated icon, respectively. Screenshots of the animation of the animated icon are depicted in FIG. 24C. A potential response entered to the first problem posed according to the response function is depicted in FIG. 24D.

FIG. 24E shows a subsequent problem being posed in a second section of the sample item.

Screenshots 24f1 and 24f2 show the effects of scrolling over “Subtract” and the animated icon, respectively. It is noted that a single word is used to further reduce the language load of the sample item. Screenshot 24f3 shows a potential response to the second problem.

FIG. 24G shows a third problem posed in a third section of the sample item. Screenshots 24h1 through 24h3 show the effects of scrolling over “Complete,” “number sentence,” and the animated icon, respectively. Screenshot 24h4 shows a potential response to the third problem.

FIG. 24I presents a fourth problem posed in a fourth section of the sample item. Screenshot 24j1 of FIG. 24J shows the effect of scrolling over “Subtract,” and screenshot 24j2 shows a potential partial response to the fourth problem.

It is noted that the problems posed in this sample item present the relevant concepts from different perspectives. If the sample item were for educational rather than evaluative ends, the concepts being taught would be presented from different conceptual angles to aid the subject's learning. In an evaluative context, as presented in this sample item, the related problems posed, among other things, validate the subject's understanding of the concepts as well as the effectiveness of the sample item itself.

### Sample Item 21

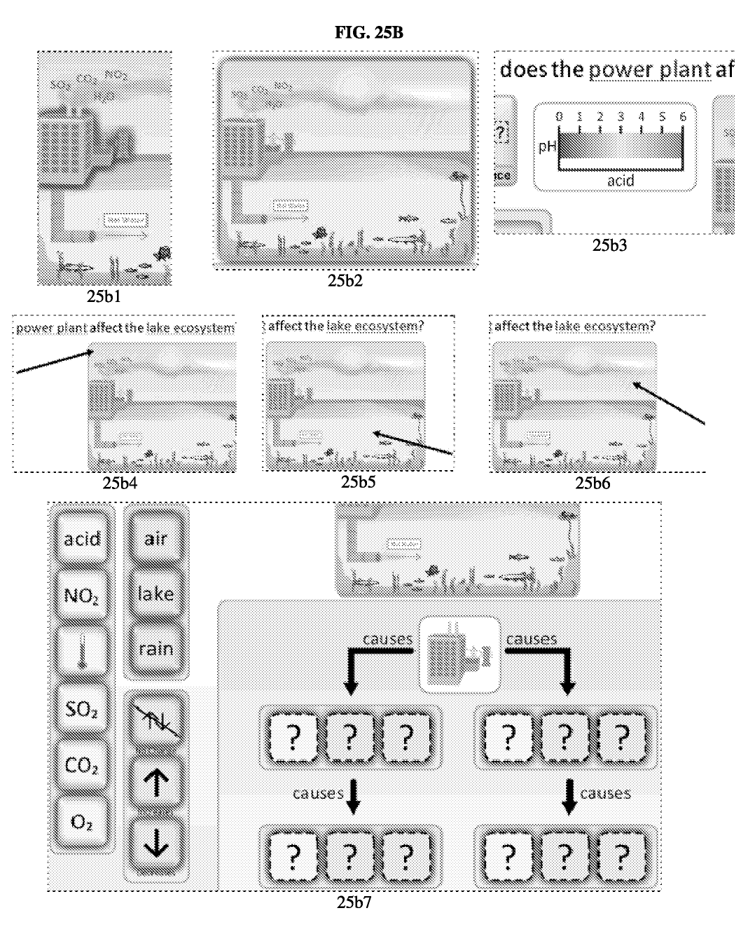

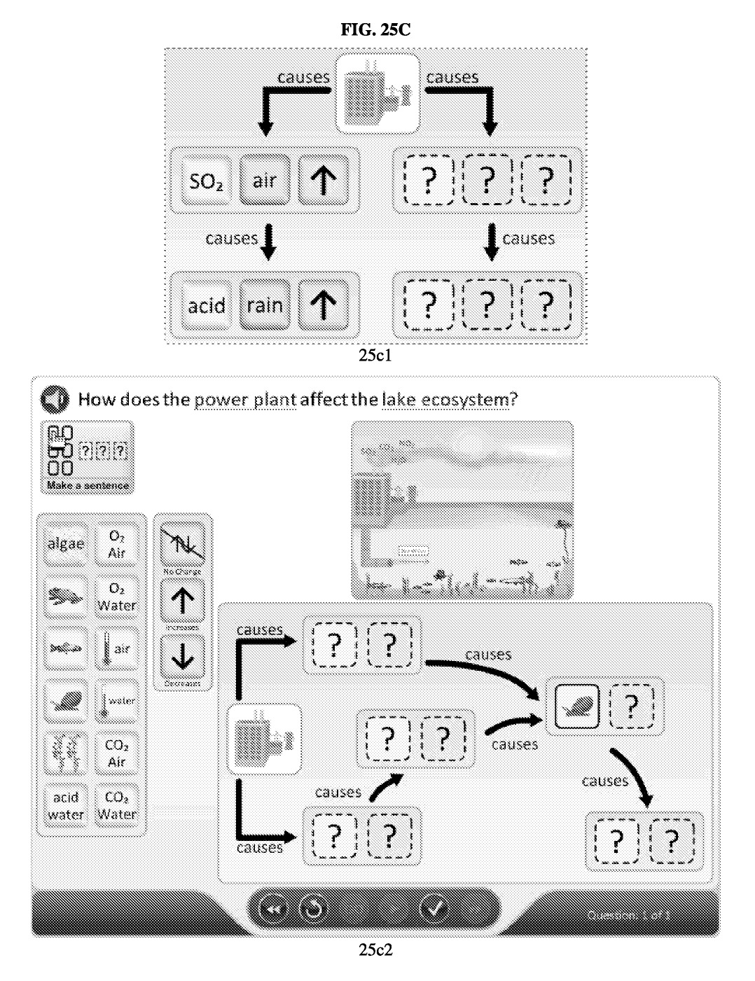

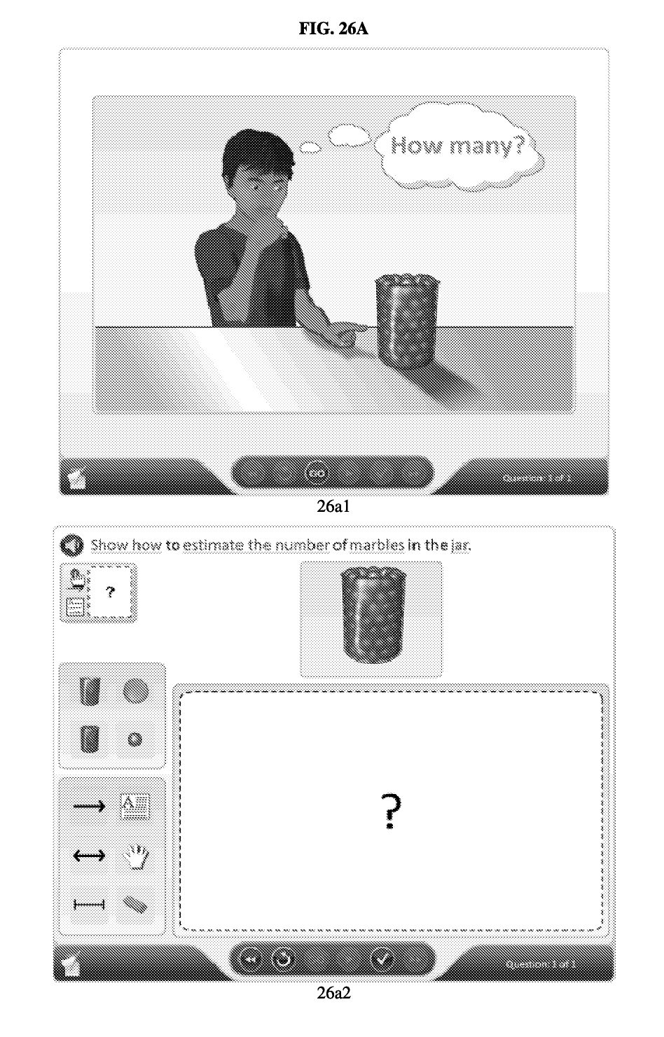

Screenshot 25a1 of FIG. 25A presents a first introductory screen for a sample item related to the environmental sciences, and 25a2 presents a first problem asking how a power plant affects a lake ecosystem. Screenshots 25b1 and 25b2 of FIG. 25B show the effects of scrolling over “power plant” and “lake ecosystem,” respectively. Scrolling over the “acid” box makes a supplementary image appear to the right of the animated icon, as shown in 25b3, depicting an acidic range (zero to six) of a pH scale. Scrolling over the “air,” “lake,” and “rain” boxes results in arrows directing the subject's attention to the relevant concepts, as shown in 25b4 through 25b6, respectively, of FIG. 25B. The supplementary images of the arrows remain only as long as the subject is scrolling over the screen elements that engaged the supplementary images, in part to avoid screen clutter and enhance their attention-grabbing nature. Screenshot 25b7 shows the effect of scrolling over the animated icon.

Screenshot 25c1 of FIG. 25C depicts a potential partial response to the problem posed in the first section of the sample item. Screenshot 25c2 shows a subsequent problem posed in another section of this sample item.

### Sample Item 22

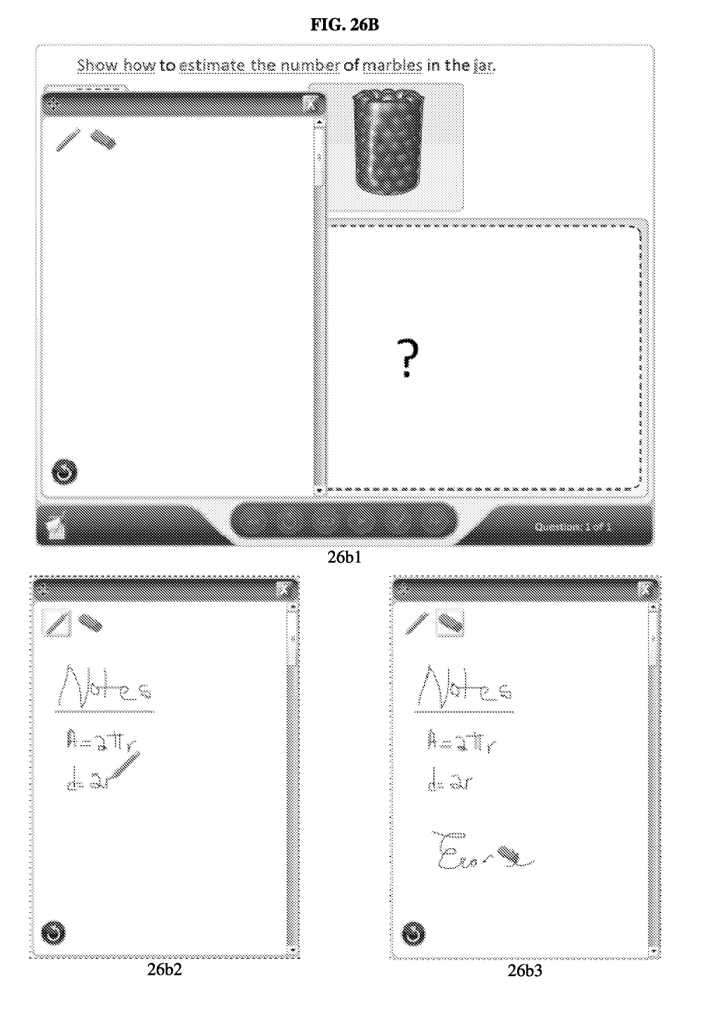

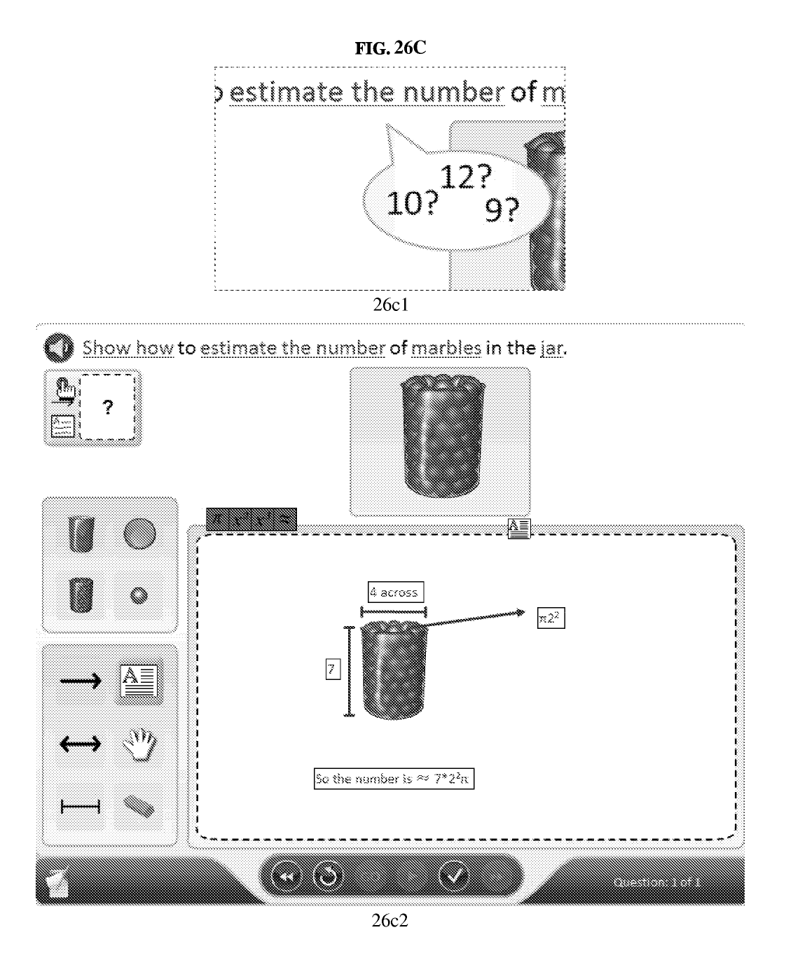

Screenshots 26a1 and 26a2 of FIG. 26A show a first introductory screen and a first problem posed, respectively, in this sample item. It is noted that not all sections and features of this sample item are presented or discussed. The states of the animated icon, for example, are not depicted. Here, the demonstrative phase of the animated icon depicts the hand icon dragging a gray circle into the represented response space (the white box with a question mark), the hand placing a “text” box (with a “A” in the top-left corner and wavy lines representing text) into the response space, letters of the alphabet being entered in the box, and the hand icon selecting the arrow and drawing an arrow from the text box to the gray circle in the represented response space. It is noted that the question mark in the represented response space disappears once something has been entered in it.

The response space pictured here (for example, in 26a2) is for demonstrating the process of arriving at the answer in this item. It is not only unique, but it has the ability to reflect a high degree of cognitive complexity and understanding if completed correctly. Here subjects must demonstrate their problem solving strategy in order to estimate the volume in a later screen (not shown), and the strategy used throughout is as important as the end volume result. In conventional items, if the strategy were to be scored as well as the conclusion, the explanatory response would require a prohibitively large quantity of language. In this sample item, however, students are provided various pictures of screen elements, directional arrows, special characters such as squared, cubed, and pi, and text boxes to demonstrate their strategy, as depicted in screenshot 26c2 of FIG. 26C. The response space is filled with a potential response in 26c2, illustrating one way to demonstrate a strategy—there are many correct and many more incorrect ways to depict the process the subject believes they use.

The subject sample item here provides an optional notepad feature for use by the subject, as indicated by the notepad icon in the bottom-left of the screenshot in 26a2. If the subject selects the icon, a notepad becomes activated, as shown in screenshot 26b1 of FIG. 26B. The notepad here includes at several main features, although the may include others. As suggested by the pencil icon, the notepad permits the subject to take notes in free-form fashion by selecting the pencil, as depicted in 26b2. The notepad also permits the subject to erase pencil marks, as depicted in 26b2. The notepad may also be moved elsewhere on the screen using the four-direction arrows on the top-left of the notepad so as to reveal different portions of the display area that may otherwise be blocked by a static notepad. The notepad may also be reset or blanked-out using the curved arrow at the bottom-left of the notepad. Additionally, the work area of the notepad may be scrolled to reveal more space using the scroll-bar at the right of the notepad. The notepad may be closed by reselecting the notepad icon that activated it, or by selecting the “X” at the top-right of the notepad.

Rolling over “estimate the number” in this sample item, for example, results in appearance of the supplementary image shown in screenshot 26c1 of FIG. 26C.

### Sample Item 23

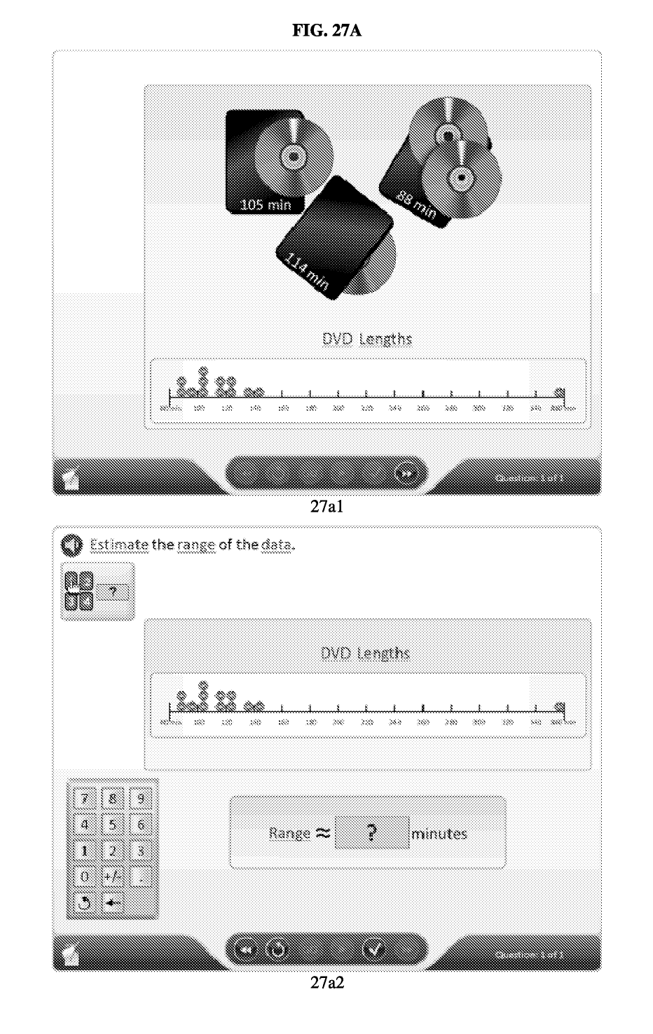

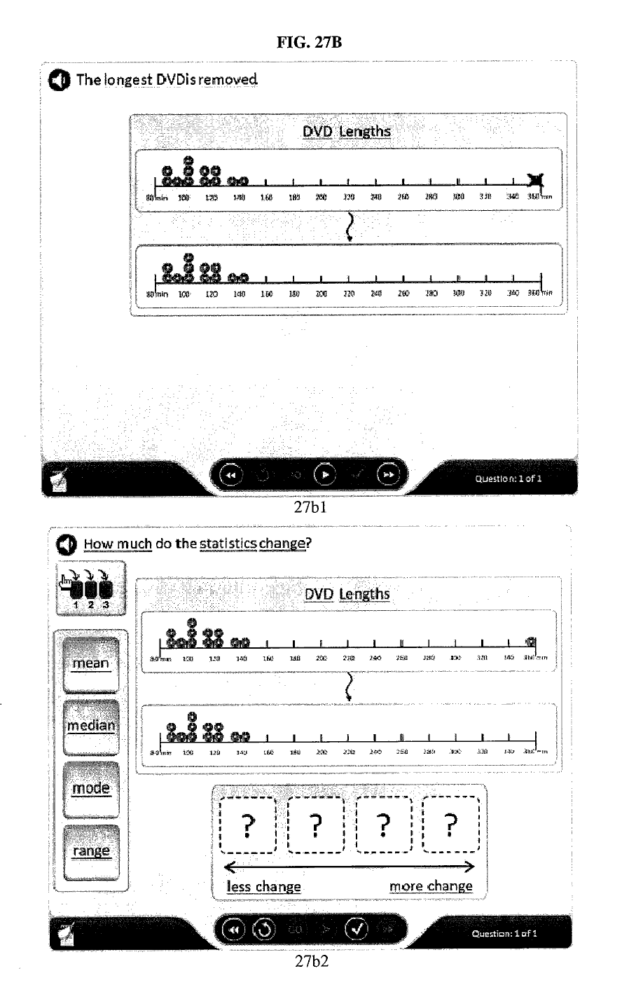

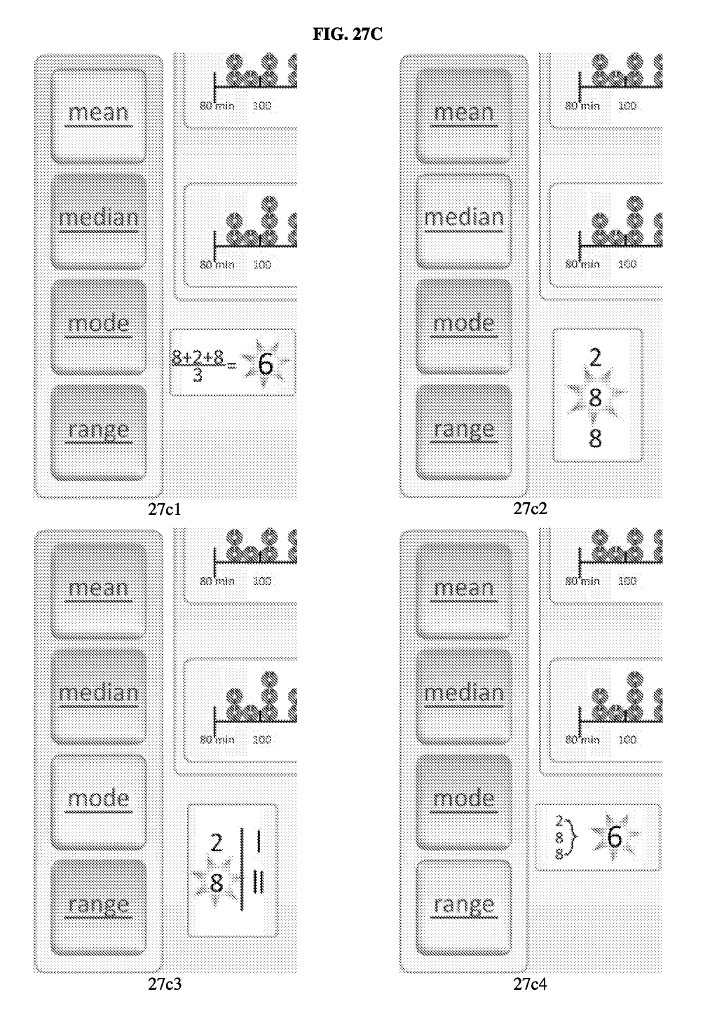

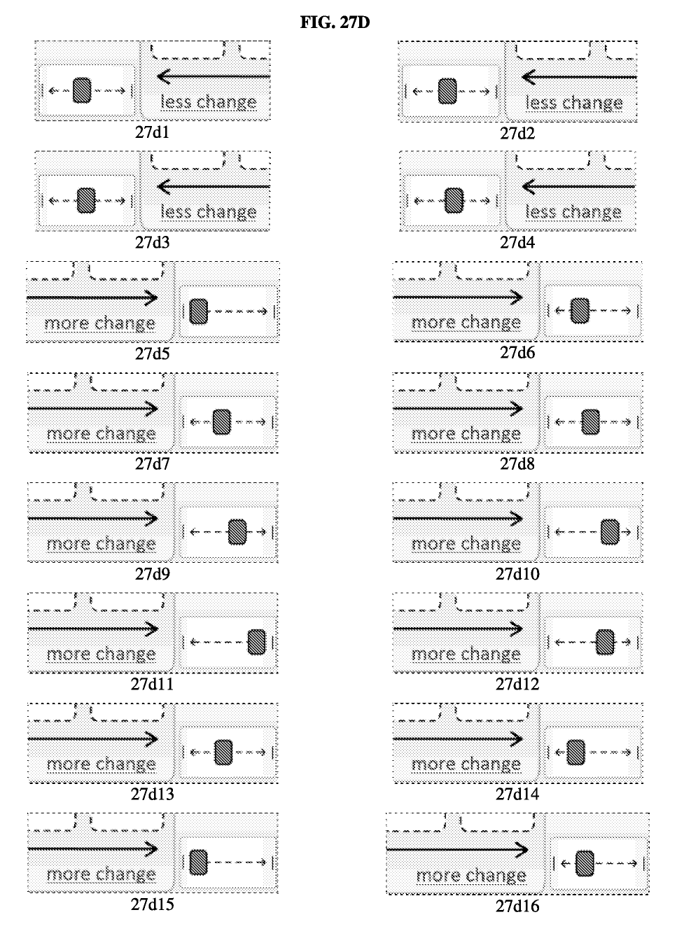

Screenshots 27a1 and 27a2 of FIG. 27A provide an introductory screen and a first problem, respectively, for this sample item. Screenshot 27b1 of FIG. 27B shows the final screen of a contextual animation in a second section of the sample item, and 27b2 shows a second problem. Although this sample item involves several sections and screens, only a limited portion of the item is presented here.

The response space of 27b2 utilizes an ordering to get at a cognitively complex understanding of the differences between closely related statistical concepts. Such distinctions would otherwise involve very language-rich explanations. Additionally, important foci in this sample item are the rollovers exhibited in the item on the response screen, as shown for “mean,” “median,” “mode,” and “range,” respectively, in the four screenshots of FIG. 27C. Since this item is not necessarily measuring the subjects' knowledge of the statistical concepts identified here, the rollovers identified in the partial shots of FIG. 27C illustrate how the statistical concepts are supported without cuing the response. While “less change” and “more change” may seem like easy text for English speakers, they are very difficult linguistically for English learners. Therefore, the rollovers depicted in FIG. 27D for this language provide clarity without adding more text. Specifically, the screenshots of 27d1 through 27d4 depict a supplementary animation in which the gray rectangle moves back-and-forth over a small range of the horizontal dotted line. In the screenshots of 27d5 through 27d16, by contrast, the gray box is shown moving back-and-forth over the full range of the horizontal dotted line.

### Sample Item 24

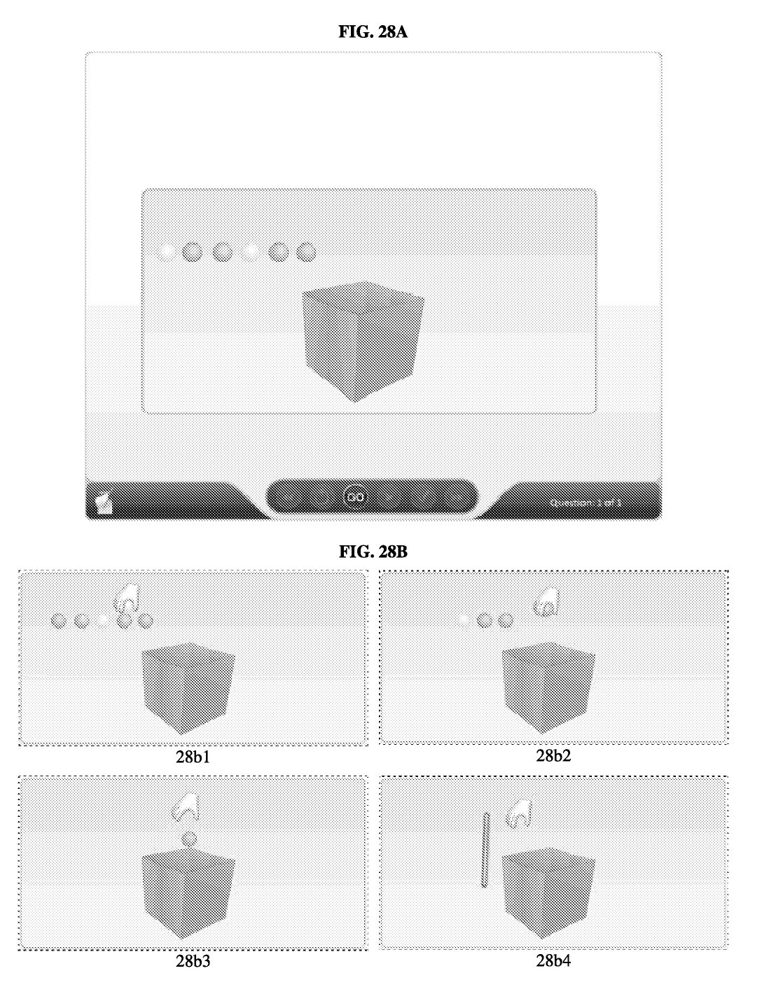

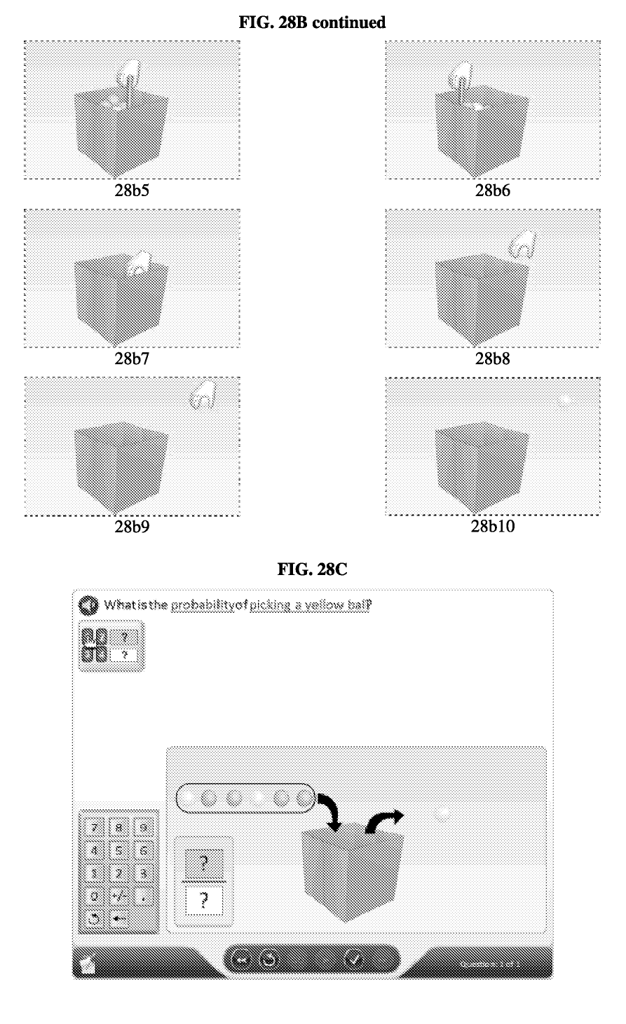

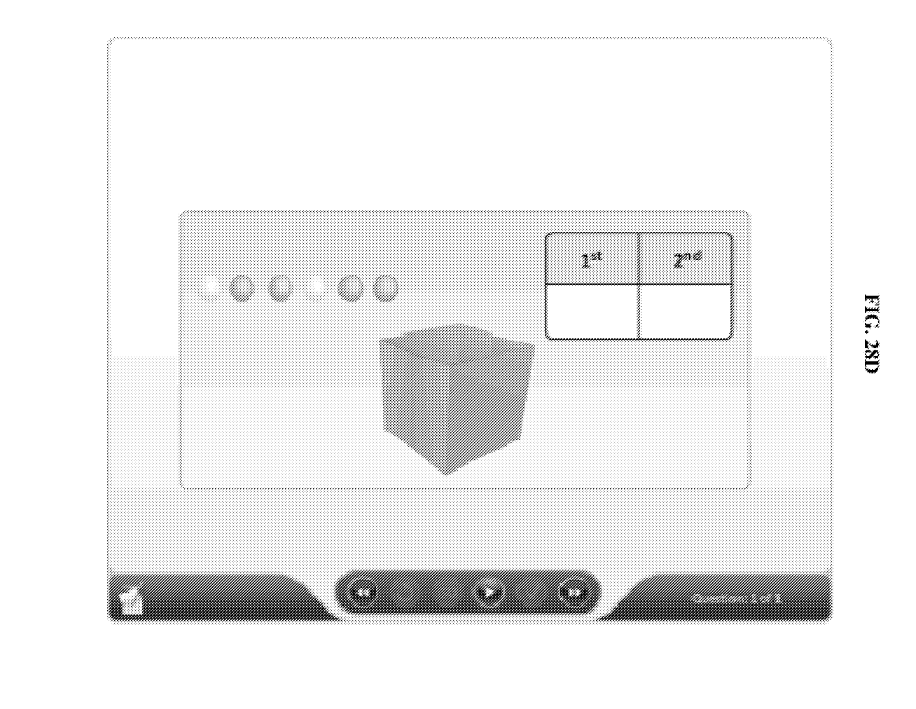

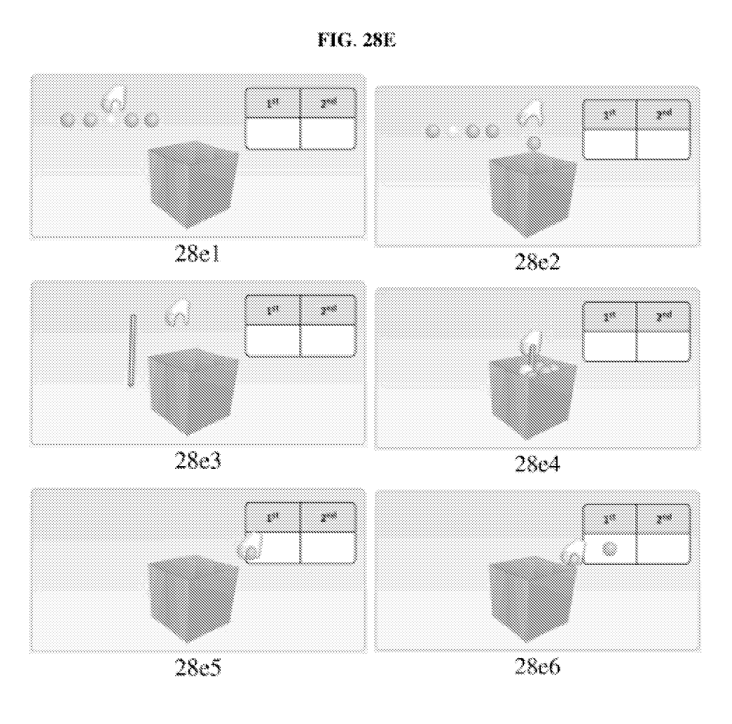

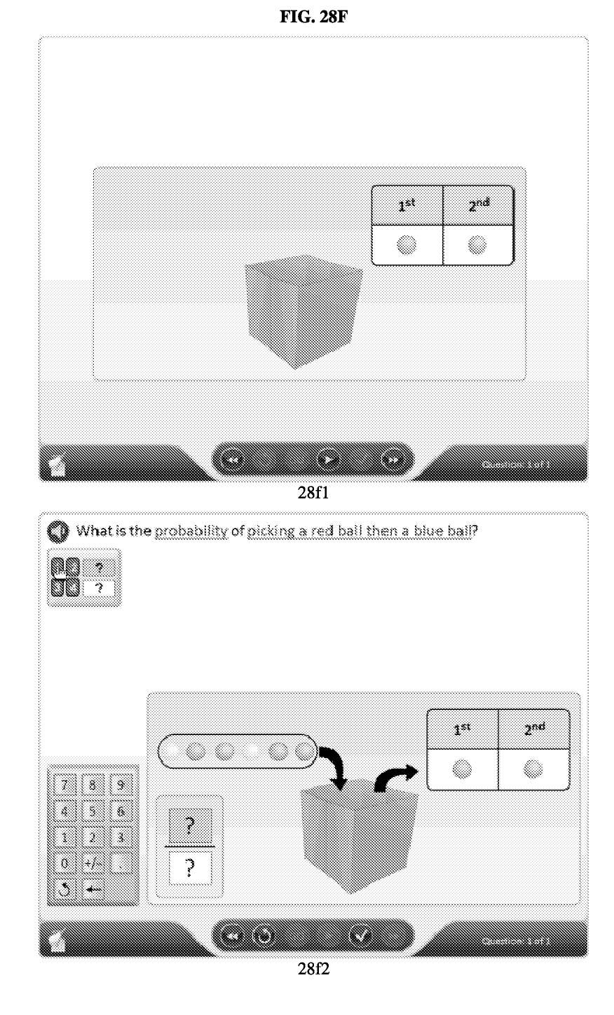

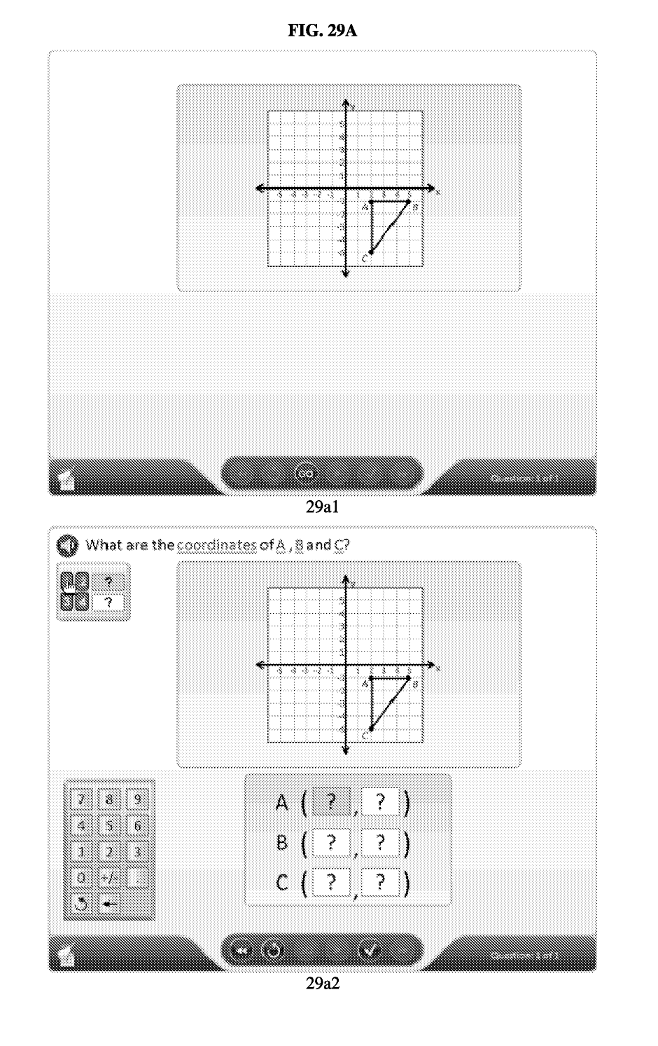

FIG. 28A shows a first introductory screen in this sample item. The screen is followed by a first contextual animation, as shown in FIG. 28B. In this animation, a hand appears to drop each of the six balls into the paper bag, as shown by 28b1 through 28b3. Then a rod appears to allow the hand to mix the differently-colored balls in the paper bag, as shown in 28b4 through 28b6. The hand is then shown removing a random ball out of the paper bag in screenshots 28b7 through 28b10. FIG. 28C provides a first problem based on the introduction and animation. The problem is highly interactive, and rolling over “picking a yellow ball,” for example, provides a supplementary animation depicting an animation of a hand picking a yellow ball from a paper bag (similar to the portion of the contextual animation shown in screenshots 28b7 through 28b10).

FIG. 28D shows a second introductory screen. In FIG. 28E, a contextual animation shows a hand dropping the six balls into a paper bag (28e1 and 28e2), stirring the balls with a rod (28e3 and 28e4), and first picking a red ball and then picking a blue ball from the paper bag (28e5 and 28e6, respectively). Screenshot 28f1 of FIG. 28F shows the end result of the contextual animation, and 28f2 shows a subsequent problem being posed. Rolling over “picking a red ball then a blue ball” results in the appearance of a supplementary animation (not shown) that depicts such a “picking” (as in the portion of the contextual animation in screenshots 28e5 and 28e6).

Like previous examples, the contextual language which would be needed to describe the method of randomly selecting elements in the experiment shown here, the language for selection with and without replacement, and the language that would be needed to ask the targeted question about probability are all rich, abstract, and difficult for English learners and some students with disabilities. This sample item illustrates a carefully designed contextual animation which eliminates almost all language, and the animated rollovers for picking one ball and then another ball support the contextual animation as well as the notions of probability necessary for understanding in the response space.

### Sample Item 25

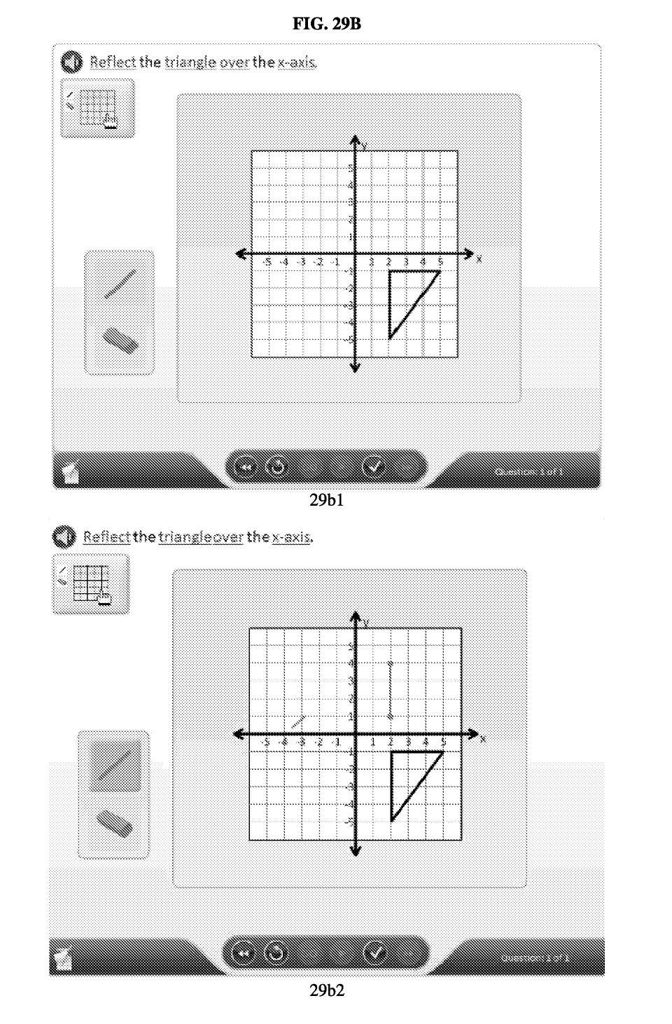

Screenshot 29a1 of FIG. 29A shows a first introductory screen, and 29a2 shows a first problem being posed in a first section of this sample item (not shown in its entirety). Screenshot 29b1 of FIG. 29B shows a second problem being posed in a subsequent section. A partial potential response is depicted in 29b2. The animated icon in FIG. 29B, not separately shown, in part demonstrates the response function of drawing a line in the represented grid.

As suggested by FIG. 29B, this sample item illustrates how subjects can demonstrate their understanding of how a figure would be reflected on a coordinate plane using a drawing tool. This response capability allows for an almost unlimited number of responses that can be scored progressively depending on the subject's sophistication of the concept. This example serves as a building block for more complex response spaces that can be used in a variety of ways to measure the subject's grasp of conceptual elements that would otherwise require substantial language to ask for in the targeted question or to differentiate in response choices.

It is understood that the invention is not confined to the particular construction and arrangement of parts herein illustrated and described, but embraces such modified forms thereof as come within the scope of the following claims.

What is claimed is:

1. A computer-implemented method for administering and analyzing electronic testing, comprising:
providing to a non-English speaking student a computer-implemented standardized testing interface configured to administer a standardized test including one or more test question sets stored in an electronic database, each test question set administration including,
providing a test question demonstration animation for a demonstration test question to be solved through non-linguistic methods and
providing at least a first solvable test question animation, the subject matter of the solvable test question correlated to the subject matter of the demonstration test question, wherein the solvable test question is solved by the student using non-linguistic methods; and
providing to an educator a computer-implemented standardized testing analysis engine configured to monitor and analyze one or more activities of the user during the administration of the test question set;
generating a testing analysis report including data generated by the computer-implemented standardized testing analysis engine;
showing on the report various depths of knowledge of the student based how the student interacted with respect to graphics, screens, information provided, and questions.

2. A computer-implemented system for electronic testing, comprising:
a computer-implemented testing interface configured to administer a standardized test including one or more test question sets stored in an electronic database, each test question set administration including,
a test question demonstration animation wherein a demonstration test question is solved using non-linguistic methods,
at least one solvable test question, the subject matter of the solvable test question correlated to the subject matter of the demonstration test question, wherein the solvable test question is solved using non-linguistic methods, and
a tool to scroll over items on a screen to reveal additional information relative to the test question;
a computer-implemented testing analysis engine configured to monitor and analyze one or more activities of the student during the administration of the test question set; and
a testing analysis report including data generated by the computer-implemented testing analysis engine, wherein the report includes data that tracks how a student interacts within a task demand space.

3. A computer-implemented method for implementing and analyzing electronic testing, comprising:
providing a computer-implemented standardized testing interface to a non-English speaking student;
configuring the interface to administer a standardized test including one or more test question sets stored in an electronic database, wherein each test question set is a non-linguistic test question set that has been correlated to a linguistic test question set testing the same subject matter, each test question set administration including,
providing a test question demonstration animation wherein a demonstration test question is solved, wherein the solution is demonstrated using non-linguistic methods and
providing at least a first solvable test question, the subject matter of the solvable test question correlated to the subject matter of the demonstration test question, wherein the solvable test question is solved by a student using non-linguistic methods;
configuring a computer-implemented standardized testing analysis engine to track and analyze for teaching purposes one or more activities of the student during the administration of the test question set; and
generating a testing analysis report for a educator including data generated by the computer-implemented standardized testing analysis engine, the data including a comparison between steps taken by the student while solving the question, a knowledge level of the student, and an accuracy of responses to the test question set.
